(19) United States
(12) Patent Application Publication
(10) Pub. No.: US 2009/0102988 A1
(43) Pub. Date: Apr. 23, 2009

(54) Projection device provided with semiconductor light source

(76) Inventors: Yoshihiro Maeda, Tokyo (JP); Kazuma Arai, Tokyo (JP); Taro Endo, Tokyo (JP); Fusao Ishii, Menlo Park, CA (US)

Correspondence Address: Bo-In Lin, 13445 Mondoli Drive, Los Altos Hills, CA, 94022, US

(21) Appl. No.: 12/286,836

(22) Filed: Oct. 1, 2008

Related U.S. Application Data
(60) Provisional application No. 60/997,728, filed on Oct. 2, 2007.

(51) Int. Cl. H04N 5/74

(52) U.S. Cl. 348/756; 348/E05.137

(57) ABSTRACT

The present invention provides a projection device comprising a semiconductor light source comprises a plurality of sub light sources arranged in an array, an illumination optical system for guiding an illumination light emitted from the semiconductor light source, a spatial light modulator for receiving and applying an image signal for modulating the illumination light emitted from the semiconductor light source guided by said illumination optical system, a control circuit for controlling the semiconductor light source and the spatial light modulator and a projection optical system for projecting images by applying the illumination light modulated by the spatial light modulator. The control circuit controls or adjusts the emitting state of the semiconductor light source by modifying at least two of following parameters consisted of an emission intensity, a number of times of emission, an emission period and an emitting timing of the sub light source or a number of emitted light and an emitting position of the sub light sources.

### CROSS REFERENCE TO RELATED APPLICATIONS

This application is a Non-provisional Application claiming a Priority date of Oct. 2, 2007 based on a previously filed Provisional Application 60/997,728 and a Non-provisional patent application Ser. No. 11/121,543 filed on May 3, 2005 issued into U.S. Pat. No. 7,268,932. The application Ser. No. 11/121,543 is a Continuation In Part (CIP) Application of three previously filed Applications. These three Applications are Ser. No. 10/698,620 filed on Nov. 1, 2003, Ser. No. 10/699,140 filed on Nov. 1, 2003 now issued into U.S. Pat. No. 6,862,127, and Ser. No. 10/699,143 filed on Nov. 1, 2003 now issued into U.S. Pat. No. 6,903,860 by the Applicant of this Patent Applications. The disclosures made in these Patent Applications are hereby incorporated by reference in this Patent Application.

### BACKGROUND OF THE INVENTION

1. Field of the Invention

The present invention relates generally to the field of system configuration and methods for controlling and operating a projection apparatus. More particularly, this invention related to an image projection apparatus implemented with a semiconductor light source and controller for controlling the light source and the spatial light modulators.

2. Description of the Related Art

Even though there have been significant advances made in recent years in the technologies of implementing electromechanical micromirror devices as spatial light modulators (SLM), there are still limitations and difficulties when they are employed to display high quality images. Specifically, when the display images are digitally controlled, the quality of the images is adversely affected because the images are not displayed with a sufficient number of gray scale gradations.

An electromechanical mirror device is drawing a considerable interest as a spatial light modulator (SLM). The electromechanical mirror device consists of a mirror array arranging a large number of mirror elements. In general, the number of mirror elements range from 60,000 to several millions and are arranged on the surface of a substrate in an electromechanical mirror device.

Referring to FIG. 1A, an image display system 1 including a screen 2 is disclosed in a relevant U.S. Pat. No. 5,214,420. A light source 10 is used to generate light beams to project illumination for the display images on the display screen 2. The light 9 projected from the light source is further concentrated and directed toward lens 12 by way of mirror 11. Lenses 12, 13 and 14 form a beam columnator operative to columnate the light 9 into a column of light 8. A spatial light modulator 15 is controlled by a computer through data transmitted over data cable 18 to selectively redirect a portion of the light from path 7 toward lens 5 to display on screen 2. FIG. 1B shows a SLM 15 that has a surface 16 that includes an array of switchable reflective elements 17, 27, 37, and 47, each of these reflective elements is attached to a hinge 30. When the element 17 is in an ON position, a portion of the light from path 7 is reflected and redirected along path 6 to lens 5 where it is enlarged or spread along path 4 to impinge on the display screen 2 to form an illuminated pixel 3. When the element 17 is in an OFF position, the light is reflected away from the display screen 2 and, hence, pixel 3 is dark. Each of the mirror elements constituting a mirror device functions as a spatial light modulator (SLM), and each mirror element comprises a mirror and electrodes. A voltage applied to the electrode(s) generates a coulomb force between the mirror and the electrode(s), making it possible to control and incline the mirror. The inclined mirror is “deflected” according to a common term used in this patent application for describing the operational condition of a mirror element.

When a mirror is deflected with a voltage applied to the electrode(s), the deflected mirror also changes the direction of the reflected light in reflecting an incident light. The direction of the reflected light is changed in accordance with the deflection angle of the mirror. The present patent application refers to the light reflected to a projection path designated for image display as “ON light”, and refers to a light reflected in a direction other than the designated projection path for image display as “OFF light”. When the light reflected by the mirror to the projection path is of a lesser intensity than the “ON light”, because part of it is directed in the OFF light direction, it is referred to as “intermediate light”.

The present patent application defines an angle of rotation along a clockwise (CW) direction as a positive (+) angle and that of a counterclockwise (CCW) direction as a negative (−) angle. A deflection angle is defined as zero degrees (0°) when the mirror is in the initial state.

Most of the conventional image display devices, such as the device disclosed in U.S. Pat. No. 5,214,420 implement a dual-state mirror control that controls mirrors in either the ON or OFF state. The quality of image display is limited due to the limited number of gray scales. Specifically, in a conventional control circuit that performs pulse width modulation (PWM), the quality of an image is limited by the least significant bit (LSB) or the least pulse width, as controls related to the ON or OFF state. Since the mirror is controlled to operate in either an ON or OFF state, the conventional image display apparatus has no way to provide a pulse width to control the mirror that is shorter than the duration represented by the LSB. The least quantity of light, which determines the gray scale, is the light reflected during the least pulse width. The limited levels of gray scale lead to the degradation of the display image.

Specifically, FIG. 1C exemplifies, as related disclosures, a circuit diagram for controlling a micromirror according to U.S. Pat. No. 5,285,407. The control circuit includes memory cell 32. Various transistors are referred to as “M*” where “*” designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads in the memory cell 32. The memory cell 32 includes an access switch transistor M9 and a latch 32a based on a Static Random Access switch Memory (SRAM) design. All access transistors M9 on an Row line receive a DATA signal from a different Bit-line 31a. The particular memory cell 32 is accessed for writing a bit to the cell by turning on the appropriate row select transistor M9, using the ROW signal functioning as a Word-line. Latch 32a consists of two cross-coupled inverters, M5/M6 and M7/M8, which permit two stable states that include a state 1 when is Node A high and Node B low, and a state 2 when Node A is low and Node B is high.

The mirror is driven by a voltage applied to the landing electrode and is held at a predetermined deflection angle on the landing electrode. An elastic “landing chip” is formed on a portion on the landing electrode that makes contact with the mirror, and assists in deflecting the mirror towards the opposite direction when the deflection of the mirror is switched. The landing chip is designed to have the same potential as the landing electrode, so that a shorting is prevented when the landing electrode is in contact with the mirror.

Each mirror formed on a device substrate has a square or rectangular shape, and each side has a length of 4 to 15 um. In this configuration, reflected light that is not intentionally applied to project an image is, however, inadvertently generated by reflections through the gap between adjacent mirrors. The contrast of the displayed image is degraded due to the reflections generated by the gaps between the mirrors. In order to overcome such problems, the mirrors are arranged on a semiconductor wafer substrate with a layout to minimize the gaps between the mirrors. One mirror device is generally designed to include an appropriate number of mirror elements, wherein each mirror element is manufactured as a deflectable mirror on the substrate for displaying a pixel of an image. The appropriate number of elements for displaying an image is configured in compliance with the display resolution standard according to the VESA Standard defined by Video Electronics Standards Association or by television broadcast standards. When a mirror device is configured with the number of mirror elements in compliance with WXGA (resolution: 1280 by 768) defined by VESA, the pitch between the mirrors of the mirror device is 10 μm, and the diagonal length of the mirror array is about 0.6 inches.

The control circuit, as illustrated in FIG. 1C, controls the mirrors to switch between two states, and the control circuit drives the mirror to oscillate to either an ON or OFF deflected angle (or position) as shown in FIG. 1A.

The minimum intensity of light reflected from each mirror element for image display, i.e., the resolution of gray scale of image display for a digitally controlled image display apparatus, is determined by the least length of time that the mirror may be controlled to stay in the ON position. The length of time a micromirror is in an ON position is controlled by a multiple bit word. FIG. 1D shows the “binary time intervals” when controlling micromirrors with a four-bit word. As shown in FIG. 1D, the time durations have relative values of 1, 2, 4, 8, which in turn define the relative brightness for each of the four bits where “1” is the least significant bit and “8” is the most significant bit. According to the PWM control mechanism, the minimum quantity of light that determines the gray scale is a brightness controlled by using the “LSB” to hold the mirror at an ON position during the shortest controllable length of time.

For example, assuming n bits of gray scales, one time frame is divided into 2ⁿ−1 equal time periods. For a 16.7-millisecond frame period and n-bit intensity values, the time period is 16.7/(2ⁿ−1) milliseconds.

Having established these times for each pixel of each frame, pixel intensities are quantified such that black is a 0 time period, the intensity level represented by the LSB is 1 time period, and the maximum brightness is 2ⁿ−1 time periods. Each pixel's quantified intensity determines its ON-time during a time frame. Thus, during a time frame, each pixel with a quantified value of more than 0 is ON for the number of time periods that correspond to its intensity. The viewer's eye integrates the pixel brightness so that the image appears the same as if it were generated with analog levels of light.

In order to control a deflectable mirror device, the PWM calls for data to be formatted into “bit-planes”, with each bit-plane corresponding to a bit weight of the intensity of light. Thus, if the brightness of each pixel is represented by an n-bit value, each frame of data has the n-bit-planes. Then, each bit-plane has a 0 or 1 value for each mirror element. According to the PWM control scheme described in the preceding paragraphs, each bit-plane is independently loaded and the mirror elements are controlled according to bit-plane values corresponding to the value of each bit during one frame. Specifically, the bit-plane according to the LSB of each pixel is displayed for 1 time period.

When adjacent image pixels are displayed with a very coarse gray scale caused by great differences in the intensity of light, thus, artifacts are shown between these adjacent image pixels. That leads to the degradations of image quality. The image degradations are especially pronounced in the bright areas of image where there are “bigger gaps” between of the gray scales of adjacent image pixels. The artifacts are generated by technical limitations in that the digitally controlled image does not provide a sufficient number of the gray scale.

As the mirrors are controlled to be either ON or OFF, the intensity of light of a displayed image is determined by the length of time each mirror is in the ON position. In order to increase the number of gray scales of a display, the switching speed of the ON and OFF positions for the mirror must be increased. Therefore the digital control signals need be increased to a higher number of bits. However, when the switching speed of the mirror deflection is increased, a stronger hinge for supporting the mirror is necessary to sustain the required number of switches between the ON and OFF positions for the mirror deflection. In order to drive the mirrors with a strengthened hinge, a higher voltage is required. The higher voltage may exceed twenty volts and may even be as high as thirty volts. The mirrors produced by applying the CMOS technologies are probably not appropriate for operating the mirror at such a high range of voltages, and therefore DMOS mirror devices may be required. In order to achieve a higher degree of gray scale control, more complicated production processes and larger device areas are required to produce the DMOS mirror. Conventional mirror controls are therefore faced with a technical problem in that accuracy of gray scales and range of the operable voltage have to be sacrificed for the benefits of a smaller image display apparatus.

There are many patents related to light intensity control. These Patents include U.S. Pat. Nos. 5,589,852, 6,232,963, 6,592,227, 6,648,476, and 6,819,064. There are further patents and patent applications related to different light sources. These Patents include U.S. Pat. Nos. 5,442,414, 6,036,318 and Application 20030147052. Also, U.S. Pat. No. 6,746,123 has disclosed particular polarized light sources for preventing the loss of light. However, these patents or patent applications do not provide an effective solution to attain a sufficient number of the gray scale in the digitally controlled image display system.

Furthermore, there are many patents related to a spatial light modulation, including U.S. Pat. Nos. 2,025,143, 2,682,010, 4,087,810, 4,292,732, 4,405,209, 4,454,541, 4,592,628, 4,767,192, 4,842,396, 4,907,862, 5,214,420, 5,287,096, 5,506,597 and 5,489,952. There are additional patented disclosures related to the image projection apparatuses. These patented disclosures include U.S. Pat. No. 5,214,420, U.S. Pat. No. 5,285,407, U.S. Pat. No. 5,589,852, U.S. Pat. No. 6,232,963, U.S. Pat. No. 6,592,227, U.S. Pat. No. 6,648,476, U.S. Pat. No. 6,819,064, U.S. Pat. No. 5,442,414, U.S. Pat. No. 6,036,318, United States Patent Application 20030147052, U.S. Pat. No. 6,746,123, U.S. Pat. No. 2,025,143, U.S. Pat. No. 2,682,010, U.S. Pat. No. 2,681,423, U.S. Pat. No. 4,087,810, U.S. Pat. No. 4,292,732, U.S. Pat. No. 4,405,209, U.S. Pat. No. 4,454,541, U.S. Pat. No. 4,592,628, U.S. Pat. No. 4,767,192, U.S. Pat. No. 4,842,396, U.S. Pat. No. 4,907,862, U.S. Pat. No. 5,214,420, U.S. Pat. No. 5,287,096, U.S. Pat. No. 5,506,597, and U.S. Pat. No. 5,489,952. However, these inventions do not provide a direct solution for a person skilled in the art to overcome the above-discussed limitations and difficulties.

In view of the above problems, US Patent Application 20050190429 has disclosed a method for controlling the deflection angle of the mirror to express higher gray scales of an image. In this disclosure, the intensity of light obtained during the oscillation period of the mirror is about 25% to 37% of the intensity of light obtained while the mirror is held in the ON position continuously.

According to this control, it is not necessary to drive the mirror at a high speed. Also, it is possible to provide a higher number of the gray scale using a hinge with low elastic constant. Hence, such a control makes it possible to reduce the voltage applied to the landing electrode.

An image display apparatus using the mirror device described above is broadly categorized into two types: a single-plate image display apparatus equipped with only one spatial light modulator and a multi-plate image display apparatus equipped with a plurality of spatial light modulators. In the single-plate image display apparatus, a color image is displayed by changing, in turn, the color (i.e. frequency or wavelength) of projected light over time. In a multi-plate the image display apparatus, a color image is displayed controlling the multiple spatial light modulators, corresponding to beams of light having different colors (i.e. frequencies or wavelengths), to modulate and combine the beams of light continuously.

A projection apparatus applies a single-plate color sequential method to display image does not requires an optical structure for combining different colors. Therefore, the single projection apparatus is implemented with simpler optical structure and only one spatial modulator and is therefore inexpensive. However, the time during for projecting each color is short is difficult to display images with high levels of gray scales and resolution when a method for sequentially projecting the light of each color in the duration of a sub-frame is adopted. Furthermore, sequentially switching and projecting the light of each color when the single-plate color sequential method is adopted can separately perceive the image display of different colors of R, G and B. As a result, a viewer can perceive the disruption in the projected image. This phenomenon is called color break, in which an observer does not observe high quality color images.

In the multi-plate color method, since light of each color can be projected in one frame, and since multiple beams of color light of R, G and B are projected, a high gradation image can be projected. However, with the recent advance of imaging technology, far higher-gradation and far higher-quality images are desired, even in the multi-plate color projection device.

### SUMMARY OF THE INVENTION

It is an aspect of the present invention to provide a projection device for displaying images for displaying a higher level of gray scales and higher gradation of resolutions and also reducing the effects of color breaks to an inconspicuous level.

The first exemplary embodiment of the present invention is a projection device comprising a semiconductor light source comprises a plurality of sub light sources arranged in an array, an illumination optical system for guiding an illumination light outputted from the semiconductor light source, a spatial light modulator for receiving and applying an image signal for modulating the illumination light outputted from the semiconductor light source guided by said illumination optical system, a control circuit for controlling the semiconductor light source and the spatial light modulator, and a projection optical system for projecting images by applying the illumination light modulated by the spatial light modulator, wherein the control circuit controls or adjusts the emitting state of the semiconductor light source by modifying at least two of following parameters consisted of an emission intensity, a number of times of emission, an emission period and an emitting timing of the sub light source or a number of emitted light and an emitting position of the sub light sources.

The second exemplary embodiment of the present invention is a projection device according to the projection device in the first exemplary embodiment wherein the semiconductor light source has different wavelengths.

The third exemplary embodiment of the present invention is a projection device according to the projection device in the first exemplary embodiment wherein the spatial light modulator is a mirror device in which mirror elements for modulating the illumination light outputted from the semiconductor light source and deflecting the illumination light in an ON direction which leads reflected light of the illumination light to the projection optical system, in an OFF direction which does not lead the reflected light of the illumination light to the projection optical system or in an intermediate direction between the ON direction and OFF direction are arranged in an array.

The fourth exemplary embodiment of the present invention is a projection device according to the projection device in the third exemplary embodiment wherein the control circuit controls the mirror device on the basis of non-binary data of the binary image signal.

The fifth exemplary embodiment of the present invention is a projection device according to the projection device in the first exemplary embodiment wherein the control circuit controls the emission intensity, times of emission, emission period and emitting timing of the semiconductor light source in synchronization with the spatial light modulator.

The sixth exemplary embodiment of the present invention is a projection device according to the projection device in the second exemplary embodiment wherein the control circuit controls the semiconductor light source and the spatial light modulator in such a way that the total time of sub-frame time corresponding to illumination light of at least one wavelength may change during each frame period of the image signal.

The seventh exemplary embodiment of the present invention is a projection device according to the projection device in the first exemplary embodiment wherein when the control circuit controls the semiconductor light source, the gradation of the illumination light of at least one wavelength and/or the number of sub-frames during each frame period of the image signal differ.

The eighth exemplary embodiment of the present invention is a projection device according to the projection device in the second exemplary embodiment, comprising a plurality of the spatial light modulator, wherein at least one of the spatial light modulator modulates illumination light of a plurality of wavelengths and the other spatial light modulators modulate the illumination light of the remaining wavelengths.

The ninth exemplary embodiment of the present invention is a projection device according to the projection device in the second exemplary embodiment, comprising a plurality of the spatial light modulator, wherein a first spatial light modulator modulates the illumination light of a plurality of wavelengths and the other second spatial light modulators modulate the illumination light of a plurality of wavelengths including wavelengths modulated by the first spatial light modulator.

The tenth exemplary embodiment of the present invention is a projection device according to the projection device in the first exemplary embodiment, comprising a plurality of the spatial light modulator, wherein the control circuit controls the semiconductor light source and/or the spatial light modulators in such a way that the modulation time of illumination light modulated by at least two of the spatial light modulators becomes almost the same during each frame period of the image signal.

The eleventh exemplary embodiment of the present invention is a projection device according to the projection device in the first exemplary embodiment, wherein the control circuit controls the semiconductor light source in such a way that the ratio of the lightness of a projected image of each wavelength based on the total time of each sub-frame time during each frame period of the image signal becomes close to the distribution of spectral luminous efficiency.

The twelfth exemplary embodiment of the present invention is a projection device according to the projection device in the first exemplary embodiment, wherein the control circuit controls the semiconductor light source and/or the spatial light modulator in such a way as to change the white balance or a gamma characteristic of an image to be projected.

The thirteenth exemplary embodiment of the present invention is a projection device according to the projection device in the first exemplary embodiment, wherein the control circuit controls the semiconductor light source and/or the spatial light modulator in such a way that time during which the illumination light of each wavelength is projected may become almost equal in each frame period of the image signal.

The fourteenth exemplary embodiment of the present invention is a projection device according to the projection device in the first exemplary embodiment, wherein the control circuit controls the semiconductor light source in such a way as to output illumination light of each wavelength in a shorter cycle than the modulation cycle of the spatial light modulator.

The fifteenth exemplary embodiment of the present invention is a projection device according to the projection device in the second exemplary embodiment, wherein the plurality of sub light sources of each wavelength has the same polarization direction.

The sixteenth exemplary embodiment of the present invention is a projection device according to the projection device in the second exemplary embodiment, wherein the plurality of sub light sources of at least one wavelength has a different polarization direction.

The seventeenth exemplary embodiment of the present invention is a projection device according to the projection device in the first exemplary embodiment, comprising a polarization control unit for controlling the polarization direction of the polarized light, wherein the illumination light and/or its projected light are polarized light.

The eighteenth exemplary embodiment of the present invention is a projection device according to the projection device in the seventeenth exemplary embodiment, wherein the polarization control unit comprises a polarization filter and a polarization conversion element for switching a polarization direction.

The nineteenth exemplary embodiment of the present invention is a projection device according to the projection device in the seventeenth exemplary embodiment, wherein the polarization control unit controls the polarization direction of light of a plurality of wavelengths in the illumination light.

The twentieth exemplary embodiment of the present invention is a projection device according to the projection device in the first exemplary embodiment, comprising two of the spatial light modulators, wherein the spatial light modulators modulates illumination light of different polarization directions and the same wavelength.

The twentieth-first exemplary embodiment of the present invention is a projection device according to the projection device in the first exemplary embodiment, wherein the illumination light applied to the spatial light modulators is one of cyan, magenta, yellow and white, and the spatial light modulator modulates the illumination light on the basis of an image signal corresponding to the illumination light.

The twentieth-second exemplary embodiment of the present invention is a projection device according to the projection device in the first exemplary embodiment, wherein the illumination optical system includes at least one of a diffractive optical element, an optical fiber, a micro-lens array and a rod pipe.

The twentieth-third exemplary embodiment of the present invention is a projection device according to the projection device in the first exemplary embodiment, wherein the illumination light outputted from the semiconductor light source has a plurality of wavelengths, and the optical axis of the illumination light of each wavelength does not coincide with the optical axis of the illumination light of another wavelength.

The twentieth-fourth exemplary embodiment of the present invention is a projection device according to the projection device in the first exemplary embodiment, wherein the control circuit controls the semiconductor light source of at least one wavelength on the basis of the image signal.

The twentieth-fifth exemplary embodiment of the present invention is a projection device according to the projection device in the first exemplary embodiment, comprising a wobbling unit for wobbling the projected light, wherein the spatial light modulator is a mirror device including a plurality of mirror elements for modulating the illumination light outputted from the semiconductor light source and controlling the reflection direction of the illumination light.

The twentieth-sixth exemplary embodiment of the present invention is a projection device according to the projection device in the twentieth-fifth exemplary embodiment, wherein the control circuit controls the semiconductor light source before/after or during wobbling the projected light.

The twentieth-seventh exemplary embodiment of the present invention is a projection device according to the projection device in the first exemplary embodiment, wherein the spatial light modulator is a mirror device in which 1,000,000 or more mirror elements having a set of at least one address electrode and memory, for modulating the illumination light outputted from the semiconductor light source and controlling the deflected direction of the illumination light are arranged in an array, and the ratio between the light level and dark level of contrast of an image projected by the projection optical system is 5000:1 to 10000:1.

The twentieth-eighth exemplary embodiment of the present invention is a projection device according to the projection device in the first exemplary embodiment, wherein the spatial light modulator is a mirror device in which 1,000,000 or more mirror elements having a set of at least one address electrode and memory, for modulating the illumination light outputted from the semiconductor light source and controlling the deflected direction of the illumination light are arranged in an array, and by the control circuit controlling the spatial light modulation using at least pulse width modulation control and also controls the semiconductor light source using pulse modulation control, projected light modulated by the spatial light modulator the has 1,000 or more levels of gray scale.

The twentieth-ninth exemplary embodiment of the present invention is a projection device, comprising a semiconductor light source of different wavelengths, comprising a plurality of sub light sources disposed in an array, an illumination optical system for guiding an illumination light outputted from the semiconductor light source, a spatial light modulator for receiving and applying an image signal for modulating the illumination light outputted from the semiconductor light source guided by said illumination optical system, a control circuit for controlling the semiconductor light source and the spatial light modulator, and a projection optical system for projecting an image by the illumination light modulated by the spatial light modulator, wherein the semiconductor light source has different wavelengths, the control circuit modifies at least one of the following parameters consisted of an emission intensity, a number of times of emission, an emission period and an emitting timing of the sub light source or a number of emitted light and an emitting position of the sub light sources and also controls or adjusts the total length of time of sub-frame time for each wavelength for outputting the illumination light.

The thirtieth exemplary embodiment of the present invention is a projection device according to the projection device in the twentieth-ninth exemplary embodiment, wherein the control circuit controls or adjusts at least two of the emission intensity, times of emission, emission period and emitting timing of the sub light source or the number of emitted light and emitting position of the sub light sources arranged in an array to produce at least one color of the projected image.

The thirtieth-first exemplary embodiment of the present invention is a projection device according to the projection device in the twentieth-ninth exemplary embodiment, comprising a plurality of the spatial light modulators, wherein at least one of the spatial light modulators modulates the illumination light of a plurality of wavelengths according to the image signal.

The thirtieth-second exemplary embodiment of the present invention is a projection device according to the projection device in the twentieth-ninth exemplary embodiment, wherein the projection optical system combines the illumination light modulated by the spatial light modulator.

The thirtieth-third exemplary embodiment of the present invention is a projection device according to the projection device in the twentieth-ninth exemplary embodiment, comprising a wobbling unit for wobbling the projected light, wherein the control circuit controls at least one of the emission intensity, the number of times of emission, the emission period and the emitting timing of the sub light source or the number of emitted light and the emitting position of the sub light sources during the projection period of the image before or after wobbling the projected light.

The thirtieth-fourth exemplary embodiment of the present invention is a projection device according to the projection device in the twentieth-ninth exemplary embodiment, wherein by the control circuit controlling the semiconductor light source, the gradation of illumination light of at least one wavelength and/or the number of sub-frames during each frame period of the image signal differ.

The thirtieth-fifth exemplary embodiment of the present invention is a projection device according to the projection device in the twentieth-ninth exemplary embodiment, wherein the sub light source also comprises a plurality of light sources.

The thirtieth-sixth exemplary embodiment of the present invention is a projection device according to the projection device in the twentieth-ninth exemplary embodiment, wherein the spatial light modulator is a mirror device in which 1,000,000 or more mirror elements having a set of at least one address electrode and memory, for modulating the illumination light outputted from the semiconductor light source and controlling the deflected direction of the illumination light are disposed in an array, and the ratio between the light level and dark level of the contrast of an image projected by the projection optical system is 5000:1 to 10000:1.

The thirtieth-seventh exemplary embodiment of the present invention is a projection device according to the projection device in the twentieth-ninth exemplary embodiment, wherein the spatial light modulator is a mirror device in which 1,000,000 or more mirror elements having a set of at least one address electrode and memory, for modulating the illumination light outputted from the semiconductor light source and controlling a deflected direction of the illumination light are disposed in an array and by the control circuit controlling the spatial light modulation using at least pulse width modulation control and also controls the semiconductor light source using pulse modulation control, projected light modulated by the spatial light modulator the has 1,000 or more levels of gray scale.

The thirtieth-eighth exemplary embodiment of the present invention is a projection device, comprising a semiconductor light source comprises a plurality of sub light sources arranged in an array, an illumination optical system for guiding an illumination light outputted from the semiconductor light source, a spatial light modulator for receiving and applying an image signal for modulating the illumination light outputted from the semiconductor light source guiding by illumination optical system, a control circuit for controlling the semiconductor light source and the spatial light modulator, and a projection optical system for projecting images by applying the illumination light modulated by the spatial light modulator, wherein the control circuit controls the spatial light modulator and/or the semiconductor light source in the frame cycle of 120 Hz or more and controls at least one of following parameters consisted of an the emission intensity, a number of times of emission, an emission period and an emitting timing of the sub light source or a number of emitted light and an emitting position of the sub light sources for each frame.

The thirtieth-ninth exemplary embodiment of the present invention is a projection device according to the thirtieth-eighth exemplary embodiment of the present invention, wherein the spatial light modulator is a mirror device in which mirror elements for modulating the illumination light outputted from the semiconductor light source and deflecting the illumination light in an ON direction which leads reflected light of the illumination light to the projection optical system, in an OFF direction which does not lead the reflected light of the illumination light to the projection optical system or in an intermediate direction between the ON direction and OFF direction are arranged in an array.

The fortieth exemplary embodiment of the present invention is a projection device according to the thirtieth-eighth exemplary embodiment of the present invention, wherein by the control circuit controlling the semiconductor light source, the gradation of illumination light of at least one wavelength and/or number of sub-frames during each frame period of the image signal differ.

The fortieth-first exemplary embodiment of the present invention is a projection device according to the thirtieth-eighth exemplary embodiment of the present invention, wherein the sub light source also comprises a plurality of light sources.

The fortieth-second exemplary embodiment of the present invention is a projection device according to the thirtieth-eighth exemplary embodiment of the present invention, wherein the spatial light modulator is a mirror device in which 1,000,000 or more mirror elements having a set of at least one address electrode and memory, for modulating the illumination light outputted from the semiconductor light source and controlling the deflected direction of the illumination light are arranged in an array, and the ratio between the light level and dark level of the contrast of an image projected by the projection optical system is 5000:1 to 10000:1.

The fortieth-third exemplary embodiment of the present invention is a projection device according to the thirtieth-eighth exemplary embodiment of the present invention, wherein the spatial light modulator is a mirror device in which 1,000,000 or more mirror elements having a set of at least one address electrode and memory, for modulating the illumination light outputted from the semiconductor light source and controlling the deflected direction of the illumination light are disposed in an array, and by the control circuit controlling the spatial light modulation using at least pulse width modulation control and also controls the semiconductor light source using pulse modulation control, projected light modulated by the spatial light modulator has approximately 1,000 or more levels of gray scale.

The projection device of the present invention can display an image to be projected by high gradation by controlling or adjusting at least two of the emission intensity, times of emission, emission period and emitting timing of a light source or the number of emitted light and emitting position of a sub light source in synchronization with a spatial light modulator. By appropriately performing such synchronous control or adjustment, color breaks can be made inconspicuous.

### BRIEF DESCRIPTION OF THE DRAWINGS

The present invention is described in detail below with reference to the following drawings.

FIG. 1A is a functional block diagram showing the structure of the conventional projection device.

FIG. 1B is a top view diagram showing the structure of the mirror elements of the conventional projection device.

FIG. 1C is a circuit diagram showing the structure of the driver circuit of the mirror elements of the conventional projection device.

FIG. 1D is a timing diagram showing the format of image data in the conventional projection device.

FIG. 2 shows one example of a multi-plate optical structure.

FIG. 3 is a diagram showing the relationship among the numerical aperture NA1 of an illumination light path, the numerical aperture NA2 of a projected light path and the inclination angle α of a mirror.

FIG. 4 is a side cross-sectional view explaining etendue as an example of using a discharge lamp light source and projecting images via an optical element.

FIG. 5 is a conceptual diagram showing the structure of the projection device in one preferred embodiment of the present invention.

FIG. 6A is a conceptual drawing showing the structure of a single-plate projection device in another preferred embodiment of the present invention.

FIG. 6B is a conceptual drawing showing the structure of a variation example of the single-plate projection device in another preferred embodiment of the present invention.

FIG. 6C is a conceptual drawing showing the structure of another variation example of the single-plate projection device in another preferred embodiment of the present invention.

FIG. 7A is the front view of a two-plate projection device provided with a plurality of mirror devices packed in one package.

FIG. 7B is the rear view of the two-plate projection device shown in FIG. 7A.

FIG. 7C is the side view of the two-plate projection device shown in FIG. 7A.

FIG. 7D is the top view of the two-plate projection device shown in FIG. 7A.

FIG. 8 is a typically timing chart for showing the semi-ON state of a current-driven light source.

FIG. 9 is a typically timing chart graph for showing the semi-ON state in the case where mirror control is synchronized with the current drive of a light source and also a semi-ON state is obtained by emitting a pulse with modulation in a spatial light modulator composed of mirror elements.

FIG. 10 is a block diagram showing the control unit of the projection device in the preferred embodiment of the present invention.

FIG. 11 is a block diagram showing the circuit structure of the control unit of the projection device in the preferred embodiment of the present invention.

FIG. 12 is a block diagram showing a structure example of the control unit provided for the projection device in the preferred embodiment of the present invention.

FIG. 13 is a timing diagram for showing the waveform of the control signal of the projection device in the preferred embodiment of the present invention.

FIG. 14 is a chart for showing a conversion example from binary data to non-binary data performed in the projection device in the preferred embodiment of the present invention (No. 1).

FIG. 15 is a chart for showing a conversion example from binary data to non-binary data performed in the projection device in the preferred embodiment of the present invention (No. 2).

FIG. 16 is a chart for showing a conversion example from binary data to non-binary data performed in the projection device in the preferred embodiment of the present invention (No. 3).

FIG. 17 is a chart for showing a conversion example from binary data to non-binary data performed in the projection device in the preferred embodiment of the present invention (No. 4).

FIG. 18 is a perspective view for showing one example of the internal structure of a light source provided for the projection device in the preferred embodiment of the present invention (No. 1).

FIG. 19 is a perspective view for showing one example of the internal structure of a light source provided for the projection device in the preferred embodiment of the present invention (No. 2).

FIG. 20 is the perspective view of a spatial light modulator in which a plurality of mirror elements for controlling the reflection direction of incident light by deflecting a mirror are two-dimensionally arranged on a device substrate.

FIG. 21 is a functional block diagram for showing the cross section of one mirror element (one pixel unit) at a line II-II, of the spatial light modulator shown in FIG. 20.

FIG. 22A is a diagram for showing the state where the mirror of a mirror element is deflected and incident light is reflected to the projection optical system.

FIG. 22B is a diagram for showing the state where the mirror of a mirror element is deflected and incident light is not reflected to the projection optical system

FIG. 22C is a diagram for showing the state where the mirror of a mirror element is freely vibrated and incident light is reflected and is not reflected to the projection optical system repeatedly.

FIG. 23A is a diagram for showing the cross-section of a mirror element in another preferred embodiment in which one address electrode and one driver circuit correspond to one mirror element.

FIG. 23B is a diagram for roughly showing the cross-section of the mirror element shown in FIG. 23A.

FIG. 24A is the top and side views of a mirror element structured in such a way that the areas S1 and S2 of the first and second electrode parts, respectively, of one address electrode have the relation of S1>S2 and the joint part of the first and second electrode parts is located in the same structure layer.

FIG. 24B is the top and side views of a mirror element structured in such a way that the areas S1 and S2 of the first and second electrode parts, respectively, of one address electrode have the relation of S1>S2 and the joint part of the first and second electrode parts is located in a different structure layer from the first and second electrode parts.

FIG. 24C is the upper and side views of a mirror element structured in such a way that the areas S1 and S2 of the first and second electrode parts, respectively, of one address electrode have a relation of S1=S2 and the distance G1 between a mirror and the first electrode part and the distance G2 between the mirror and the second electrode part have the relation of G1<G2.

FIG. 25 is a diagram for showing data input to the mirror element, voltage application to the address electrode and the deflection angle of the mirror which are shown in FIG. 24A in time sequence.

FIG. 26A is a diagram for showing the structure in the initial state of one mirror element in this preferred embodiment.

FIG. 26B is a diagram for showing the structure in the case where the mirror in one mirror element in this preferred embodiment is in the ON state.

FIG. 26C is a diagram for showing the structure in the case where the mirror in one mirror element in this preferred embodiment is in the OFF state.

FIG. 26D is a diagram for showing the structure in the case where the mirror in one mirror element in this preferred embodiment is in the freely oscillating state.

FIG. 27 is a diagram for showing the structure in which materials having different dielectric constants are used for the upper section of the first and second electrode parts of a single address electrode in one mirror element in this preferred embodiment.

FIG. 28 is a chart for showing an example of preventing color breaks by the combination of mirror ON/OFF control and mirror oscillation control in the projection device in the preferred embodiment of the present invention.

FIG. 29 shows an exemplary embodiment of the wobbling of the optical modulation element of the spatial light modulator in the case where the wobbling device in this preferred embodiment is operated.

FIG. 30 shows an exemplary embodiment of the state where the even number field of the interlace signal in this preferred embodiment is wobbled in the vertical direction after the odd number field is displayed.

FIG. 31 is a diagram for showing the synchronization between a light source and the change of a mirror position in a mirror device by wobbling in one frame in this preferred embodiment.

### DESCRIPTION OF THE PREFERRED EMBODIMENTS

First, the method of specifying the deflection angles of a deflectable mirror in a mirror device in this preferred embodiment is briefly described.

### [Summary of Device]

Projection apparatuses using a spatial light modulator, such as a transmissive liquid crystal, a reflective liquid crystal, a mirror array, etc., are widely known.

A spatial light modulator includes a two-dimensional array that arranges, enlarges, and then displays onto a screen by way of a projection lens arrayed as tens of thousands to millions of miniature modulation elements for projecting individual pixels corresponding to an image.

The spatial light modulators generally used for projection apparatuses are of primarily two types: 1) a liquid crystal device for modulating the polarizing direction of incident light; a liquid crystal is sealed between transparent substrates and provides them with a potential, and 2) a mirror device that deflects miniature micro electro mechanical systems (MEMS) mirrors with electrostatic force and controls the direction of reflected illumination light.

One embodiment of the above described mirror device is disclosed in U.S. Pat. No. 4,229,732, in which a drive circuit using MOSFET and deflectable metallic mirrors are set on a semiconductor wafer substrate. The mirror can be deformed by electrostatic force supplied from the drive circuit and is capable of changing the direction of reflected incident light.

Meanwhile, U.S. Pat. No. 4,662,746 has disclosed an embodiment in which one or two elastic hinges retain a mirror. If the mirror is retained by one elastic hinge, the elastic hinge functions as bending spring. If two elastic hinges retain the mirror, these two elastic hinges function as torsion springs to incline the mirror and thereby deflect the direction of reflected incident light. As described earlier, the on and off states of a micro-mirror control scheme as that implemented in U.S. Pat. No. 5,214,420 and most of the conventional display systems impose a limitation on the quality of the display. Specifically, when applying the conventional structure of a control circuit, there is a limitation that the gray scale of the conventional system (PWM between ON and OFF states) is limited by the LSB (the least significant bit or the least pulse width). Due to the ON/OFF states implemented in the conventional system, there is no way to provide a shorter pulse width than the LSB. The least brightness, which determines a gray scale, is light reflected during the least pulse width. The limited gray scales lead to the degradation of image display quality.

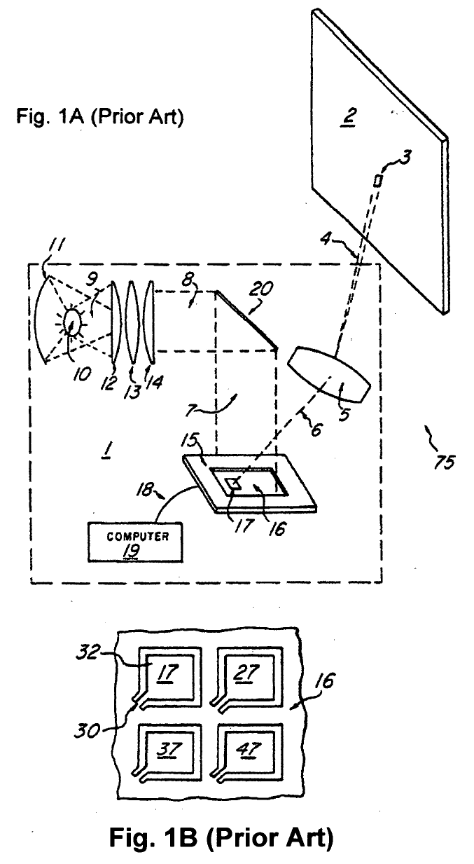

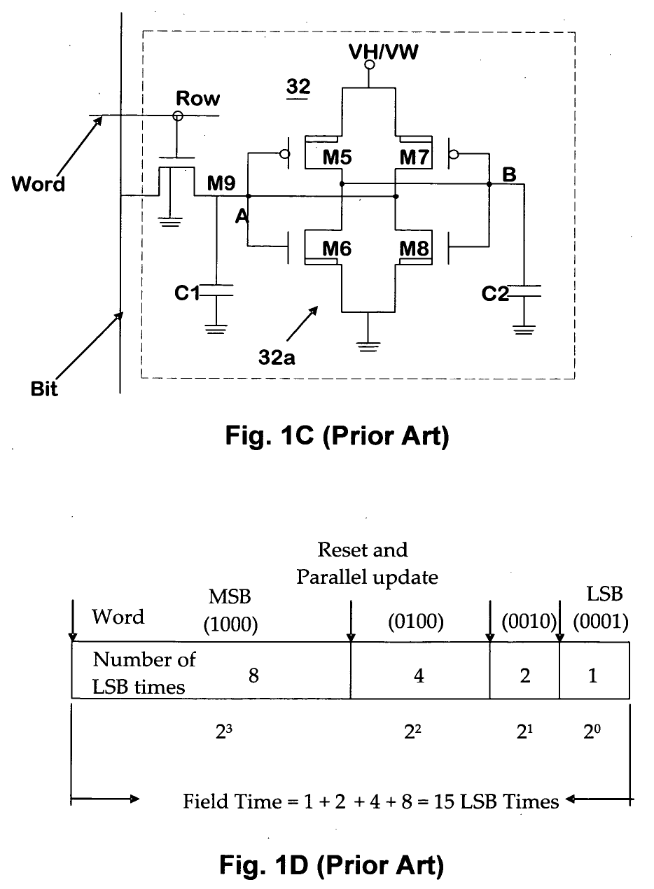

Specifically, FIG. 1C shows an exemplary control circuit for controlling a mirror element according to the disclosure made in U.S. Pat. No. 5,285,407. The control unit includes a memory cell 32. Various transistors are referenced as “M*” where “*” designates a transistor number and each transistor is an insulated gate field effect transistor. Transistors M5 and M7 are p-channel transistors; while transistors M6, M8 and M9 are n-channel transistors. Capacitors C1 and C2 represent capacitive loads in the memory cell 32. The memory cell 32 includes an access switch transistor M9 and a latch 32a, which is based on a static random access switch memory (SRAM) design. The transistor M9 connected to a Row-line receives a DATA signal via a Bit-line. Data written in the memory cell 32 is accessed when the transistor M9 that has received the ROW signal on a Word-line is turned on. The latch 32a consists of two cross-coupled inverters, i.e., M5/M6 and M7/M8, which permit two stable states, that is, a state 1 is one where Node A is high and Node B low, and a state 2 one where Node A is low and Node B high.

The mirror is driven by a voltage applied to the landing electrode, abutting on a landing electrode and is held at a predetermined deflection angle on the landing electrode. An elastic “landing chip” is formed at a contact part to the landing electrode, which assists the operation of deflecting the mirror toward the opposite direction when the deflection of the mirror is switched. The landing chip is designed to have the same potential as the landing electrode, so that shorting is prevented when the landing electrode is contact with the mirror.

### [Summary of PWM Control]

As described above, the control circuit positions the micromirrors in either an ON or OFF angular orientation (as shown in FIG. 1A). The brightness, i.e., the level of gray scales, of a display for a digitally controlled image system is determined by the length of time the micromirror stays at an ON position. The length of time a micromirror stays at an ON position is in turn controlled by a multiple bit word. As a simple illustration, FIG. 1D shows the “binary time intervals” with control by a four-bit word. As shown in FIG. 1D, time durations have relative values of 1, 2, 4, and 8 that in turn define the relative brightness for each of the four bits where “1” is the least significant bit and “8” is the most significant bit. The minimum difference between gray scales for indicating different light intensities is limited by the “least significant bit” that maintains the micromirror at an ON position.

For example, assuming an n-bit gray scale, the time frame is divided into (2ⁿ−1) equal time periods. For a 16.7-millisecond time frame and n-bit intensity values, the time period is 16.7/(2ⁿ−1) milliseconds

Having established these times, for each pixel of each frame, pixel intensities are quantified, such that black is “0” time period, the intensity level represented by the LSB is “1” time period, and maximum brightness is “15” time periods (in the case of n=4). The quantified intensity of each pixel determines its ON-time during a time frame. Thus, during a time frame, each pixel with a quantified value of more than “0” is ON for the number of time periods that correspond to its intensity. The viewer's eye integrates the pixel brightness so that the image appears as if it were generated with analog levels of light.

To address this limitation in mirror devices, a pulse width control (PWM) scheme calls for data formatted into “bit-planes”, each bit-plane corresponding to the bit weight of the intensity value. Thus, if the intensity of each pixel is represented by an n-bit value, each frame of data has n bit-planes. Each bit-plane has “0” or “1” value for each display element. In the PWM example described in the preceding paragraphs, during a frame, each bit-plane is separately loaded and the display elements are addressed in accordance with their associated bit-plane values. For example, the bit-plane representing the LSB of each pixel is displayed for 1 time period.

### [Summary of Mirror Size and Resolution]

The size of the mirrors of such a mirror device is between 4 μm and 10 μm for each side. The mirrors are placed on a semiconductor wafer substrate in such a manner as to minimize the gap between adjacent mirrors so that excess reflected light from the gap does not degrade the contrast of a modulated image.

The mirror device comprises the appropriate number of mirror elements as image display elements. The appropriate number of image display elements is determined in compliance with the display resolution specified by the Video Electronics Standards Association (VESA) and the television-broadcasting standard. In the case of a mirror device comprising the number of mirror elements compliant to the WXGA (with the resolution of 1280×768) specified by the VESA, and in which mirrors are arrayed in intervals (noted as “pitch” hereinafter) of 10 μm, a sufficiently miniature mirror device is configured with about 15.49 mm (0.61 inches) as the diagonal length of the display area.

### [Summary of Projection Device Structure]

The projection device using a deflective light modulator is roughly classified into a single-plate projection device for changing the frequency of projected light time wise using only one spatial light modulator and displaying images in color and a multi-plate projection device for each spatial light modulator always modulating illumination light having different frequency using a plurality of spatial light modulators and displaying images in color by composing the plurality of pieces of illumination light.

As to the single-plate projection device, the device is structured as described with reference to FIG. 1A.

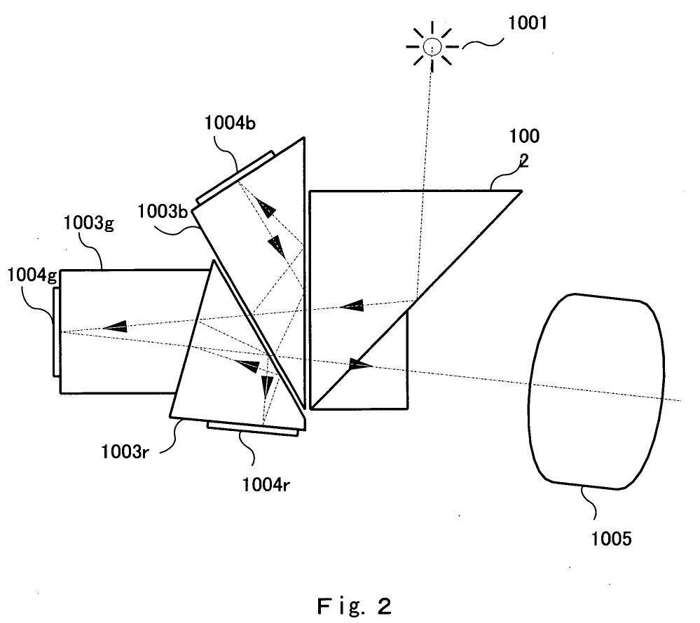

FIG. 2 shows an example of a multi-plate optical configuration.

In FIG. 2, the illumination light from a light source 1001 is projected to the total reflection surface of a total internal reflection (TIR) prism 1002 at a critical angle (or higher) and is directed to a prism for color synthesis and separation. The TIR prism 1002 is used for separating the light paths of the light between the illumination light and the light modulated by a deflectable spatial light modulator. The color separation/synthesis prism is configured by placing a first color separation/synthesis prism 1003b and a first junction prism made by joining a second color separation/synthesis prism 1003r to a third color separation/synthesis prism 1003g.

A first dichroic film, which reflects only the blue light of the illumination light and transmits other colors, is placed on the emission surface of the first color separation/synthesis prism 1003b. The blue illumination light reflected by the first dichroic film is totally reflected by the incidence surface of the first color separation/synthesis prism 1003b and is incident to a first spatial light modulator 1004b at a desired incident angle. The modulation light reflected towards the ON light by the first spatial light modulator 1004b, proceeding in a perpendicular direction to the first spatial light modulator 1004b, is totally reflected by the incident surface of the first color separation/synthesis prism 1003b and reflected by the first dichroic film towards the projection light path. The red and green illumination lights transmitting through the first dichroic film pass through an air layer and enter the second color separation/synthesis prism 1003r.

A second dichroic film, which reflects only red light, is placed on the junction surface between the second color separation/synthesis prism 1003r and third color separation/synthesis prism 1003g. Therefore, the second dichroic film reflects the red light of the illumination light to the second color separation/synthesis prism 1003r. The reflected red illumination light is totally reflected by the light incident surface of the second color separation/synthesis prism 1003r and enters into a second spatial light modulator 1004r. The light modulated by the second spatial light modulator 1004r is reflected by the incident surface and second dichroic film to proceed towards the projection light path. The green light passes through the second dichroic film is modulated by a third spatial light modulator 1004g and is reflected towards the projection light path. The individual color lights modulated by the first through third spatial light modulators 1004b, 1004r and 1004g and reflected toward the same light path transmit through the total reflection surface of the TIR prism 1002 and are projected by a projection lens 1005 onto the projection surface.

The multiple panel configurations prevent the problem of a color break. Unlike a single-panel projection apparatus, the color break problem is resolved because each primary color is constantly projected. Further, this configuration produces images with a higher level of brightness because the light from a light source is effectively utilized. On the other hand, the process of assembling the multi-panel projection apparatus is a more complicated one. For example, the spatial light modulators must be placed in proper locations corresponding to the respective colors and the assembling processes require more alignment adjustments. There are further problems due to the size increase of such apparatus.

### [Summary of Laser Light Source]

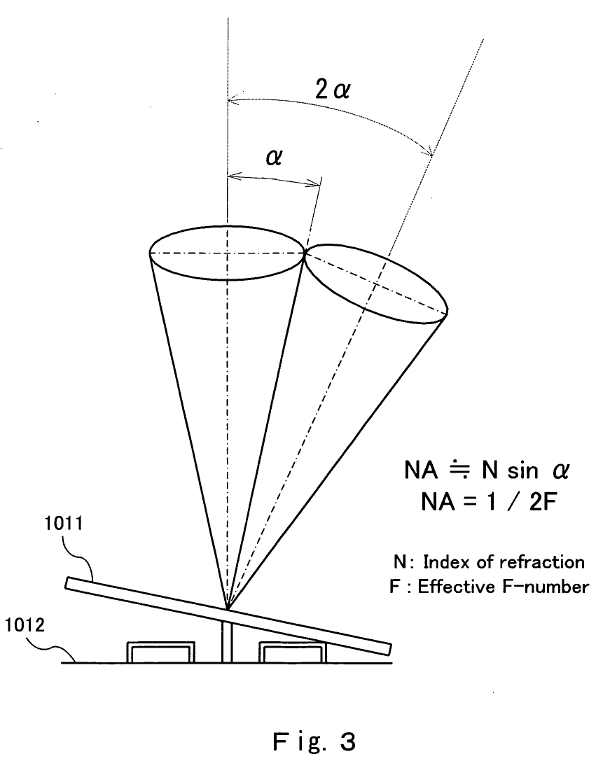

In the projection apparatus that includes a reflective spatial light modulator implemented with a mirror described above, there is a close relationship between the numerical aperture (NA) NA1 of an illumination light path, the numerical aperture NA2 of a projection light path, and the tilt angle α of a mirror. FIG. 3 shows the relationship between them.

Assuming that the tilt angle α of a mirror 1011 is 12 degrees, when a modulated light reflected by mirror 1011 and incident to the center of the projection light path is set perpendicular to a device substrate 1012, the illumination light is incident from a direction inclined by 2α, that is, 24 degrees, relative to the perpendicular of the device substrate 1012. For the light beam reflected by the mirror to be most efficiently incident to the center of the projection lens, the numerical aperture of the projection light path should be equal to the numerical aperture of the illumination light path. If the numerical aperture of the projection light path is smaller than that of the illumination light path, the illumination light cannot be sufficiently projected into the projection light path. However, if the numerical aperture of the projection light path is larger than that of the illumination light path, the illumination light can be entirely directed. The projection lens then becomes unnecessarily large.

Furthermore, the light fluxes of the illumination light and projection light need to be placed apart from each other because the optical members of the illumination system and those of the projection system need to be physically separated. Keeping the above considerations in mind, when a spatial light modulator with the tilt angle of a mirror being 12 degrees is used, the numerical aperture (NA) NA1 of the illumination light path and the numerical aperture NA2 of the projection light path are preferably set as follows:

NA1=NA2=sin α=sin 12 deg

If the F-number of the illumination light path is F1 and the F-number of the projection light path is F2, then the numerical aperture can be converted into an F-number as follows:

F1=F2=1/(2×NA)=1/(2×sin 12 deg)=2.4

In order to maximize the use of illumination light emitted from a non-coherent light source, such as a high-pressure mercury lamp or a xenon lamp, which is generally used for projection apparatuses, the projection angle of light must be maximized on the illumination light path side. Since the numerical aperture of the illumination light path is determined by the tilt angle of a mirror to be used, it is clear that the tilt angle of the mirror needs to be large in order to increase the numerical aperture of the illumination light path.

However, when the inclination angle of a mirror is increased, the drive voltage for driving the mirror must also be increased. When increasing the inclination angle of a mirror, a physical space for inclining the mirror must be secured. Therefore, a distance between the mirror and an electrode for driving it must be increased. If it is assumed that the area of an electrode, voltage, a distance between the electrode and a mirror and the dielectric constant of vacuum are S, V, d and ∈, respectively, the electrostatic force F occurring between the mirror and the electrode can be calculated as follows:

F=(∈×S×V²)/(2×d²)

The equation shows that the drive force decreases in proportion to the second power of the distance d between the electrode and the mirror. It is possible to increase the drive voltage to compensate for the decrease in the drive force associated with the increase in the distance; conventionally, however, the drive voltage is about 5 to 10 volts in the drive circuit by means of a CMOS process used for driving a mirror and. If a voltage in excess of that is needed, a relatively special process such as a DMOS process is required. That is not preferable since cost reduction remains a consideration.

Furthermore, in order to reduce the cost of a mirror device, it is desirable to obtain as many mirror devices as possible from a single semiconductor wafer substrate to increase productivity. That is, a decrease in the size of mirror elements reduces the size of the mirror device. It is clear that the area size of an electrode is reduced in association with a decrease in the size of the mirror, which also requires less driving power in accordance with the above equation.

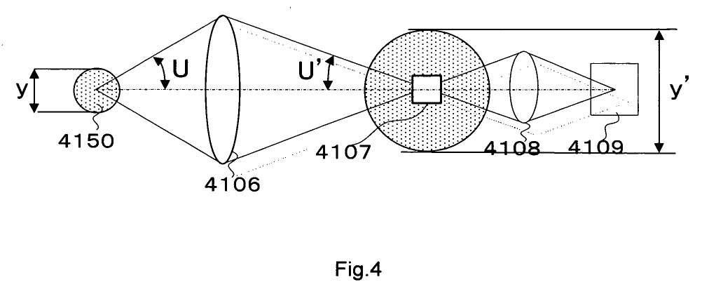

In contrast to the need to decrease the size of a mirror device, the larger a mirror device, the brighter it can illuminate, as long as a conventional lamp is used. This is because a conventional lamp with a non-directive emission allows the usage efficiency of light to be substantially reduced. This is attributable to a relationship commonly called etendue. If it is assumed, as shown in FIG. 4, that the size of a light source, the angle of light with which an optical lens 4106 transmits the light from the light source, the size of a light source image, and the converging angle on the image side, converged by using the optical lens 4106, are y, u, y′ and u′, respectively, the following relation holds true among them:

Y×u=y′×u′

That is, the smaller the device onto which a light source will project an image, the smaller the transmitting angle on the light source side becomes. This is why it is advantageous to use a laser light source, which possesses strong directivity of emission light, in order to decrease the size of the mirror device. In FIG. 4, numerical references 4150, 4106, 4107, 4108 and 4109 represent an illumination lens, a device, a projection lens and a projected image, respectively.

### [Summary of Resolution Limit]

As to the numerical aperture of a projection lens used in a device in which the display surface of a spatial light modulator is enlarged and displayed, the following equation can be obtained when examining its limit value from the viewpoint of the resolution of a projected image. If it is assumed that the pixel pitch of a spatial light modulator, the numerical aperture of a projection lens, an F number and the wavelength of light are ∈, NA, F and λ, respectively, the limit ∈ up to which two adjacent pixels can be separately observed on a projection plane can be obtained as follows.

∈=0.61×λ/NA=1.22×λ×F

The F number of a projection lens when the wavelength light λ is 650 nm (λ=650 nm), which is the worst condition within the range of visible light is miniaturized and the pitch of adjacent mirror element are small and the deflection angle of a mirror are shown below. The F-number of a projection lens in the case the wavelength is set to 700 nm is reduced approximately 7% compared with that calculated with the wavelength at 650 nm.

| Mirror | | Mirror |
|---|---|---|
| device pixel | Projection lens | deflection angle |
| pitch [μm] | F number | [deg.] |
| 4 | 5.0 | 5.67 |
| 5 | 6.3 | 4.54 |
| 6 | 7.6 | 3.78 |
| 7 | 8.8 | 3.24 |
| 8 | 10.1 | 2.84 |
| 9 | 11.3 | 2.52 |
| 10 | 12.6 | 2.27 |
| 11 | 13.9 | 2.06 |

Therefore, since the difficulties related to the above described concerns with etendue is circumvented by using a laser light for the light source, the F numbers of the lenses for the illumination system and projection system can be increased to the values shown in the table. Therefore, it is possible to decrease the deflection angle of the mirror element, and thereby, a smaller mirror device with a low drive voltage can be configured.

### [Summary of Oscillation Control]

Besides the method for reducing the inclination angle of a mirror, there is a technology disclosed in US Patent Application 2005/0190429 as another means for reducing drive voltage. By freely oscillating a mirror with a specific number of oscillations, an intensity of light approximately 25% to 37% of the intensity emitted when the mirror is always in an ON state can be obtained.

According to this technique, there is no need to drive a mirror in high speed, and a high gradation can be obtained while maintaining the spring constant of a hinge, which supports the mirror, at a low level, accordingly reducing drive voltage needed. This technique is further effective if it is combined with the above-described method for reducing drive voltage by reducing a mirror deflection angle.

As described above, by using a laser light as a light source, the deflection angle of a mirror can be reduced and the size of a mirror device can be reduced without reducing light intensity. Furthermore, if the above-described oscillation control is used, a high gradation can be realized without the increases of drive voltage.

The projection device in this preferred embodiment, for projecting images by synchronously controlling a light source and a spatial light modulator, is described in more detail on the basis of the above-described structure.

This projection device comprises a semiconductor light source consisting of a plurality of sub light sources, an illumination optical system for directing illumination light outputted from the semiconductor light source, a spatial light modulator for modulating illumination light according to an image signal, and a control unit 5500 for controlling the spatial light modulator. This control unit 5500 controls or adjusts at least two of the following: emission intensity, times of emission, emission period, and emitting timing of the sub light source or the number of emitted lights and emitting positions of the sub light sources.

One example of such a configuration of the projection device in this preferred embodiment is exemplified below. The projection device in this preferred embodiment can use a mirror device, which is described later.

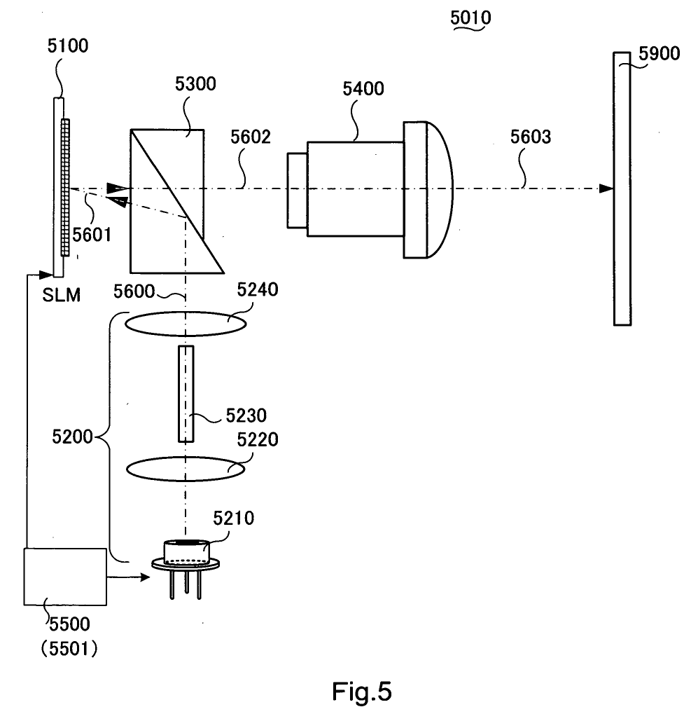

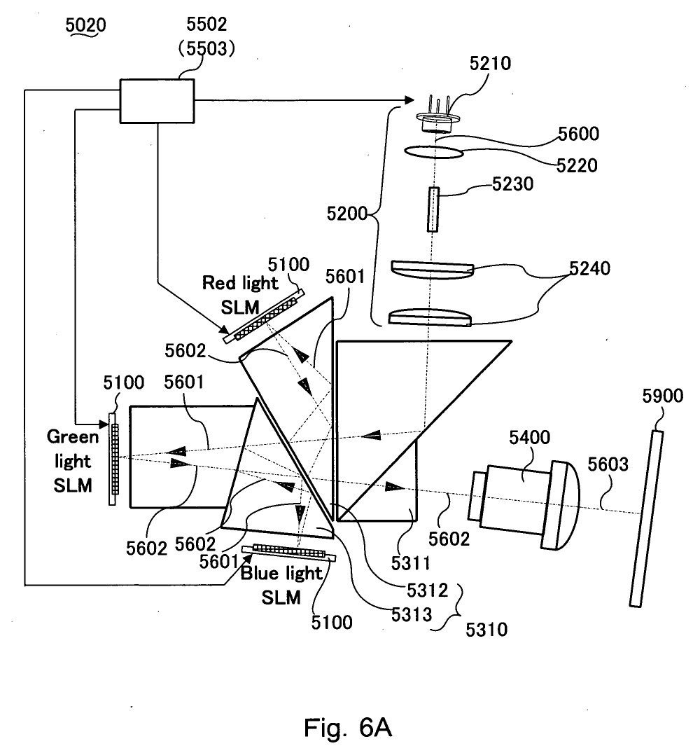

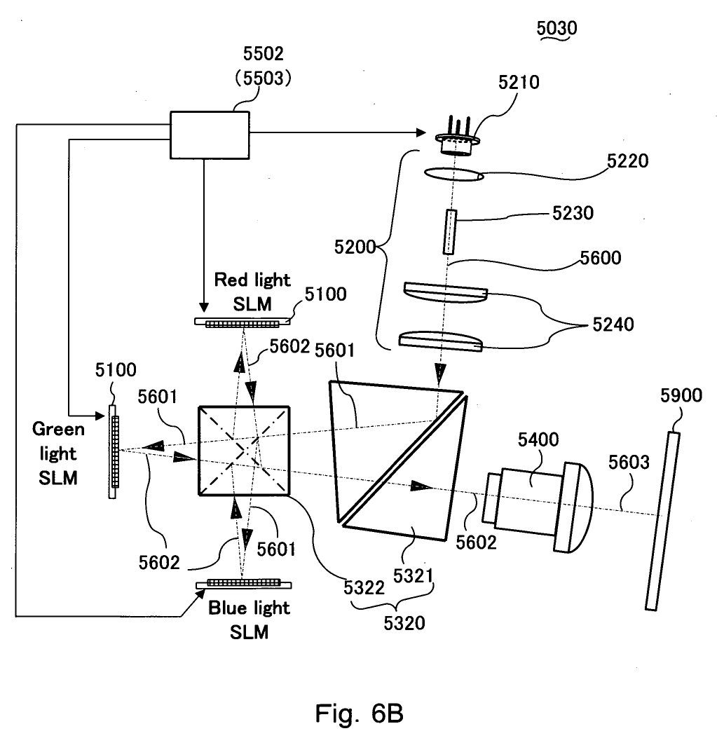

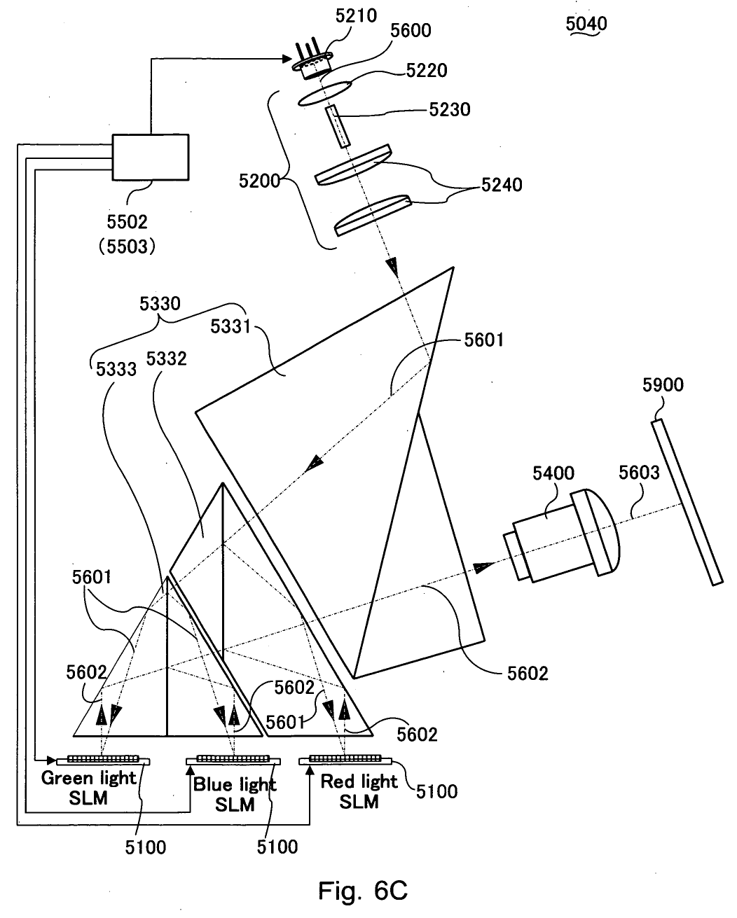

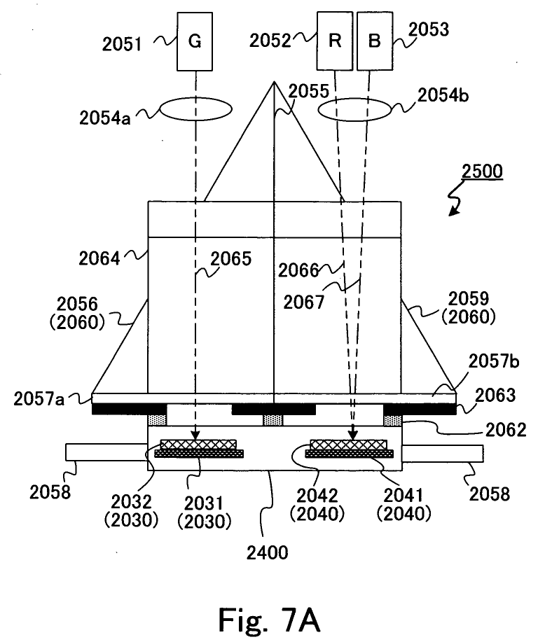

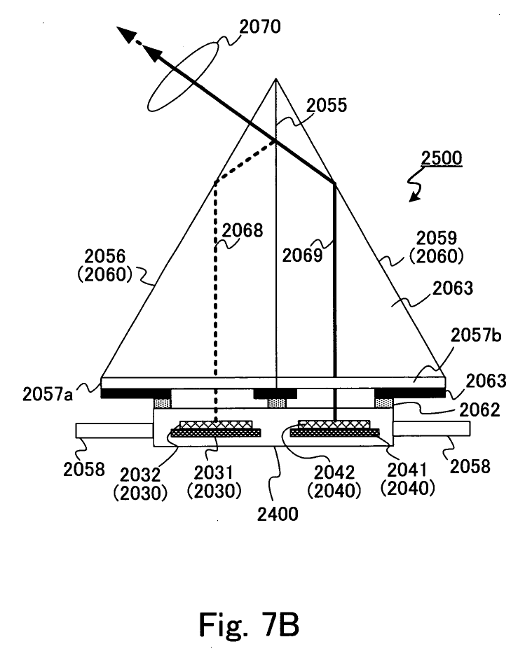

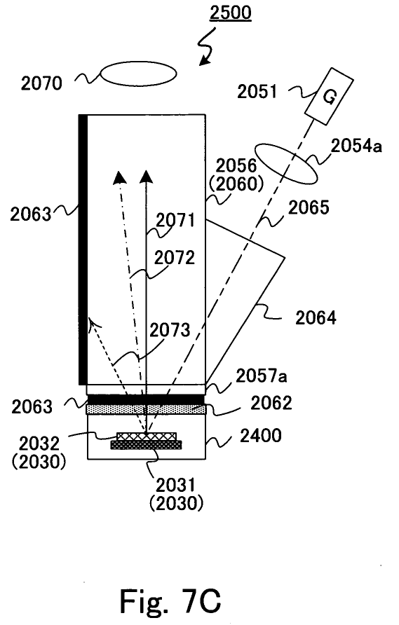

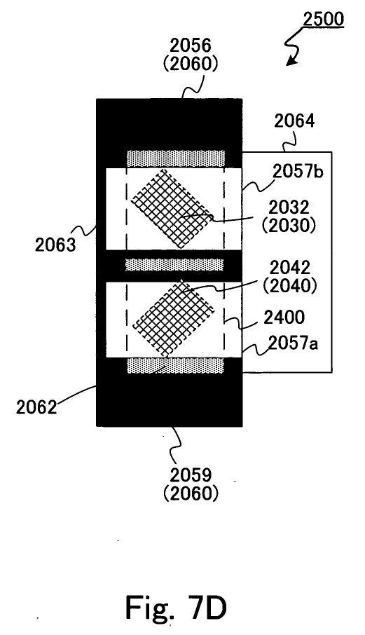

A projection device provided with the above-described mirror device can be a single-plate projection device provided with one mirror device, as shown in FIG. 5, or a multi-plate projection device provided with a plurality of mirror devices, as shown in FIGS. 6A, 6B, 6C or FIGS. 7A, 7B, 7C and 7D.

FIG. 5 is a block diagram showing the configuration of a projection apparatus according to a preferred embodiment of the present invention. FIG. 5 shows a projection apparatus 5010 according to the present embodiment comprising a single spatial light modulator (SLM) 5100, a control unit 5500, a Total Internal Reflection (TIR) prism 5300, a projection optical system 5400 and a light source optical system 5200.

The projection apparatus 5010 is commonly referred to as a single-panel projection apparatus 5010 that includes a single spatial light modulator 5100.

The projection optical system 5400 includes a spatial light modulator 5100 and a TIR prism 5300 disposed along the optical axis of the projection optical system 5400. The light source optical system 5200 is disposed for projecting a light along the optical axis, which matches with the optical path of the projection optical system 5400.

The TIR prism 5300 receives the incoming illumination light 5600, projected from the light source optical system 5200, and directs the light to transmit as incident light 5601 to the spatial light modulator 5100 at a prescribed inclination angle. The SLM 5100 further reflects and transmits the reflection light 5602, towards the projection optical system 5400.

The projection optical system 5400 receives the light 5602 reflected from the SLM 5100 and projects it onto a screen 5900 as projection light 5603.

The light source optical system 5200 comprises a variable light source 5210 for generating the illumination light 5600, a condenser lens 5220 for focusing the illumination light 5600, a rod type condenser body 5230 and a condenser lens 5240.

The variable light source 5210, condenser lens 5220, rod type condenser body 5230 and condenser lens 5240 are sequentially placed in the aforementioned order along the optical axis of the illumination light 5600 emitted from the variable light source 5210 and incident to the side of the TIR prism 5300.

The projection apparatus 5010 employs a single spatial light modulator 5100 for projecting a color display on the screen 5900 by applying a sequential color display method.

Specifically, the variable light source 5210 comprises a red 5211, green 5212, and blue 5213 laser light source (not specifically shown here). The variable light source allows independent controls for the light emission states. The controller of the variable light source performs an operation of dividing one frame of display data into a plurality of sub-fields (i.e., three sub-fields, that is, red (R), green (G) and blue (B) in the present case) and turns on each of the red 5211, green 5212 and blue 5213 laser light source to emit each respective light in time series at the time band corresponding to the sub-field of each color as will be described later.

FIG. 6A is a functional block diagram for showing the configuration of a projection apparatus according to an alternate preferred embodiment of the present invention.

The projection apparatus 5020 is commonly referred to as a multiple-plate projection apparatus that includes a plurality of spatial light modulators 5100 instead of a single SLM included in the single-panel projection apparatus 5010 described earlier. Further, the projection apparatus 5020 comprises a control unit 5502 in place of the control unit 5500.

The projection apparatus 5020 comprises a plurality of spatial light modulators 5100, and further includes a light separation/synthesis optical system 5310 between the projection optical system 5400 and each of the spatial light modulators 5100.

The light separation/synthesis optical system 5310 comprises a plurality of TIR prisms, i.e., a TIR prism 5311, a prism 5312, and a prism 5313.

The TIR prism 5311 carries out the function of directing the illumination light 5600 projected along the optical axis of the projection optical system 5400 and directs the light to the spatial light modulator 5100 as incident light 5601.

The TIR prism 5312 carries out the function of separating red (R) light from an incident light 5601, projected by way of the TIR prism 5311, transmits the red light to the spatial light modulators for the red light 5100. The TIR prism 5312 further carries out the function of directing the reflection light 5602 of the red light to the TIR prism 5311.

Likewise, the prism 5313 carries out the functions of separating blue (B) and green (G) lights from the incident light 5601 projected by way of the TIR prism 5311, and directs the light to the blue color-use spatial light modulators 5100 and green color-use spatial light modulators 5100, and further carries out the function of directing the reflection light 5602 of the green light and blue light to the TIR prism 5311.

Therefore, the spatial light modulations of these three colors, R, G and B, are carried out simultaneously by these three spatial light modulators 5100. The reflection light 5602, resulting from the respective modulations, is projected onto the screen 5900 as the projection light 5603 by way of the projection optical system 5400, and thus a color display is carried out.

The light separation/composition optical system is not limited to the light separation/composition optical system 5310 and various variations can be used.

FIG. 6B is a functional block diagram for showing the configuration of an example of a modification of a multi-panel projection apparatus according to the present embodiment. The projection apparatus 5030 comprises a light separation/synthesis optical system 5320 in place of the above described light separation/synthesis optical system 5310. The light separation/synthesis optical system 5320 comprises a TIR prism 5321 and a cross-dichroic mirror 5322.

The TIR prism 5321 directs the illumination light 5600, entering from the side of the optical axis of the projection optical system 5400, to the spatial light modulator as incident light 5601.

The cross-dichroic mirror 5322 separates red, blue and green light from incident light 5601 arriving from the TIR prism 5321, inputs it into the spatial light modulators 5100 for the red, blue and green colors, respectively, disposed around the cross-dichroic mirror 5322, focuses light 5602 reflected by the spatial light modulators 5100 for each color and directs it to the projection optical system 5400.

FIG. 6C is a functional block diagram for showing the configuration of another exemplary modification of a multi-panel projection apparatus according to the present embodiment. The projection apparatus 5040 is configured; differently from the above-described projection apparatuses by placing 5020 and 5030 adjacent to one another in the same plane. A plurality of spatial light modulators 5100 corresponding to the three colors R, G and B are on one side of a light separation/synthesis optical system 5330. This configuration makes it possible to consolidate the multiple spatial light modulators 5100, by integrating them into the same packaging unit, and thereby saving space.

The light separation/synthesis optical system 5330 comprises a TIR prism 5331, a prism 5332, and a prism 5333.

The TIR prism 5331 has the function of directing, to spatial light modulators 5100, the illumination light 5600, incident in the lateral direction of the optical axis of the projection optical system 5400, as incident light 5601.

The prism 5332 has the functions of separating the red light from the incident light 5601 and directing it towards the red color-use spatial light modulator 5100 and of capturing the reflection light 5602 and directing it to the projection optical system 5400.

Likewise, the prism 5333 has the functions of separating the green and blue incident lights from the incident light 5601, making them incident to the individual spatial light modulators 5100 implemented for the respective colors, and of capturing the green and blue reflection lights 5602 and directing them towards the projection optical system 5400.

FIGS. 7A through 7D show the structure of a two-plate projection device 2500 provided with an assembly 2400, in which two mirror devices 2030 and 2040 are packaged within in one package.

The two-panel projection apparatus 2500 does not project only one color of three colors R, G and B in sequence, nor does it project the R, G and B colors continuously and simultaneously, as in the case of a three-panel projection apparatus. A two-panel projection apparatus projects an image by continuously projecting, for example, a green light source with high visibility and projecting a red light source and a blue light source in sequence.

The two-panel projection apparatus 2500 is capable of changing over colors in high speed by means of pulse emission in 180 kHz to 720 kHz by controlling the laser light sources, thereby making it possible to obscure flickers caused by the change over among the light sources of the different colors.

Further, a projection method for continuously projecting the brightest color and changing over the other colors in sequence, on the basis of the image signals, can also be implemented. Such projection methods can also be adopted for a configuration making R, G and B lights correspond to the respective mirror devices, as in the three-panel projection method.

FIG. 7A is the front view of the two-plate projection device 2500. FIG. 7B is the rear view of the two-plate projection device 2500. FIG. 7C is the side view of the two-plate projection device 2500. FIG. 7D is the top view of the two-plate projection device 2500. The optical structure and projection principle of the projection device 2500 shown in FIGS. 7A through 7D are described below.

The projection device 2500 shown in FIGS. 7A through 7D comprises a green laser light source 2051, a red laser light source 2052, a blue laser light source 2053, illumination optical systems 2054a and 2054b, two triangular prisms 2056 and 2059, ½ wavelength plates 2057a and 2057b corresponding to each mirror device, two mirror devices 2030 and 2040 packaged in one package, a circuit substrate 2058, a light guide prism 2064 and a projection lens 2070.

The two triangular prisms 2056 and 2059 are joined into one polarization beam splitter prism 2060. A polarization beam splitter film 2055 is provided in the joint part between these two prisms 2056 and 2059. The coating is applied to the joined part in such a way as to separate/synthesize deflected light. The polarization beam splitter prism 2060 has the main function of synthesizing light reflected by the two mirror devices 2030 and 2040.

The polarization beam splitter film 2055 is a filter for transmitting only an S-polarized light and reflecting P-polarized light. The polarizing direction of light scattered from the edge of a mirror element is undesirable. Therefore, undesirable reflected light from the mirror device is suppressed by the polarization beam splitter film 2055. As a result, contrast can be improved.

In another preferred embodiment, by utilizing a color filter instead of the polarization beam splitter film 2055, only light of a green wavelength is reflected, and the light of red and blue wavelengths transmits through it. With this color filter, the deterioration of the transmission efficiency of light, due to the incident angle of light against the polarization beam splitter film 2055, can be reduced.

The right triangular light guide prism 2064, whose base is turned up and whose slopes are glued, is joined to the front of the polarization beam splitter prism 2060. The green 2051, red 2052 and blue 2035 laser light sources are equipped on the base of this light guide prism 2064. The optical axes of the green 2051, red 2052 and blue 2053 laser light source are positioned perpendicular to the base of the light guide prism 2064.

The illumination optical system 2054a corresponding to the green laser light source 2051 and the illumination optical system 2054b corresponding to the red laser light source 2052 and the blue laser light source 2053 are also positioned perpendicular to the base of the light guide prism 2064.

The light guide prism 2064 is provided to direct the respective lights of the green 2051, red 2052 and blue 2053 laser light source to enter the polarization beam splitter prism 2060 at a perpendicular angle. The light guide prism 2064 makes it possible to reduce the amount of the reflection light caused by the polarization beam splitter prism 2060 when the laser light enters the polarization beam splitter prism 2060.

The ½ wavelength plate 2057 is provided on the base of the polarization beam splitter prism 2060. A light shielding layer 2063 is also provided in order to decrease the area to which light is irradiated in each of the mirror devices 2030 and 2040. The light shielding layer 2063 is also provided on the rear of the polarization beam splitter prism 2060. The ½ wavelength plate 2057 can also be replaced with a ¼ wavelength plate.

The ½ wavelength plate 2057 is implemented for each polarization direction of each of the laser light sources 2051, 2052 and 2053. The ½ wavelength plate 2057 reflects reflected light whose polarization direction is out of order, from the mirror devices 2030 and 2040. Thus, reflected light whose polarization direction is out of order can be reduced before reflected light from the mirror devices 2030 and 2040 enters the polarization beam splitter prism 2060.

When a ¼ wavelength plate is utilized, the polarization directions of incident light and reflected light to the mirror devices 2030 and 2040 can be changed by approximately 90 degrees. By positioning a ¼ wavelength plate only on a mirror device corresponding to the green laser light source 2051, the polarization direction of reflected light only from the green laser light source 2051 can be changed by approximately 90 degrees. Since there is no need to change the polarization direction for each color of the laser light sources 2051, 2052 and 2053, it becomes easier to configure the layout of the green 2051, the red 2052 and the blue 2053 laser light source. An Anti-reflection (AR) coat can also be used instead of the ½ wavelength plate 2057.

The two mirror devices 2030 and 2040, which are accommodated in a single package, are implemented under the ½ wavelength plates 2057, and the cover glass of the package is joined to the polarization beam splitter prism 2060 by way of a thermal conduction member 2062. This makes it possible to radiate heat from the cover glass of the package to the polarization beam splitter prism 2060 by way of the thermal conduction member 2062. Further, the circuit boards 2058 comprising a control circuit(s) for controlling the individual mirror devices 2030 and 2040 are formed, respectively, on both sides of the package.

The mirror devices 2030 and 2040 are placed to form a 45-degree angle relative to the four sides of the outer circumference of the package. The deflecting direction of each mirror element of the mirror devices 2030 and 2040 is approximately orthogonal to the slope face forming the polarization beam splitter prism 2060 and to the plane on which the reflection lights are synthesized. The mirror devices 2030 and 2040 must be precisely placed with a high precision in relation to the polarization beam splitter prism 2060 within the package by means of the positioning pattern 2016.

The illumination optical systems 2054a and 2054b are composed of optical elements, such as a lens, an optical fiber, a diffraction grating, and a hologram device.

The projection principle of the projection device shown in FIGS. 7A through 7D is described below

In the projection apparatus 2500, the individual laser lights 2065, 2066 and 2067 are incident from the front direction and are reflected by the two mirror devices 2030 and 2040 toward the rear direction, and then an image is projected by way of the projection lens 2070 located in the rear.

Next is a description of the projection principle starting from the incidence of the individual laser lights 2065, 2066 and 2067 to the reflection of the respective laser lights 2065, 2066 and 2067 at the two mirror devices 2030 and 2040 toward the rear direction, with reference to the front view diagram of the two-panel projection apparatus 2500 shown in FIG. 7A.

The respective laser lights 2065, 2066 and 2067 from the S-polarized green laser light source 2051, and the P-polarized red laser light source 2052 and blue laser light source 2053 are made to project to the polarization beam splitter prism 2060 through the illumination optical systems 2054a and 2054b, respectively corresponding to the laser lights 2065, and 2066 and 2067, and by way of the light guide prism 2064. After transmission through the polarization beam splitter prism 2060, the S-polarized green laser light 2065 and the P-polarized red and blue laser lights 2066 and 2067 are incident to the ½ wavelength plates 2057a and 2057b, which are placed on the base of the polarization beam splitter prism 2060. The polarization directions of the green laser light 2065, that has transmitted through the ½ wavelength plate 2057a, and the red laser light 2066 and blue laser light 2067, that has transmitted through the ½ wavelength plates 2057b, become the same.

Then, the P-polarized green laser light 2065 that has transmitted through the ½ wavelength plate 2057a, and the S-polarized red 2066 and blue 2067 laser light that has transmitted through the ½ wavelength plates 2057b enters the two mirror devices 2030 and 2040, respectively, packed in one package. Each of the laser lights 2065, 2066 and 2067 is modulated and reflected by each of the mirror devices 2030 and 2040, corresponding to each of the laser light 2065, 2066 and 2067.

Next is a description of the projection principle starting from the reflection of individual laser lights 2065, and 2066 and 2067 to the projection of an image, with reference to the rear view diagram of the two-panel projection apparatus 2500 shown in FIG. 7B.

The P-polarized green laser ON light 2068 and the mixed ON light 2069 of the S-polarized red and blue laser, that is reflected by the mirror devices 2030 and 2040, transmits through the ½ wavelength plate 2057 again and enters the polarization beam splitter prism 2060. In this case, since the polarization directions of scattered light and of light reflected by each of the mirror devices 2030 and 2040 are out of order, the scattered light does not transmits through the ½ wavelength plate 2057.

Then, the green laser ON light 2068 and the mixed ON light 2069 of the red and blue laser is reflected by the outside surface of the polarization beam splitter prism 2060, and the P-polarized green laser ON light 2068 is reflected by the polarization beam splitter film 2055. However, the mixed ON light 2069 of the S-polarized red and blue laser transmits through the polarization beam splitter film 2055. Then, by inputting the green laser ON light 2068 and the mixed ON light 2069 of the red and blue laser to the projection lens 2070, a colored image is projected. It is preferable that the optical axis of the light entering the projection lens 2070 from the polarization beam splitter prism 2060 is at right angle to the surface of the polarization beam splitter prism 2060.

It is also preferable that the deviation of the optical axes of the light 2068 and 2069 entering the projection lens 2070 from the polarization beam splitter prism 2060 be equal to or less than ⅓ of the size of a mirror element. When this amount of deviation is ½ to one pixel, the color deviation of a projected image becomes conspicuous and resolution deteriorates.

In the positioning of the polarization beam splitter prism 2060 and the mirror devices 2030 and 2040 in the pattern 2106 described above, the positioning pattern 2106 and the reference part of the prism 2060 are matched with each other. Thus, the polarization beam splitter prism 2060 and the mirror devices 2030 and 2040 can be positioned with high accuracy in such a way that reflected light in the mirror devices 2030 and 2040 might be matched with each other on the composition surface of the polarization beam splitter prism 2060.

With the configuration and the principle of projection described above, an image can be projected in the two-panel projection apparatus 2500 comprising the assembly body 2400 that packs the two mirror devices 2030 and 2040 in a single package.

FIG. 7C is the side view of the two-plate projection device 2500.

The green laser light 2065 emitted from the green laser light source 2051 enters the light guide prism 2064 at a right angle via the illumination optical system 2054a, thus minimizing the reflection of the laser light 2065.

Then, having passed through the light guide prism 2064, the laser light 2065 passes through the polarization beam splitter prism 2060 and the ½ wavelength plate 2057a, which is joined to the light guide prism 2064, and then, enters the mirror array 2032 of the mirror device 2030.

The mirror array 2032 reflects the laser light 2065 in such a way that the deflection angle of a mirrors may be in one of three states: 1.) An ON state, in which all of the reflected light is directed to the projection lens 2070, 2.) An intermediate state where part of the reflected light is directed to the projection lens 2070, and 3.) An OFF state, in which none of the reflected light is reflected to the projection lens 2070.

All of the laser light (ON light) 2071, obtained in the ON state, is reflected by the mirror array 2032 to enter the projection lens 2070. A portion of the laser light (intermediate light) 2072, obtained in the intermediate state, is reflected by the mirror array 2032 to enter the projection lens 2070. The laser light (OFF light) 2073, obtained in the OFF state, is reflected by the mirror array 2032 towards the light shielding layer 2063 and is absorbed by the light shielding layer 2063.

With this configuration, the laser light enters the projection lens 2070 at the maximum light intensity of the ON light, at an intermediate intensity between the ON light and OFF light of the intermediate light, and at the zero intensity of the OFF light. This configuration makes it possible to project an image at a high level of gradation. Note that the intermediate light state produces a reflection light reflected by a mirror, in which the deflection angle is regulated between the ON light state and OFF light state.

Meanwhile, making the mirror perform a free oscillation causes it to alternate between the three deflection angles, producing the ON light, the intermediate light and the OFF light. Controlling the number of free oscillations makes it possible to adjust the light intensity and obtain an image with a higher level of gradation.

As shown in FIG. 7D, each of the mirror devices 2030 and 2040 is positioned at 45 degree angle relative to the four sides of the package on the same horizontal plane. Therefore, the light shielding layer 2063 can absorb light in an OFF state without reflecting it onto the slope of the polarization beam splitter prism 2060. As a result, contrast can be improved.

Then, heat generated inside the package is conducted to the polarization beam splitter prism 2060 via the heat conduction member 2062 and is radiated to the outside. By conducting heat generated in a mirror device to the polarization beam splitter prism 2060, the heat radiation efficiency of a mirror device can be improved. Furthermore, since the light shielding layer 2063 is in contact with the outside, heat generated by light absorption is immediately radiated to the outside.

When a mirror element reflects the incident light towards a projection lens 2070 at an intermediate light intensity (i.e., an intermediate state), the intensity between the ON light and OFF light states, an effective reflection plane needs to be provided along the length of the slope face of a prism in a conventional apparatus.

In contrast, the projection apparatus 2500 is enabled to provide a wide effective reflection plane along the direction of the thickness of the polarization beam splitter prism 2060, even when the mirror element as described above has an intermediate state. With this configuration, the total reflection by the slope face of the polarization beam splitter prism 2060 for the reflection light from the mirror element can be alleviated.

For the light source (variable light source 5210) of a projection device, such as the projection device 5010, a semiconductor light source, such as a laser light source, can be used. Similarly, for the red 5211, green 5212 and blue 5213 laser light source of the projection device 2500, a semiconductor light source can also be used.

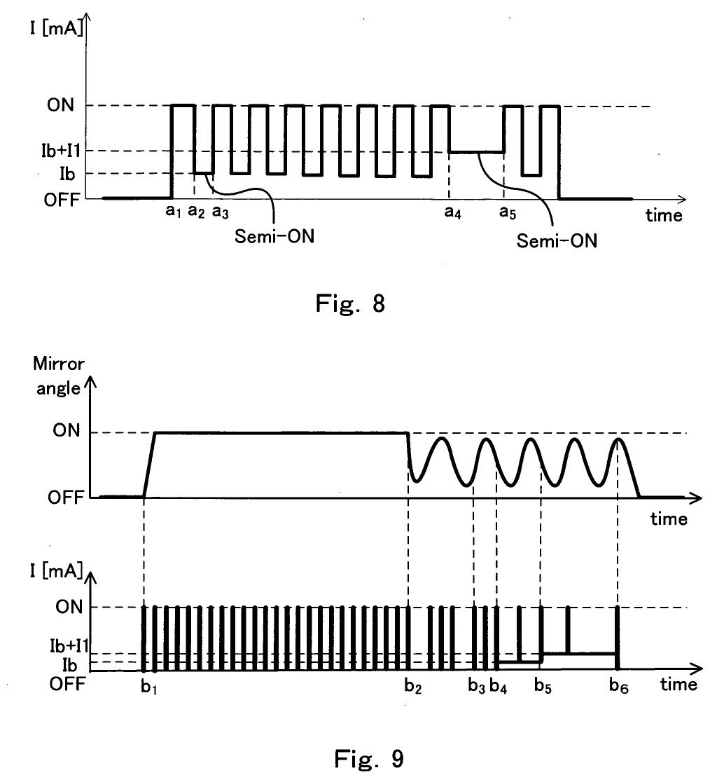

A light source having a state where incident light projecting no image is emitted or a semi-ON state where no incident light is emitted while a light source is being driven, as shown in FIGS. 8 and 9, in addition to having an ON state where incident light for projecting images is emitted and an OFF state where the power of a light source is completely disconnected, can also be used.

The following is a description of the process of turning a light source to the ON, OFF, and semi-ON states, with reference to FIG. 8. FIG. 8 is a graph illustrating the semi-ON state of a light source performing on an electric current drive.

In FIG. 8, the vertical axis represents current values, with “ON” indicating a current value, which enables the light source to emit an incident light for projecting an image, and “OFF” indicating a current value which shuts off the power supply for the light source; the horizontal axis shows a time axis, indicating the elapsed time.

The relationship between time and a light source in this preferred embodiment is described below.

Until time a₁: the power supply to the light source is completely shut off, with the current value set at OFF.

At time a₁: the power supply to the light source is turned on for projecting an image, with the current value set at ON. As a result, an image can be projected.

Between time a₁ to time a₂: the current value is maintained at ON so that images are continuously projected.

At time a₂: in order to stop projecting an image, the current value of the light source is set at I_{b}. The current I_{b} is a bias current shown in the above described FIG. 8B. An appropriate setup of the bias current makes it possible to produce the semi-ON state in which an incident light is not emitted and while driving the light source.

Between time a₂ to time a₃: no image is projected and the current value I_{b} of the bias current is maintained.

At time a₃: the current value of the light source is set at ON for restarting the projection of an image. The current values are changed to ON from the current value I_{b} of the bias current, and thereby the light source can be activated more rapidly than when changing the current values from OFF to ON.

Between time a₃ to time a₄: the light source is controlled to perform pulse emission by repeatedly setting the current value at ON followed by setting the bias current at the current value I_{b}.

At time a₄: in order to stop projecting an image, the current value for the light source is set at I_{b}+I₁, a current value obtained by adding together the bias current I_{b} shown in FIG. 8B and a current value I₁. The current value I₁ can be added to the current value I_{b} by the light source control unit controlling the switching circuit. An appropriate setup of the current value I_{b}+I₁ produces the semi-ON state in which the light source emits an incident light while no image is projected.

Between time a₄ to time a₅: no image is projected, and the current value I_{b}+I₁ is maintained.

At time a₅: in order to restart an image projection, the current value of the light source is set at ON. The current values are changed to ON from I_{b}+I₁, and thereby the light source can be activated more rapidly than when changing the current values from OFF to ON or from the current value I_{b} of the bias current to ON.

By thus controlling the current value of the circuit of a light source by the light source control unit, the light source can be switched to an ON state, a semi-ON state or an OFF state.

Specifically, in this preferred embodiment, in addition to having an ON and an OFF state, a light source can have a semi-ON state by controlling the above-described bias current I_{b}. Specifically, a “semi-ON state” used in this patent application is a state where incident light so weak that an image cannot be projected is emitted from a light source or no incident light is emitted while the light source is being driven.

FIG. 9 is a timing diagram showing the example of a semi-ON state in the case where the mirror control is synchronized with the current drive of a light source and the semi-ON state is obtained by performing pulse width modulation (PWM) in a spatial light modulator composed of mirror elements.

In FIG. 9, the vertical axis indicates the deflection angle of a mirror and the current i of the light source, defining the deflection angle of a mirror when the incident light is projected in the ON light state as “ON” and that of the mirror when the incident light is in the OFF light state as “OFF”. A current value i transmitted to the light source to project a light intensity for projecting an image is defined as “ON”, and a current value i, when the power supply to the light source is completely shut off, is defined as “OFF”. The horizontal axis indicates a time axis, indicating the elapsed time.

The following is the relationship between time and the light source of the present embodiment:

Until time b₁: the deflection angle of a mirror is controlled to be OFF light, and the current value is OFF when the power supply to the light source is completely shut off.

At time b₁: the deflection angle of the mirror is controlled to be ON light for projecting an image, and the current value is ON as a result of turning on the power supply to the light source. As a result, an image can be projected.

Between the time b₁ and time b₂: the deflection angle of the mirror is controlled to be ON light, and the current value to the light source is repeatedly changed between ON and OFF causing the light source to perform pulse emission, and thereby the images are projected while adjusting the light intensity.

At time b₂: stopping the application of the voltage to the address electrode, which retains the deflection angle of the mirror in the ON position controls the mirror under a free oscillation state in which the mirror oscillates between the deflection angles of the ON and OFF states. Here, the number of pulse emission, with the current values set at ON and OFF, is adjusted.

Between time b₂ and time b₃: the mirror is in a free oscillation state in which the deflection angles of the mirror oscillates between the ON and OFF light state, and the number of pulse emissions, with the current values set at ON and OFF, is adjusted to three times per one cycle of free oscillation, and thereby the quantity of light for projecting an image is adjusted.

Between the time b₃ and time b₄: a control similar to the control carried out between the time b₂ and b₃ is carried out.

Between time b₄ and time b₅: the number of pulse emission, with the current values set at ON and OFF, is adjusted to two times per one cycle of free oscillation, while maintaining the mirror in a free oscillation. With this control, it is possible to change the intensity of light of the image that has been projected between the time b₃ and time b₄. Further, between the time b₄ and time b₅, the current value of the light source when no image is projected is not controlled at OFF (as between the time b₁ and time b₂), but controlled at I_{b}. The current value I_{b} is, for example, the bias current. An appropriate setting of the bias current makes it possible to control the light source under the semi-ON state in which an incident light is not emitted while the light source is being driven. Specifically, between the time b₄ and time b₅, the pulse emission is carried out with the current value set at ON and I_{b}. During pulse emission, setting the current value of the bias current from I_{b} to the ON state makes it possible to activate the light source more rapidly than when changing the current value from the OFF to ON state.

Between time b₅ and time b₆: while maintaining the mirror under a free oscillation, the number of pulse emissions, with the current values set at ON and OFF, is adjusted to two times per one cycle of free oscillation. Meanwhile, between the time b₅ and time b₆, the current value of the light source is set at I_{b}+I₁ when no image is projected, instead of being set at ON and I_{b} (as between the time b₄ and time b₅). The current value I_{b}+I₁ is the current generated by adding a current value I₁ to the current value I_{b} of the bias current. The light source control unit controls the switching circuit to add the current value I₁ to the current I_{b} of the bias current. An appropriate setting of the current value I_{b}+I₁ makes it possible to control the light source under the semi-ON state, in which it outputs an incident light with which no image is projected. Specifically, between the time b₅ and time b₆, the pulse emission can be carried out with the current value set at ON and I_{b}+I₁. In this case, when the current values are changed from I_{b}+I₁ to the ON state, it is possible to activate the light source more rapidly than when changing the current values from the OFF to ON state, or from the current value I_{b}, of the bias current, to the ON state.

The light source control unit controls the current of the circuit, as described above, to control the light source under the ON state, semi-ON state, and OFF state, to achieve an appropriate adjustment of the intensity of light emitted from the light source.

As described above, the present embodiment is configured to keep a semiconductor light source turned on at a degree of brightness in which no image is projected or to keep applying the light source with a drive current or drive voltage at a value at which the light source is not turned on and an image is not projected. Such a control enables a more rapid response in changing over between projecting an image and projecting no image, preventing blurriness in a moving image.

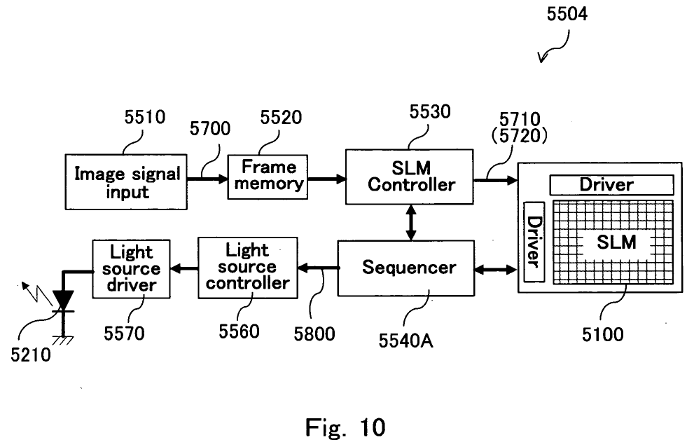

Such a control of a light source can be performed by the circuit structures shown in FIGS. 10, 11 and 12.

Thus, in addition to having an ON and an OFF state, a light source may be configured with a semi-ON state. For example, semiconductor light sources, such as laser diode, a light-emitting diode (LED) are light source capable of being configured in this way.

FIG. 10 is a functional block diagram showing the control unit 5504 being a variation of the above-described control unit 5500. In this case, the sequencer 5540A of the control unit 5504 has the function of inputting the control signals of a mirror control profiles 5710 and 5720, such as binary data 5704 and non-binary data, which are outputted to the spatial light modulator 5100 from an SLM controller 5530, to generate a light source profile control signal 5800, such as light source pulse patterns 5801 through 5813, which are described later, to enable the light source control unit 5560 to perform the light emission control of the variable light source 5210 and to output it to the light source control unit 5560.

In the case of the control unit 5500 shown in FIG. 10, an image signal to be displayed is inputted to a display device as input digital video data 5700 and the image signal is stored in the frame memory 5520 for each frame. The SLM controller 5530 generates drive signals of the mirror control profiles 5710 and 5720, for driving the spatial light modulator 5100 from the input digital video data 5700 stored in the frame memory 5520. The spatial light modulator 5100 is driven by a drive signal.

However, the drive signal generated by the SLM controller 5530 is also inputted to the sequencer 5540A for controlling the operation of the system. The sequencer 5540A transmits the light source profile control signal 5800 to the light source control unit 5560 according to a drive signal inputted from the SLM controller 5530. Then, the light source control unit 5560 controls the light source driver circuit 5570 in the emission timing and intensity of illumination light 5600 in the variable light source 5210. Then, the variable light source 5210 emits illumination light 5600 with the timing and intensity driven by the light source driver circuit 5570.

According to this preferred embodiment, by continuously adjusting the emission intensity of the variable light source 5210 while displaying an image on a screen 5900, the brightness of a pixel to be displayed can be changed and the gradation of a displayed image can be controlled. Since the emission intensity of the variable light source 5210 is adjusted using a drive signal for driving the spatial light modulator 5100, no light is wasted, thereby reducing the heat generation and power consumption of variable light source 5210.

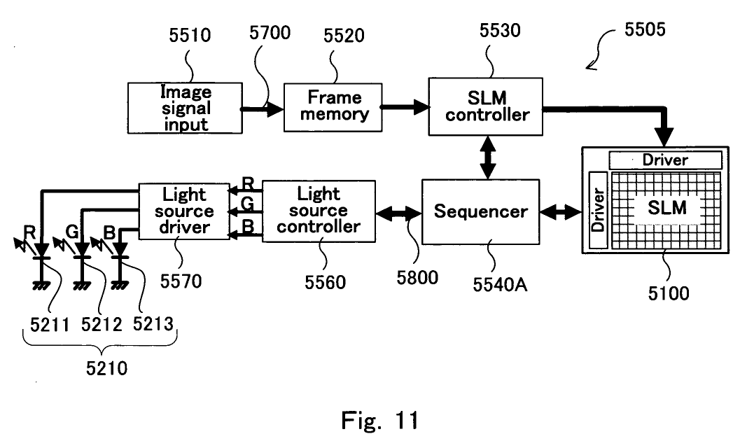

FIG. 11 shows an example of the circuit structure of the control unit 5500 using a variable light source 5210 consisting of the red 5211, the green 5212 and the blue 5213 laser light source, which correspond to each color of RIG/B.

In this case, the light source control unit 5560 generates control signals for driving each light source of R/G/B on the basis of the light source profile control signal 5800 inputted from the sequencer 5540A. The light source driver circuit 5570 emits each light source of RIG/B by emitting pulses of light.

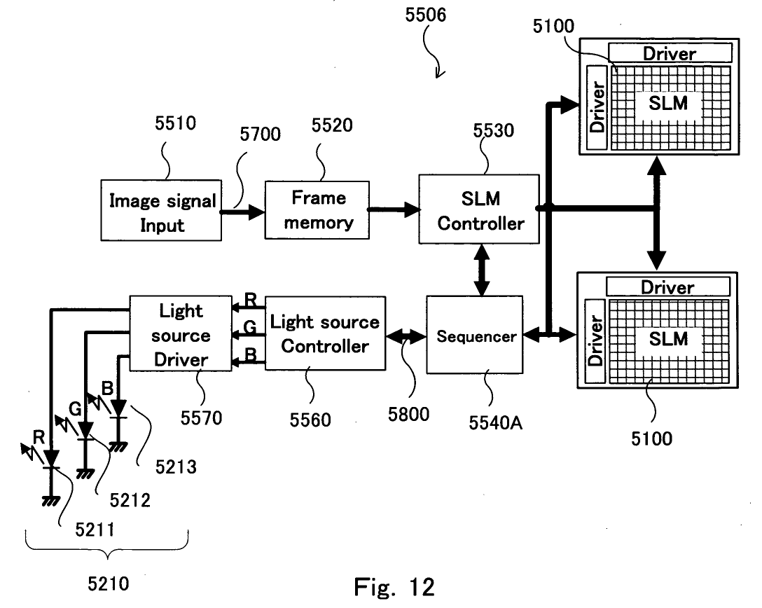

FIG. 12 is a functional block diagram showing an exemplary configuration of the control unit 5506 provided for a two-plate projection device.

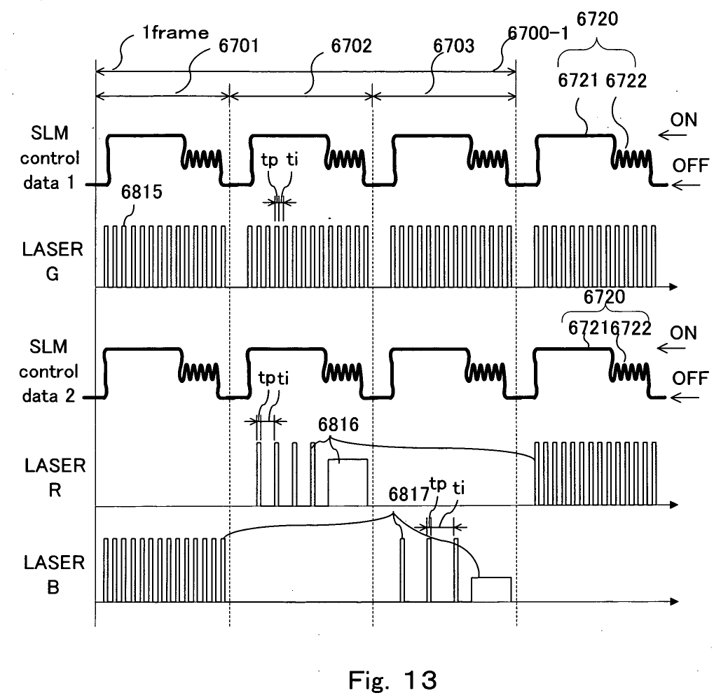

The drive signal generated by the SLM controller 5530 (the mirror control profile 6729 in FIG. 13) drives a plurality of the spatial light modulator 5100 of the device package 5100A.

The light source control unit 5560 generates a light source profile control signal 5800 corresponding to the mirror control profile 6720 for driving each spatial light modulator 5100, inputs it to the light source driver circuit 5570, and adjusts the intensity of laser light (illumination light 5600) emitted from each of the red 5211, the green 5212 and the blue 5213 laser light source.

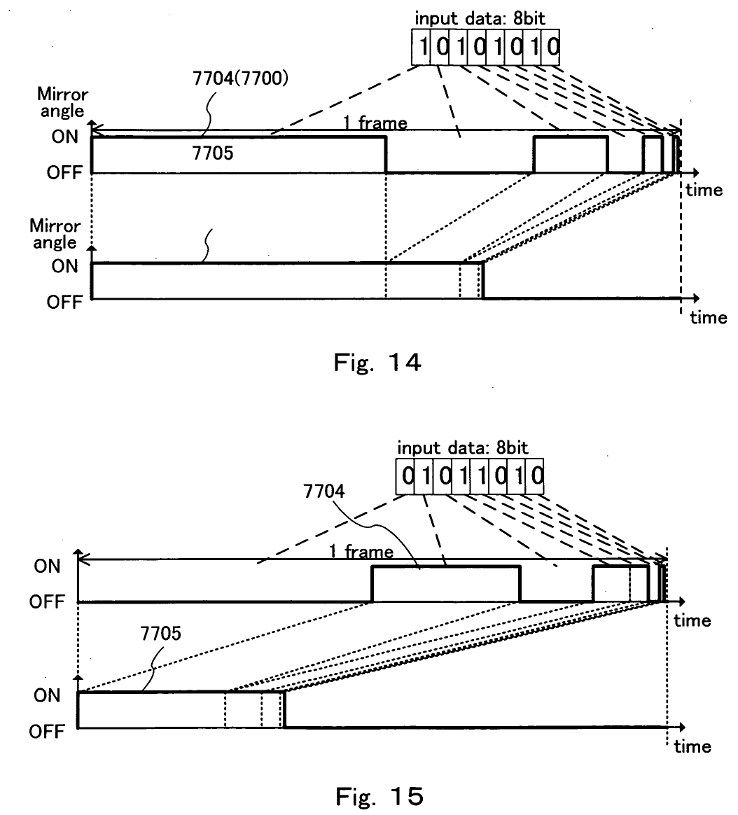

The SLM controller 5530 in this preferred embodiment controls the ON/OFF of a mirror 5112 using the non-binary data 7705 obtained by converting the binary data 7704, as shown in FIGS. 14, 15, 16 and 17.

Specifically, FIG. 14 exemplifies the case of generating non-binary data 7705, which is a bit string having an equal weighting factor for each digit, from binary data 7104 that is constituted by, for example, 8-bit “10101010”, and a control is carried out for turning ON the mirror 4003 only for the period in which the bit string continues.

Note that FIG. 14 exemplifies the case of converting the non-binary data 7705 so that the bit string is packed forward within the display period of one frame, controlling the mirror 4003 to be turned ON for a predetermined period, in accordance with the bit string number from the beginning of a frame display period.

Likewise, FIG. 15 exemplifies the case of converting 8-bit “01011010” binary data 7704 into non-binary data 7705, a forward-packed bit string.

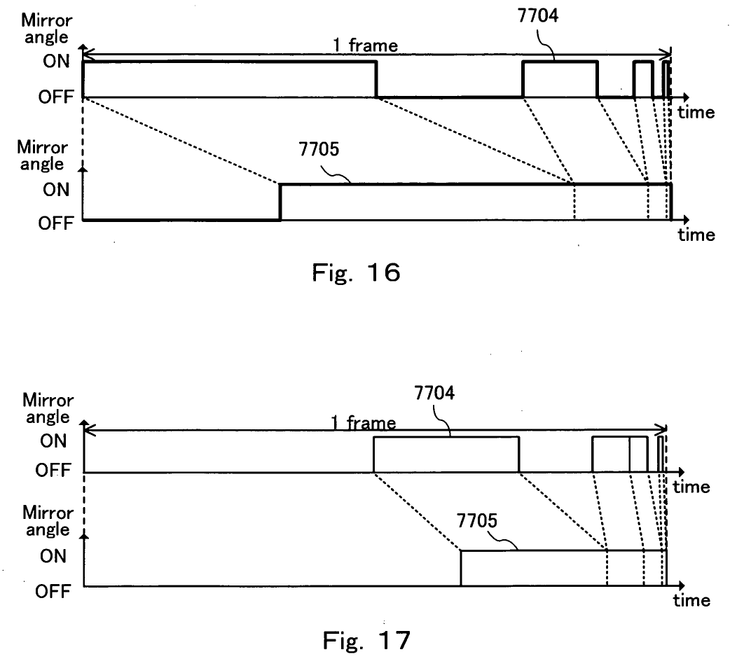

FIG. 16 exemplifies the case of converting the binary data 7704, shown in FIG. 14, into a bit string of non-binary data 7705 with the digits packed backward. In this case, the mirror 4003 is controlled so as to be turned ON only during the period of time corresponding to the bit string number starting from the middle of a frame display period until the end.

Likewise, FIG. 17 exemplifies the case of converting binary data 7704, shown in FIG. 15, into a bit string of non-binary data 7705, with the digits packed backward and controlling the ON/OFF of the mirror 4003.

When the ON/OFF is controlled by the non-binary data 7705 as described above, the ON period of the mirror 4003 becomes continuous, and therefore it is easier to control the emission intensity of the variable light source 5210 in sync with the aforementioned ON period.

Alternatively, a light source can be composed of sub light sources, some of which can have different wavelengths. It is also preferable that a light source can emit pulse-modulated light.

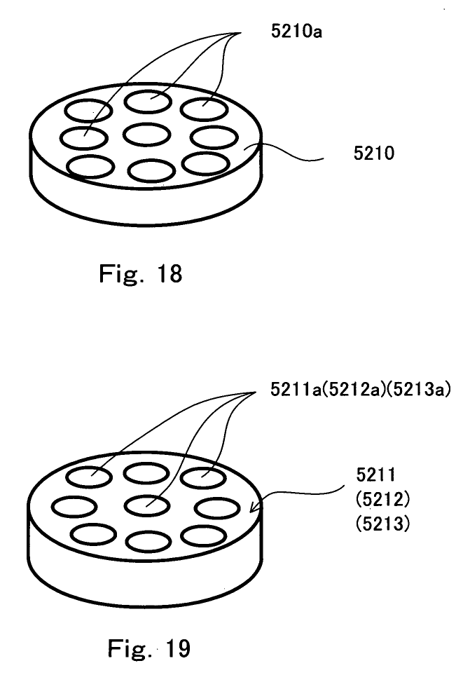

For example, as shown in FIG. 18, the above-described variable light source 5210 can be composed of a plurality of sub light sources 5210a. The emission intensity and ON/OFF timing of each sub light source 5210a can be independently controlled.

Similarly, as shown in FIG. 19, each of the above-described red 5211, green 5212 and blue 5213 laser light source can be composed of a plurality of sub light sources 5211a, 5212a and 5213a, respectively.

Next, the structure example of the spatial light modulator used for the projection device in the above-described preferred embodiment is described in detail.

The spatial light modulator may be implemented with a transmissive spatial light modulator, such as a liquid crystal, or a reflective spatial light modulator, such as a liquid crystal of silicon (LCOS). Furthermore, the reflective spatial light modulator may be a mirror device. The mirror device includes a mirror array configured by arraying a plurality of mirror elements, each comprising a deflectable mirror supported by an elastic hinge formed on a substrate for reflecting the incident light from the light source, and an address electrode, disposed on the substrate under the mirror. Furthermore, the mirror device controls the direction for reflecting the illumination light. The mirror may reflect the illumination light to an ON direction by guiding the reflection light of the illumination light to a light path for displaying an image, an OFF direction, for guiding the reflection light of the illumination light away from the projection light path, or an intermediate direction, for guiding a portion of the reflection light of the illumination light to the projection light path.

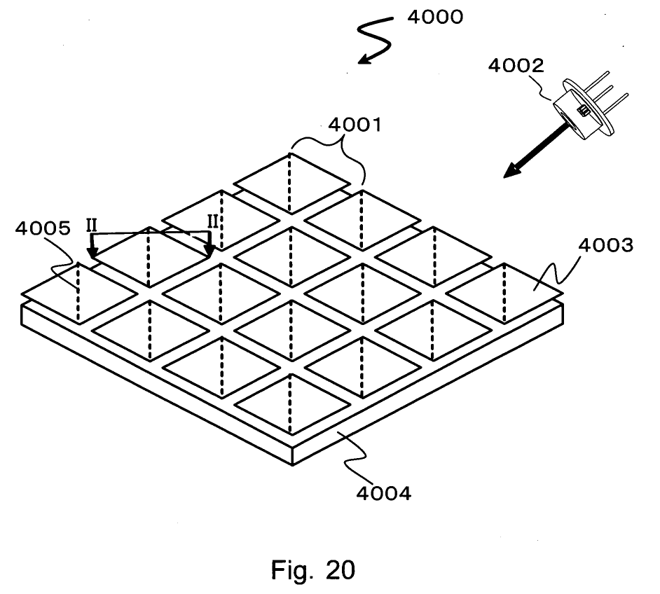

The mirror device may be implemented as those described in FIGS. 20, 21, 22A, 22B, 22C, 23A, 23B, 24A, 24B, 24C, 25, 26A, 26B, 26C, 26D and 27.

FIG. 20 is a diagram of a diagonal view of a mirror device that includes micromirrors 4003 configured as two dimension arrays. Each of the plurality of mirror elements is controlled to oscillate and deflect at specific angles for reflecting the incident light according to the mirror control signals. The mirror device 4000 includes mirror elements 4001 arranged as two-dimensional arrays on a device substrate 4004. Each of these mirror elements includes an address electrodes (not shown here), elastic hinge (not shown here), and a mirror 4003 supported by the elastic hinge. In FIG. 20, each of these multiple mirror elements 4001 comprises a square mirror 4003. The square mirrors 4003 are arrayed along two horizontal directions in constant intervals on the device substrate 4004.

The mirror 4003 on one mirror element 4001 is controlled by applying voltage to the address electrode on the device substrate 4004.

It is preferable that the pitch between adjacent mirrors 4003 be about 4 μm to 14 μm, taking into consideration the number of pixels required of a super high vision level, such as 2KX 4K up to non-full high vision level, and the size of a mirror device. In this case, the pitch indicates the distance between the deflection axes of the adjacent mirror 4003. More preferably, the pitch between adjacent mirrors 4003 should be 4 μm to 7 μm. The shape of the mirror 4003 and the pitch between the mirrors 4003 are not limited to these values. The deflection axis 4005 for deflecting the mirror 4003 is indicated by a dotted line. Light is emitted from a coherent light source 4002 in the vertical direction or oblique direction to this deflection axis 4005 and enters the mirror 4003. The coherent light source 4002 is, for example, a laser light source.

The structure and operation of the mirror element 4001 are described below with reference to the cross-section view of one mirror element 4001 at a line II-II, of the spatial light modulator 4000 shown in FIG. 20.

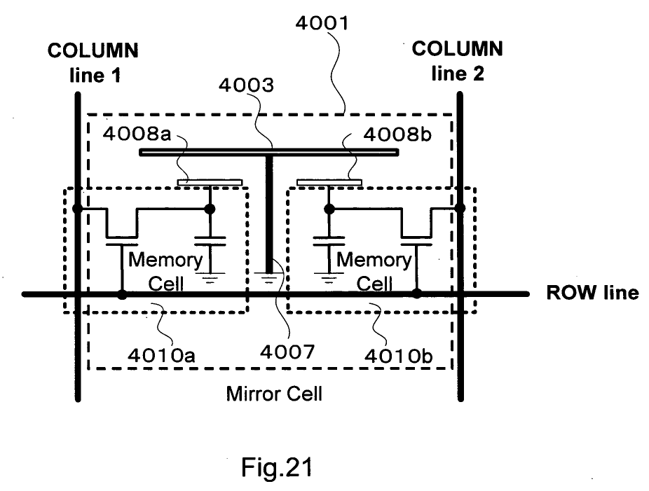

FIG. 21 shows the cross-section of one mirror element at a line II-II of the spatial light modulator shown in FIG. 20.

One mirror element 4001 comprises a mirror 4003, an elastic hinge 4007 supporting the mirror 4003, address electrodes 4008a and 4008b, and two memory cells of a first memory cell 4010a and a second memory cell 4010b for applying voltage to the address electrodes 4008a and 4008b, respectively, in order to control the mirror 4003 in a desired deflection state.

In this case, each of the memory cells 4010a and 4010b has a dynamic random access memory (DRAM) provided with a field effect transistor (FET) transistor and a capacitance. The structure of each of the memory cells 4010a and 4010b is not limited to this configuration and can also be a Static Random Access Memory (SRAM) structure or other similar data storage circuit.

Each of the memory cells 4010a and 4010b is connected to the address electrodes 4008a and 4008b, COLUMN lines 1 and 2 and a ROW line.

An FET-1 is connected to the address electrode 4008a, COLUMN line 1, and ROW line in the first memory cell 4010a. A capacitance Cap-1 is connected between the address electrode 4008a and GND (i.e., the ground). Likewise an FET-2 is connected to the address electrode 4008b, COLUMN line 2 and ROW line in the second memory cell 4010b, and a capacitance Cap-2 is connected between the address electrode 4008b and GND.

The signals on the COLUMN line 1 and ROW line generate a predetermined voltage for applying to the address electrode 4008a to tilt the mirror 4003 towards the address electrode 4008a. Likewise, the signals on the COLUMN line 2 and ROW line generate a predetermined voltage for applying to the address electrode 4008b to tilt the mirror 4003 towards the address electrode 4008b.

Note that a drive circuit for each of the memory cells 4010a and 4010b is usually formed in the device substrate 4004. The deflection angle of the mirror 4003 is controlled by controlling the respective memory cells 4010a and 4010b in accordance with the signal of image data to carry out the modulation and reflection of the incident light.

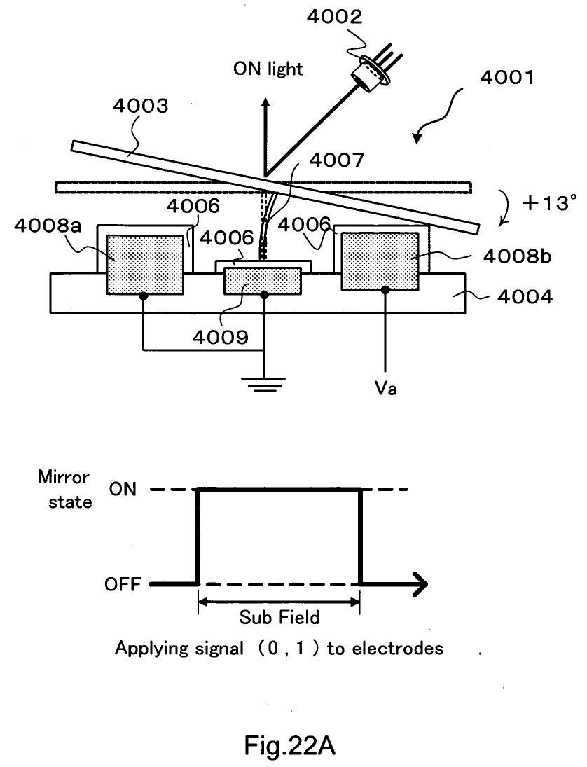

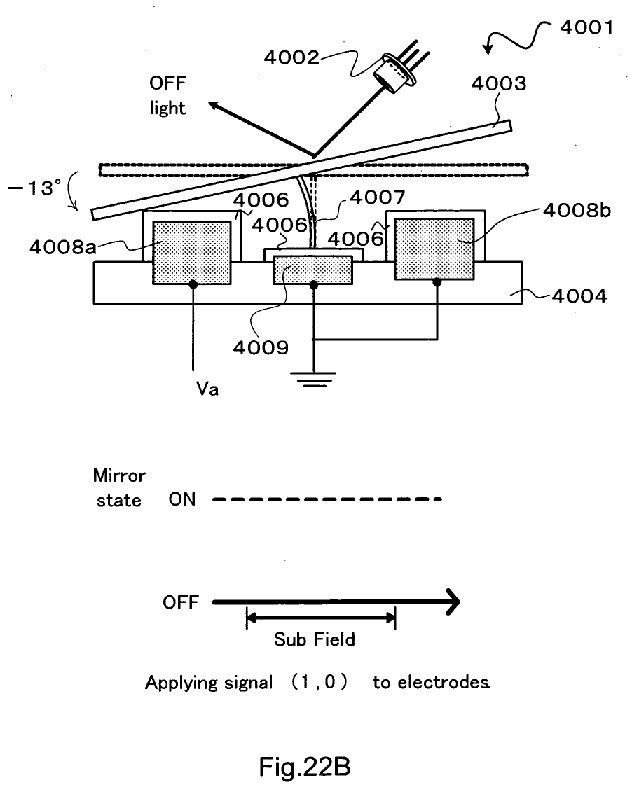

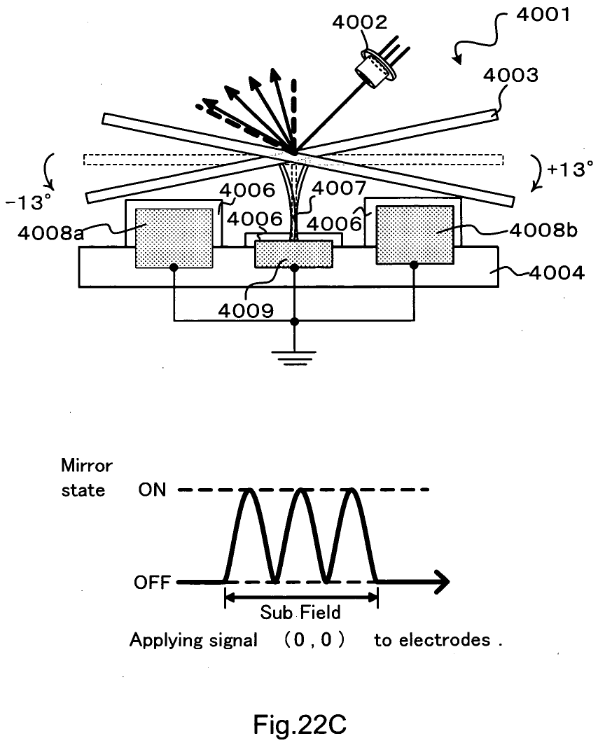

Next, the deflection operation of the mirror 4003 of the mirror element 4001 shown in FIG. 20 is described with reference to FIGS. 22A through 22C.

FIG. 22A is a diagram depicting a state in which incident light is reflected towards a projection optical system by deflecting the mirror of a mirror element. Note that in this case, the deflection angle is designated at 13 degrees; the deflection angle, however, is not limited to this angle.

FIG. 21 shows the memory cells 4010a and 4010b (which are not shown here) for storing a signal (0,1) which applies a voltage of “0” volts to the address electrode 4008a of FIG. 22A and applies a voltage of Ve volts to the address electrode 4008b. As a result of applying the voltage of Ve volts, the mirror 4003 is drawn by a Coulomb force and deflected from a deflection angle of “0” degrees, i.e., the horizontal state, to that of +13 degrees in the direction of the address electrode 4008b. This causes the incident light to be reflected by the mirror 4003 towards the projection optical system known as the ON state).

Specifically, the present patent application defines the deflection angles of the mirror 4003 as “+” (positive) for clockwise (CW) direction and “−” (negative) for counterclockwise (CCW) direction, with “0” degrees as the initial state of the mirror 4003. Further, an insulation layer 4006 is provided on the device substrate 4004 and a hinge electrode 4009, connected to the elastic hinge 4007, is grounded through the insulation layer 4006.

FIG. 22B is a diagram depicting a state in which the incident light is not reflected towards a projection optical system by the deflection of the mirror of a mirror element.

With a signal (1, 0) stored in the memory cells 4010a and 4010b (which are not shown here), illustrated in detail in FIG. 21, a voltage of Ve volts is applied to the address electrode 4008a, and “0” volts is applied to the address electrode 4008b. As a result of applying the voltage Ve volts to the electrode 4008a, the mirror 4003 is drawn by a coulomb force and deflected from a deflection angle of “0” degrees, i.e., the horizontal state, to that of −13 degrees in the direction of the address electrode 4008a. This causes the incident light to be reflected by the mirror 4003 in a direction away from that of the light path towards the projection optical system (known as the OFF state).

FIG. 22C is a diagram delineating a state in which incident light is reflected towards and away from a projection optical system by the repeated free-oscillation of the mirror of a mirror element.

In FIG. 22C, a signal (0, 0) is stored in the memory cells 4010a and 4010b (which are not shown here) and a voltage of “0” volts is applied to the address electrodes 4008a and 4008b. As a result of zero voltage applied to the electrodes, the Coulomb force between the mirror 4003 and the address electrode 4008a or 4008b, is withdrawn. The mirror 4003 is operated in a free oscillation state within the range of the deflection angles, ±13 degrees, in accordance with the property of the elastic hinge 4007. During this free oscillation, the incident light is reflected toward the projection optical system only when the mirror 4003 is within the range of a specific deflection angle. The mirror 4003 repeats the free oscillations, changing over frequently between the ON light state and OFF light state. Controlling the number of changeovers makes it possible to finely adjust the intensity of light reflected towards the projection optical system (which is called a free oscillation state).

The total intensity of light reflected during the time of the free oscillation towards the projection optical system is certainly lower than the intensity that is produced when the mirror 4003 is continuously in the ON state and higher than the intensity that is produced when it is continuously in the OFF state. That is, it is possible to make an intermediate intensity between those of the ON state and OFF state. Therefore, by finely adjusting the intensity as described above, a higher gradation image can be projected than with the conventional technique.

Although not shown in the drawing, an alternative configuration may be such that only a portion of light is made to enter the projection optical system by reflecting an incident light in the initial state of a mirror 4003. Configuring as such makes a reflection light enter the projection optical system with a higher intensity than that produced when the mirror 4003 is continuously in the OFF light state and with a lower intensity than that produced when the mirror 4003 is continuously in the ON light state thus controlling the mirror to operate in an intermediate state. A mirror device having an oscillation state and an intermediate states is optimal for a next-generation device displaying higher-gradation images, compared with the conventional device capable of controlling only two states: the ON and OFF states.

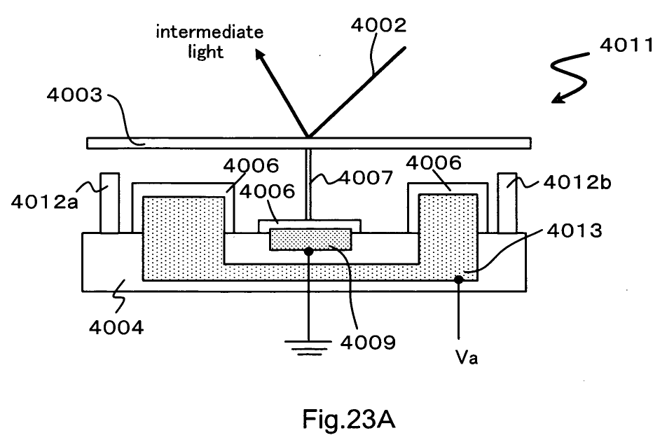

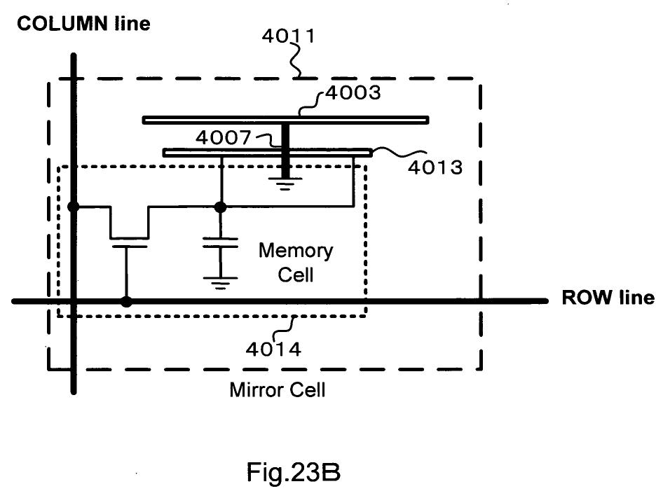

FIG. 23A shows the cross-section of a mirror element in another preferred embodiment, in which only one address electrode and one drive circuit correspond to one mirror element.

The mirror element 4011 shown in FIG. 23A includes an insulation layer 4006 on the device substrate 4004 and includes one drive circuit (see FIG. 23B) for deflecting a mirror 4003. Further, an elastic hinge 4007 is formed on the insulation layer 4006. The elastic hinge 4007 supports the mirror 4003, and the one address electrode 4013, which is connected to the drive circuit, is formed under the mirror 4003. Further, a hinge electrode 4009 connected to the elastic hinge 4007 is grounded through the insulation layer 4006.

Note that the areas of the address electrode 4013 exposed above the device substrate 4004 are configured to be different between the left side and right side of the elastic hinge 4007, or the deflection axis of mirror 4003. The area size of the exposed part of the address electrode 4013 on the left side of the elastic hinge 4007 is larger than the area size on the right side.

Here, the mirror 4003 is deflected by the electrical control of one address electrode 4013 and drive circuit. Further, the deflected mirror 4003 is retained at a specific deflection angle by contact with stopper 4012a or 4012b, which are formed in the vicinity of the exposed parts on the left and right sides of the address electrode 4013.

In this patent application the left and right sides of the address electrode 4013 exposed above the device substrate 4004, shown in FIG. 23A, are called “the first electrode part” and “the second electrode part”, respectively, using the elastic hinge 4007 or the deflection axis of the mirror 4003 as the border.

By configuring the address electrode 4013 to be asymmetrical with the area of the left side different from that of the right side, in relation to the elastic hinge 4007 or the deflection axis of mirror 4003, a voltage applied to the electrode 4013 will generate a difference in coulomb force between (a) and (b), where (a): a coulomb force generated between the first electrode part and mirror 4003, and (b): a coulomb force generated between the second electrode part and mirror 4003. Thus, the mirror 4003 can be deflected by differentiating the Coulomb force between the left and right sides of the deflection axis of the elastic hinge 4007 or mirror 4003.

FIG. 23B is an outline diagram of a cross-section of the mirror element 4011 shown in FIG. 23A. When implemented with a single address electrode 4013, it is possible to control the mirror with only one memory cell. FIG. 23B shows a configuration wherein two memory cells 4010a and 4010b, corresponding to the two address electrodes 4008a and 4008b shown in FIG. 21, is now reduced to one memory cell 4014. The amount of wiring for controlling the deflection of mirror 4003 is also reduced

Other possible configurations are similar to the configuration described in FIG. 21, and therefore descriptions are not provided here.

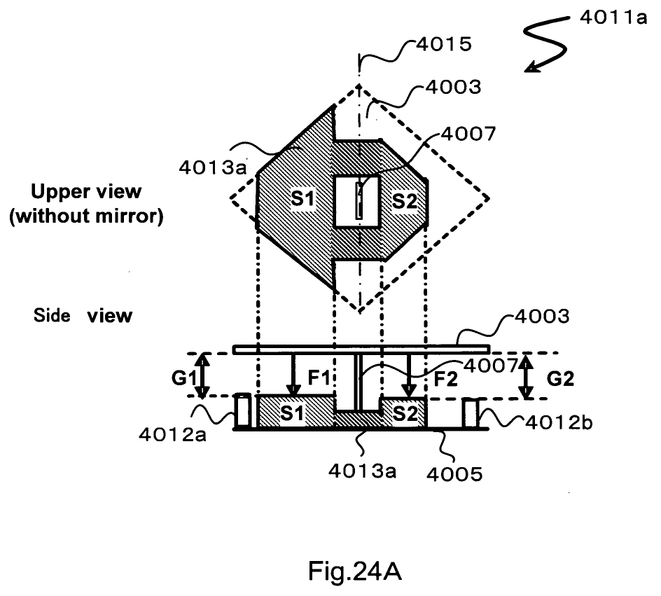

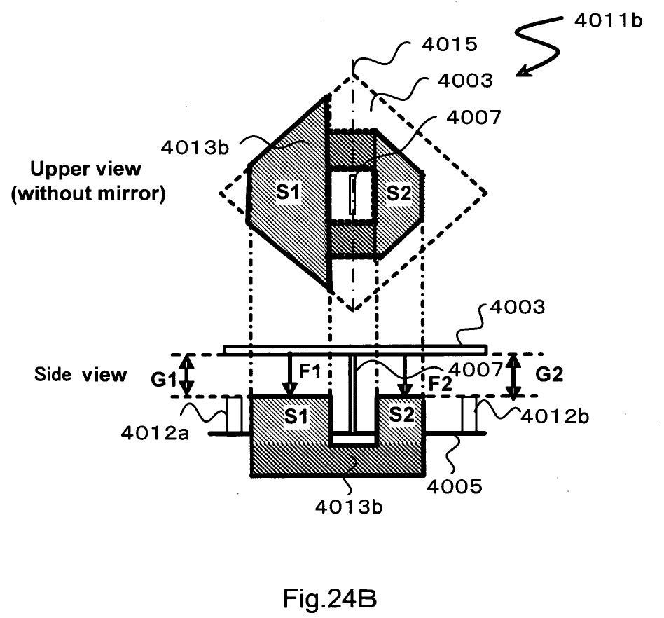

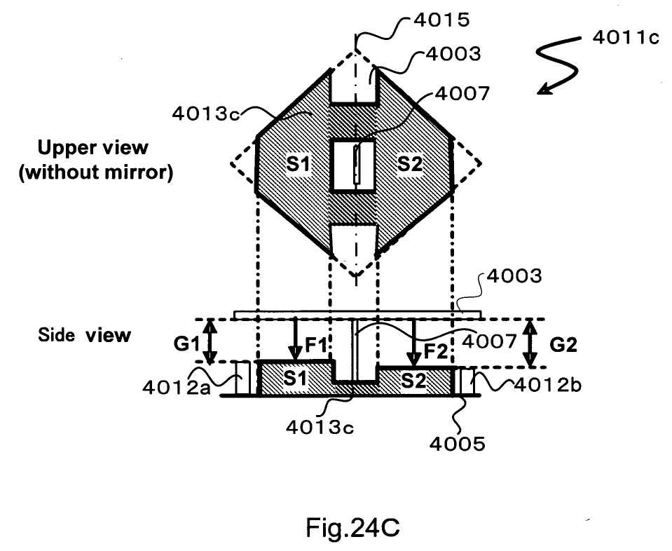

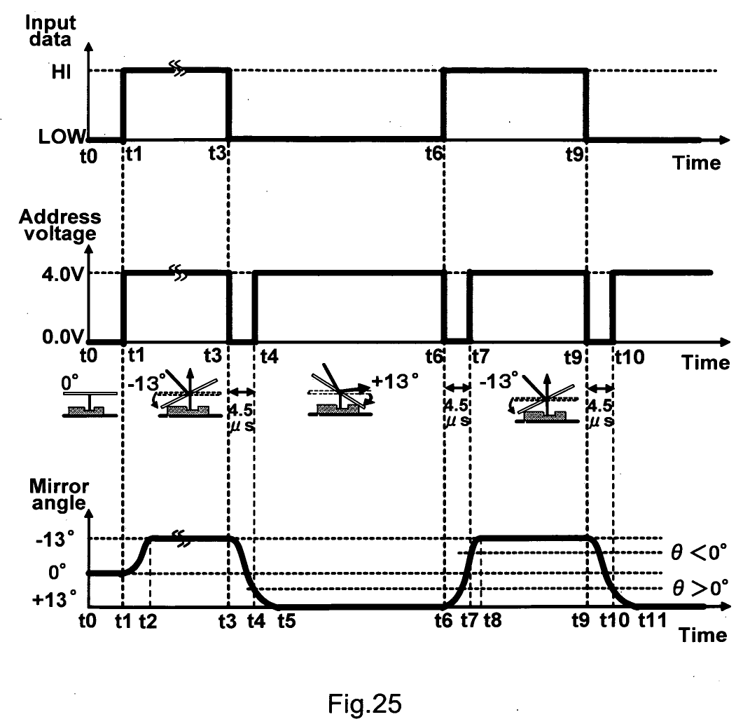

What follows is the description of detailed control of the deflection of a mirror by one address electrode 4013 with reference to FIGS. 24A, 24B, 24C and 25.

Mirror elements 4011a and 4011b, respectively shown in FIGS. 24A and 24B, are each configured such that the respective area sizes of the first and second electrode parts of the one address electrode 4013, on the left and right sides of the deflection axis 4015 of the mirror 4003, are different from each other (i.e., asymmetrical).

FIG. 24A is the top and side views of a mirror element 4011a structured in such a way that the area size S1 of a first electrode part of the one address electrode 4013a is greater than the area size S2 of a second electrode part (S1>S2), and such that the part connecting the first and second electrode parts are in the same structural layer as the first and second electrode parts.

However, FIG. 24B is the top and side views of a mirror element 4011b structured in such a way that the area size S1 of the first electrode part of the one address electrode 4013b is greater than and the area size S2 of a second electrode part, such that S1>S2, and such that the part connecting the first and second electrode parts are in a structural layer different from the layer in which the first and second electrode parts are placed.

The control of the deflecting operation of mirrors in the mirror elements 4011a and 4011b shown in FIGS. 24A and 24B, respectively, is described with reference to FIG. 25.

FIG. 25 is a timing diagram showing the sequence and the relationship between data input to the mirror elements 4011a or 4011b, the voltage application to the address electrodes 4013a or 4013b, and the deflection angles of the mirror 4003, in a time series.

In FIG. 25, the data is inputted to the mirror element 4011a or 4011b, which is controlled in two states, HI and LOW, with HI representing a data input, that is, projecting an image, and LOW representing no data input, that is, not projecting an image.

The vertical axis of the “address voltage” of FIG. 25 represent the voltage values applied to the address electrodes 4013a and 4013b of the mirror element 4011a and 4011b, for example, “4” volts and “0” volts. The vertical axis of the “mirror angle” of FIG. 25 represents the deflection angle of the mirror 4003, setting “0” degrees as the deflection angle when the mirror 4003 is parallel to the device substrate 4004. Further, with the first electrode part defined as the ON state side, the maximum deflection angle of the mirror 4003 in the ON state is set at −13 degrees. With the second electrode part defined as the OFF state side, the maximum deflection angle of the mirror 4003 in the OFF state is set at +13 degrees. Therefore, the mirror 4003 deflects within a range in which the maximum deflection angles of the ON state and OFF state are +13. The maximum deflection angle designated at 13 degrees is only provided as an example and the maximum deflection angle may be flexibly adjusted to other value larger or smaller than 13 degrees. The horizontal axis of FIG. 25 represents elapsed time t.

In FIGS. 24A and 24B, when deflecting the mirror 4003, voltage is applied to the address electrodes 4013a and 4013b with a timing according to the elapsed time of data input and data overwriting.

Between time t0 and t1 in FIG. 25, data is not inputted, and the mirror 4003 is in the initial state. Specifically, no voltage is applied to the address electrodes 4013a and 4013b, and the deflection angle of the mirror 4003 is at 0 degrees.

At time t1, a voltage of 4 volts is applied to the address electrode 4013a or 4013b, causing the mirror 4003 to be attracted by a coulomb force generated between the mirror 4003 and address electrode 4013a or 4013b towards the first electrode part, which has a larger area size, so that the mirror 4003 shifts from the 0-degree deflection angle at time t1 to a −13-degree deflection angle at time t2. The mirror 4003 is then retained on the stopper 4012a or on the first electrode part.

In this case, the fact that the mirror 4003 is drawn to the first electrode part side having the larger area of the address electrodes 4013a and 4013b can be understood the Coulomb force F calculated from equation (1) as follows.

$$F = \frac{1}{4 π {r}^{2}} \cdot \frac{1}{ɛ} {q}_{1} {q}_{2} \qquad ( 1 )$$

where “r” is the distance between the address electrode 4013a and mirror 4003, “∈” is permittivity, and “q1” and “q2” are the amounts of charge retained by the address electrodes 4013a and 4013b and the mirror 4003.

The distance G1 between the mirror 4003 and the first electrode part and the distance G2 between the mirror 4003 and the second electrode part are equal when the mirror 4003 is in the initial state. However, since the first electrode part has a larger area than the second electrode part, and the first electrode part can retain a larger amount of charge, and as a result, a larger coulomb force is generated for the first electrode part.

Between time t2 and time t3, the mirror 4003 is retained on the stopper 4012a of the first electrode side as a result of continuously applying a voltage of 4 volts to the address electrode 4013a, in accordance with data inputted.

Then, at time t3, stopping the data input applies a voltage of “0” volts to the address electrode 4013a. As a result, the Coulomb force generated between the address electrode 4013a and mirror 4003 is cancelled. This causes the mirror 4003 retained on the first electrode part side to be shifted to a free oscillation state due to the restoring force of the elastic hinge 4007.

Then, at time t4, when in the deflection angle θ of the mirror 4003 is greater than 0 degrees (θ>0), the Coulomb force F 1 generated between the mirror 4003 and the first electrode part is less than coulomb force F2 generated between the mirror 4003 and the second electrode part (F1<F2), a voltage of 4 volts is again applied to the address electrodes 4013a and 4013b, and the mirror 4003 is drawn to the second electrode part.

Then, at time t5, the mirror 4003 is held by the stopper 4012b of the second electrode part. The reason for this is that the second power of a distance has a larger effect on a coulomb force F than the difference in electrical potentials, according to the equation of the electrostatic force as discussed above in equation (1).

Therefore, with an appropriate adjustment of the area sizes of the first and second electrode parts, a coulomb force F has a stronger effect on the smaller distance G2, the distance between the address electrode 4013a and 4013b and the mirror 4003, despite the fact that the area S2 of the second electrode part is smaller than the area S1 of the first electrode part. As a result, the mirror 4003 can be deflected to the second electrode part.

Note that the transition time of the mirror 4003 between the time t3 and t4 is preferably about 4.5 μsec, in order to obtain a high grade of gradation. Further, it is possible to perform a control in such a manner so as to turn off the illumination light in sync with a transition of the mirror 4003, so as to not let the illumination light be reflected and incident to the projection light path during a data rewrite, that is, during the transition of the mirror 4003, between the time t3 and t4.

Between the time t5 and t6, the mirror 4003 is continuously retained on the stopper 4012b of the second electrode part by continuously applying voltage to the address electrode 4013a and 4013b. During this time, no data is inputted and no image is projected.

Then, at time t6, new data is inputted. The voltage of 4 volts, which has been applied to the address electrode 4013a, is changed over to “0” volts at time t6, in accordance with the data input. This operation cancels the Coulomb force generated between the mirror 4003, retained on the second electrode part, and the address electrode 4013a, similar to the case at time t3, so that the mirror 4003 shifts to a free oscillation state due to the restoring force of the elastic hinge 4007.

Then, a voltage of 4 volts is again applied to the address electrode 4013a at time t7. Coulomb force F1, which is generated between the mirror 4003 and first electrode part, becomes greater than coulomb force F2, which is generated between the mirror 4003 and the second electrode part, (F1>F2) when the deflection angle of the mirror 4003 becomes θ<0 degrees, and thereby the mirror 4003 is attracted to the first electrode part and is retained on the first electrode part at time t8.

This principle is understood from the description of the action of a coulomb force between the above described times t3 and t5. In this case, too, the transition time of the mirror 4003 between time t6 and t7, is preferably about 4.5 μsec, and the control is performed in such a manner to turn off the illumination light in sync with a transition of the mirror 4003, so as to not let the illumination light be reflected and incident to the projection light path during the transition of the mirror 4003.

Then, between the times t8 and t9, the mirror 4003 is continuously retained on the stopper 4012a of the first electrode part by continuously applying a voltage of 4 volts to the address electrode 4013a and 4013b. During this period, data is continuously inputted, and images are projected.

Then, when at time t9 the data input is stopped, the voltage of the address electrodes 4013a and 4013b is switched from 0 volts to 4 volts. Thus, the mirror 4003 enters a free oscillation state again. Then, according to the same principle as between time t3 and t5 and time t6 and time t8, by applying voltage to the address electrodes 4013a and 4013b at time t10, at time t11 the mirror 4003 can be held by the stopper 4012b on the second electrode part side.

A repetition of similar operations controls the deflection of the mirror 4003.

Next is a description of the control necessary for returning the mirror 4003 from being retained on the stoppers 4012a or 4012b of the first or second electrode parts back to the initial state by the application of an appropriate pulse voltage.

For example, changing the voltage applied to the address electrode 4013a and 4013b to “0” volts causes the mirror 4003 to perform a free oscillation. During free oscillation, when the distance between the address electrode 4013a or 4013b and the mirror 4003 becomes appropriate, a temporary application of an appropriate voltage to the address electrode 4013a or 4013b generates a coulomb force F that pulls the mirror 4003 back to the first electrode part or second electrode part, on which the mirror was previously retained, that is, generates acceleration in a direction opposite to the direction in which the mirror 4003 was heading, and thereby the mirror 4003 can be returned to the initial state.

Thus, the application of a pulse voltage to the one address electrode 4013a or 4013b, as described above, makes it possible to return the mirror 4003 to the initial state from a state of being retained on the stoppers 4012a or 4012b of the first or second electrode parts.

Applying the principle of Coulomb force between the mirror and address electrode 4013a and 4013b, as described above, the application of a voltage to the address electrode 4013a and 4013b at an appropriate distance between the mirror 4003 and address electrode 4013a 4013b also makes it possible to retain the mirror 4003 at the deflection angle of the OFF state by returning the mirror 4003 from the ON state, or at the deflection angle of the ON state by returning the mirror 4003 from the OFF state.

The control of the mirror 4003 of the mirror elements 4011a and 4011b, shown in FIG. 25, can be widely applied to a mirror element having one address electrode and a horizontal (left/right) asymmetrical structure about the elastic hinge or the deflection axis of a mirror. As described above, the mirror can be deflected to the deflection angle of the ON state or OFF state, or put in the free oscillation state, with a single address electrode of a mirror element.

FIG. 24C is the top and side views of a mirror element 4011c structured such that the area size S1 of the first electrode part of the one address electrode is equal to the area size S2 of a second electrode (S1=S2), and such that the distance G1 between a mirror 4003 and the first electrode part is less than the distance G2 between the mirror 4003 and the second electrode part (G1<G2).

Specifically, in FIG. 24C the height of the first electrode part is greater than that of the second electrode part, and the distance G1 between the first electrode part and the mirror 4003 is less than the distance G2 between the second electrode part and the mirror 4003 (G1<G2). Further, the part connecting the first electrode part to the second electrode part is on the same layer as the address electrode 4013.

In the case of the mirror element 4011c as shown in FIG. 24C, the size of the Coulomb force generated between the mirror 4003 and address electrode 4013c in the first electrode part differs from that generated between the mirror 4003 and address electrode 4013c in the second electrode part because the distances between the mirror 4003 and address electrode 4013c are different. Therefore, the deflection of the mirror 4003 can be controlled by carrying out a control similar to the case described above in FIG. 25.

The maximum deflection angles of the mirror 4003 as shown in FIGS. 24A, 24B and 24C show are defined by the stoppers 4012a and 4012b. However, the maximum deflection angles of the mirror 4003 can also be established by configuring the address electrode 4013c to also serve the function of the stoppers 4012a and 4012b.

Further, while the present embodiment is configured to set the control voltages at 4-volt and 0-volt applied to the address electrode 4013a, 4013b or 4013c, such control voltages may be adjusted depending on specific applications and other appropriate voltages may be used to control the mirror 4003.

Furthermore, the mirror can be controlled with multi-step voltages applied to the address electrode 4013a, 4013b or 4013c. As an example, if the distance between the mirror 4003 and address electrode 4013a, 4013b or 4013c is reduced to increase the Coulomb force, the mirror 4003 can be controlled with a lower voltage than when the mirror 4003 is in the initial state.

Next, the material of each constituent component of the mirror element is described.

The mirror 4003 is formed of a highly reflective metallic material, such as aluminum (Al) or a multilayer film made of a dielectric material. The entirety or a part of the elastic hinge 4007 (e.g., the base part, neck part, or intermediate part) is formed by a metallic material possessing a restoring force. The material for the elastic hinge 4007 may use, for example, silicon (Si), such as amorphous silicon (a-Si) or single crystal silicon, either of which is an elastic body. The address electrodes 4013a, 4013b and 4013c are configured to have the same electric potential, by using, for example, aluminum (Al), copper (Cu), and tungsten (W) as a conductor. The insulation layer 4006 uses, for example, silicon dioxide (SiO₂) and silicon carbide (SiC). The device substrate 4004 uses a silicon material. The materials and forms of each constituent part of a spatial light modulator can be changed in accordance with function.

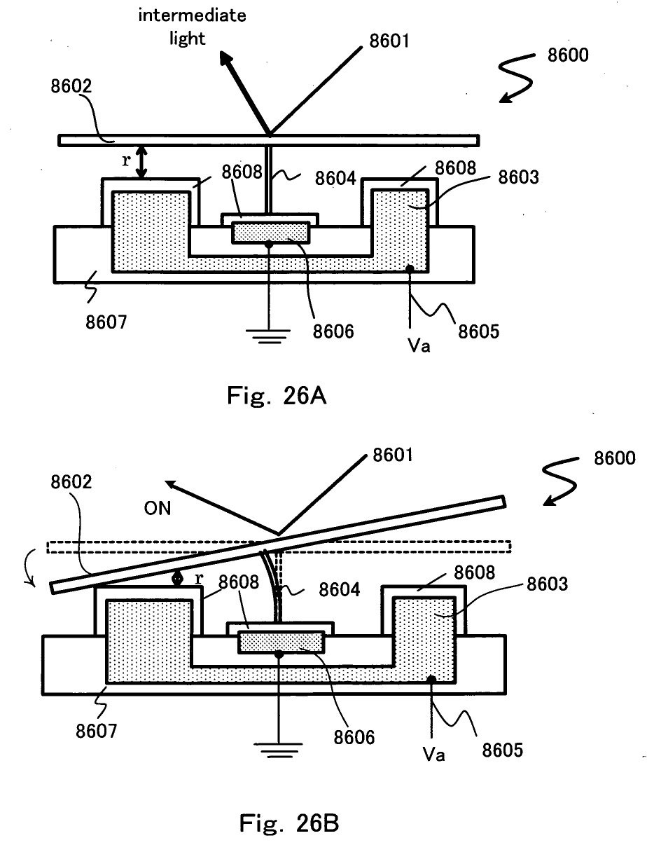

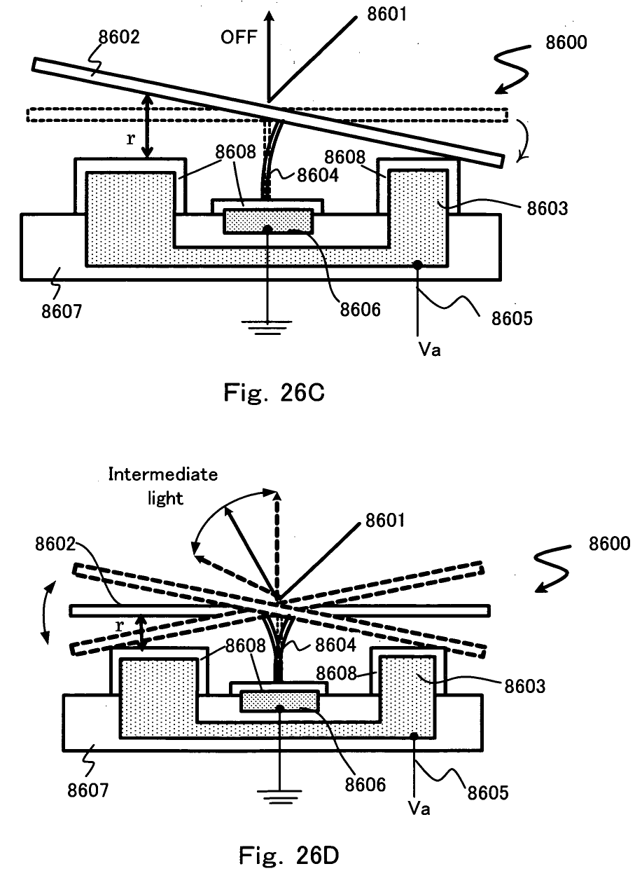

FIG. 26A shows the structure of one mirror element of the mirror device in this preferred embodiment. In this mirror element 8600, a driver circuit is formed on a substrate 8607 is for deflecting a mirror 8602. An insulating layer 8608 is also provided on the substrate 8607, and one elastic hinge 8604 is included on the insulating layer 8608. The elastic hinge 8604 supports the mirror 8602, and the single address electrode 8603, connected to the one drive circuit, is provided below one mirror 8602. This mirror 8602 is electrically controlled by the single address electrode 8603 and the one drive circuit connected to the single address electrode 8603. A hinge electrode 8606 connected to this elastic hinge 8604 is grounded through the insulating layer 8608.

FIG. 20 shows that the mirror device can be formed by configuring a plurality of mirror elements 8600 on the substrate 8607.

In this patent application, the elastic hinge 8604 or the deflection axis of the mirror 8602 serves as the boundary of the right and left sides of the exposed parts of the single address electrode 8603 shown in FIG. 26A. The exposed parts are called the first and second electrode parts, respectively, and by applying voltage to the single address electrode 8603; a Coulomb force can be generated between the first or second electrode part and the mirror 8602. In this case, “to apply voltage” may also be termed “to change potential in a predetermined waveform”. By differentiating the Coulomb force in the left and right sides of the mirror 8602, the mirror 8602 can be deflected to the left and the right. It is preferable that an angle of deflection formed by the mirror and the vertical axis of the substrate 8607 is symmetrical when the mirror 8602 is deflected to the left and right of the deflection axis.

The materials for each constituent component of the mirror element 8600 may be made of the same materials as those of the mirror element 4011a, 4011b, and 4011c described respectively in FIGS. 24A, 24B, and 24C above. In this patent application, for the elastic hinge 8604 may be a cantilever type having sufficient elasticity to freely oscillate the mirror 8602. This elastic hinge 8604 can also be a torsion hinge.

The material and shape of each constituent component of the mirror element 8600 in this patent application may be flexibly changed according to particular functions.

In FIGS. 26B to 26D, the single address electrode 8603 has a symmetrical structure about the elastic hinge 8604 or the deflection axis of a mirror. The first and second electrode parts of the single address electrode 8603 are defined as the OFF and ON light sides, respectively.

The initial state of the mirror device in this preferred embodiment is a state in which a mirror is maintained in a horizontal position in relation to the substrate, as shown in the cross-section view of one mirror element in FIG. 26A. In the following description, it is assumed that in the initial state of a mirror, incident light 8601 is reflected as intermediate light.

FIG. 26B is the cross-section view of the mirror element 8600 in the ON state of a mirror device in this preferred embodiment.

In FIG. 26B, by applying a voltage to the single address electrode 8603 in the initial state (shown in FIG. 26A), a Coulomb force F is generated between the first and second electrode parts and the mirror 8602. In this case, if the area of the second electrode part is larger than that of the first electrode part, the Coulomb force generated between the second electrode part and the mirror 8602 is stronger than that generated between the first electrode part and the mirror 8602. Therefore, the mirror 8602 is deflected toward the second electrode part, thereby making reflecting the incident light 8601 as ON light.

FIG. 26C is the cross-section view of the mirror element 8600 in the OFF state of a mirror device in this preferred embodiment.

In FIG. 26B, voltage is applied to the single address electrode 8603 and, after reflecting the incident light as 8601 ON light, the power to the single address electrode 8603 is cut off. As a result, the mirror 8602 freely oscillates because of the elasticity of the elastic hinge 8604. In this free oscillation, the mirror 8602 oscillates between the deflection angles for the ON light and the OFF light.

When a distance r between the freely oscillating mirror 8602 and the OFF light side of the single address electrode 8603 (i.e., the first electrode part) decreases, a voltage is applied to the single address electrode 8603 at an appropriate time. A Coulomb force F is generated between the first and second electrode parts and the mirror. In this case, if the distance between the first electrode part and the mirror is shorter than the distance between the second electrode part and the mirror, the Coulomb force F generated between the first electrode part and the mirror is greater than that generated between the second electrode part and the mirror, since coulomb force F is inversely proportional to the square of the distance. Therefore, the mirror element 8600 is drawn to the first electrode part and is held on that side, reflecting incident light as OFF light.

Then, in order to restore the mirror 8602 to the initial state from the free oscillation, an appropriate pulse voltage is applied to the single address electrode 8603 as a specific time in order to stop the mirror 8602. Conventionally, in order to restore the mirror 8602 to this initial state, a mirror must be stopped by applying an appropriate voltage to two address electrodes in order to generate two Coulomb forces of equal strength. However, in this preferred embodiment, the mirror 8602 can be restored to the initial state by applying pulse voltage to the single address electrode 8603.

By controlling the input of voltage to the single address electrode 8603, the ON light and OFF light of incident light can be controlled. Therefore, the number of address electrodes needed to control the mirror can be reduced, and each mirror can be independently controlled. Since one address electrode is sufficient to control the mirror, one drive circuit connected to the address electrode is also sufficient to control the mirror. Thus, the size of the mirror device can be decreased.

FIG. 26D shows a mechanism which controls the intensity of light reflected to a projection path by freely oscillating a mirror between at the deflection angles of the ON light and the OFF light to control the intensity of intermediate light. The mirror 8602 repeatedly oscillates between the ON state, intermediate state, and OFF state as shown in FIG. 26D. By controlling the number of oscillations, the intensity of incident light reflected to a projection path can be controlled. Therefore, by totaling the intensity of incident light reflected to the projection path per one repetition for the number of repetitions in one frame, the intensity of light in an intermediate state, between a complete ON state and a complete OFF state, can be controlled.

Thus, the amount of light reflected by the mirror can be controlled in at least three states: the ON light state, intermediate light state, and the OFF light state by a single address electrode, and the intensity of light reflected to the projection path can be adjusted alternatively, the height of the first and second electrode parts of the single address electrode shown in FIGS. 26A to 26D can be changed. Stoppers and other similar parts may also be added.

In this case, any of the following three: 1.) The initial state of a mirror, 2.) The deflection of the mirror to the first electrode part and 3.) The deflection of the mirror to the second electrode part, shown in FIGS. 26A to 26D, can be assigned as the ON state, the OFF state and an intermediate state. The free oscillation can be controlled with an elastic hinge applying a restoring force suitable for performing the function of deflecting the mirror to oscillate in both directions.

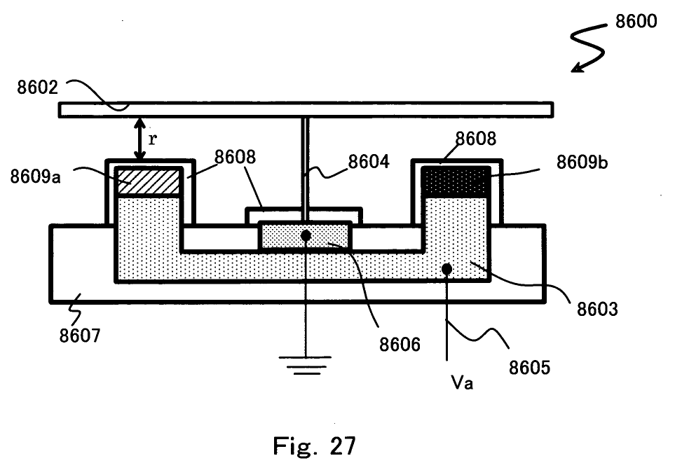

The single address electrode can also have asymmetrical physical properties about the deflection axis of a mirror. As an example, FIG. 27 shows how the mirror 8602 can be controlled under the ON and OFF light states when electrode materials 8609a and 8609b, with mutually different permittivity values, are used for the upper parts of the first electrode part 8603a and second electrode part 8603b, respectively, of the single address electrode 8603 of one mirror element 8600 of a mirror device, according to the present embodiment. According to the configuration in FIG. 27, other than using materials with different permittivity values on the upper parts of the first and second electrode parts of the single address electrode, the mirror element is formed to be symmetrical about the elastic hinge 8604.

If the mirror is made of a material based on Si or SiO₂, a material with a different and high permittivity value is preferably Si₃N₄, or HfO₂. Specifically, the materials may include a high-k material, which is has recently been commonly recognized as materials compatible to a miniaturization of devices manufactured on a semiconductor substrate.

The following is a description of a method for configuring a mirror element using materials with different permittivity values for the first 8603a and second 8603b electrode parts of the upper parts of the single address electrode 8603, thereby controlling the mirror 8602 under the ON and OFF light states. The control method for the mirror 8602 according to the present embodiment will be understood by referring to the control method put forth in the FIG. 25. Here, a brief description of the control method for the mirror element shown in FIG. 27 is provided.

When deflecting the mirror 8602 from the initial state, the application of a voltage to the single address electrode 8603 makes it possible to tilt the mirror 8602 to the side where a material with lower permittivity is used on the basis of the above-described expression (1). A stronger Coulomb force is generated with the side with lower permittivity. The mirror 8602 tilted from the initial state starts performing a free oscillation when the voltage applied to the single address electrode 8603 is temporarily cut to “0” volts. When the free-oscillating mirror 8602 comes close to the single address electrode 8603 on either the ON light side or OFF light side, an appropriate voltage is applied to the single address electrode 8603. As a result, the mirror 8602 can be retained onto the ON light side or OFF light side, that is, the first electrode part 8603a or second electrode part 8603b, and thereby the ON light state or OFF light state can be produced. Because the Coulomb force F represented by the expression (1) has a stronger function with the second power of the distance r between the mirror 8602 and single address electrode 8603 than with the permittivity ∈ thereof, the fact that the distance r between the single address electrode 8603 and mirror 8602 is shorter has a stronger effect on the Coulomb force F than the magnitude of the permittivity ∈. Therefore, it is possible to tilt the mirror 8602 to the ON light side, or OFF light side, when either of the distances r between the single address electrode 8603 and mirror 8602 is shorter.

Thus, the mirror 8602 can be controlled to move to an OFF or ON state from the initial state.

The control method for returning the mirror 8602 from the ON light state or OFF light state to the initial state may also be understood from the control method put forth in FIG. 25. It is possible to return the mirror 8602 to the initial state by applying an appropriate pulse voltage while the mirror is retained on the ON light state or the OFF light state. For example, the mirror 8602 performs a free oscillation by temporarily reducing the voltage applied to the single address electrode 8603 to “0”. Then, during the free oscillation, while the mirror is tilting in one direction, a voltage is temporarily applied to the single address electrode 8603 just when the distance r between the single address electrode 8603 and mirror 8602 reaches an appropriate value. As a result, a Coulomb force F pulls the mirror 8602 in the direction opposite the one in which it was heading during free oscillation. Generating acceleration towards a different direction from the one in which it was heading enables the return of the mirror 8602 from either the ON or OFF light state to the initial state.

This control of the mirror 8602 of the mirror device is preferably carried out using non-binary data obtained from converting binary data, with the conversion methods put forth in FIGS. 14, 15, 16 and 17. In this preferred embodiment, each mirror 8602 is controlled by pulse width modulation (PWM), using non-binary data.

As seen in the above description, when a single address electrode 8603 controls the mirror 8602, and the mirror 8602 is tilted first from the initial state to a side with a smaller Coulomb force between the mirror 8602 and single address electrode 8603, a “dummy operation” is required, in which the mirror 8602 is first tilted towards the side with a larger Coulomb force between the mirror 8602 and single address electrode 8603. The present embodiment is configured to turn off the light source in synchronous with the mirror device during a period in which the mirror is performing the dummy operation.

It is preferable to control mirror element of the mirror device using non-binary data generated by converting binary data, as described in FIGS. 14, 15, 16 and 17.

The change of projected images in synchronization with a semiconductor light source and a spatial light modulator 5100 in the projection device in this preferred embodiment is described below.

In general, a light source is controlled to change either the brightness of the illumination light or the lengths of the illumination time. Hence, a light source generally controls the brightness of the light projected to a spatial light modulator 5100 with different light intensities for displaying projection image modulated with a spatial light modulator 5100 is.

Operating the light source to emit pulses, however, makes it possible to increase the number of changeovers among sub-frames corresponding to the respective colors red (R), green (G) and blue (B), which are three primary colors of light, by increasing the frequency of emission and also, for example, shortening the irradiation periods for the lights of each of the colors R, G and B. Such a control makes it possible to cause a color break to be inconspicuous.

By changing the emitting position of a sub light source 5210a (sub light source 5211a, 5212a or 5213a), the uniformity of illumination light flux can also be modified. Specifically, it is possible to generate a locally bright emission position and a locally dark emission position.

The light source therefore allows for adjustment of the intensity of the illumination light that passes through the illumination optical system. The light source further allows an operational process to adjust the uniformity of the illumination light. Furthermore, such control processes can be carried out for individual light sources, emitting the lights of specific wavelengths in accordance with an image signal, transmitted from the control unit 5500 used for controlling the spatial light modulator 5100. As a result, it is possible to adjust the intensity of light modulated by the spatial light modulator 5100 to match the specific device specification of for the projection apparatus.

If the semiconductor light source is a laser light source, a projection light intensity may be adjusted by the diffraction angle of diffracted light by generating the diffracted light with the spatial light modulator 5100.

The control unit 5500 for controlling the spatial light modulator 5100 controls the spatial light modulator 5100 in sync with the emission light intensity of the semiconductor light source, the number of emissions, the emission period, the emission timing, the number of emitting sub light source 5210a (sub light source 5211a, 5212a or 5213a) and the emitting position of the sub light source 5210a (sub light source 5211a, 5212a or 5213a), together with the spatial light modulator 5100.

The control unit 5500 can change the total time of the sub-frame time corresponding to light of at least one color of a projected image, while controlling the semiconductor light source and the spatial light modulator 5100. For example, conventionally, in the case of a single-plate projection device provided with a mercury lamp light source and a mirror device as the spatial light modulator 5100, the period of a sub-frame is determined for each color by a color wheel and by changing the brightness of illumination light, that is, the intensity of illumination light, the dynamic range of an image is changed.

In this preferred embodiment, a corresponding sub-frame, modulation timing, can be flexibly changed for each light of each color by synchronizing a plurality of light source controls and the control of the spatial light modulator 5100 by the control unit 5500. For example, by decreasing to half the times of pulse width modulation (PWM) of a light source having a specific wavelength and also by decreasing to half the times of light emission of the sub light source 5210a (sub light source 5211a, 5212a or 5213a) implemented in the light source, the amount of applied light can be reduced to ¼. The modulation time of light is quadrupled by applying a control process for achieving the control of the same amount for controlling the gray scales. liBy controlling the semiconductor light source with the control unit 5500, the levels of gray scales of the image display with the light of at least one color can also be changed in one frame.

For example, the control unit 5500 can control the right half of the sub light source 5210a (sub light source 5211a, 5212a or 5213a), of a plurality of sub light sources 5210a (sub light sources 5211a, 5212a and 5213a) disposed in the light source to emit many beams of light. Thus, light intensity can be changed independently in the right and left halves. The control unit 5500 can also control the right and left halves of the sub light source 5210a (sub light source 5211a, 5212a or 5213a) to alternately emit light. Thus, light-emitting timing can also be staggered. As a result, the uniformity of the illumination light flux can be changed. In this case, if the spatial light modulator 5100 is a mirror device and the deflection angle of its mirror is between the ON and OFF states (that is, an intermediate state), only part of light flux reflected by the mirror passes through the pupil of the projection optical system. Then, by such a control, the intensity of part of the light flux can be changed. As a result, the intensity of light can be finely adjusted and the projected light can have a higher gradation.

By changing the diameter of the pupil of the projection optical system, through which light transmits, and also by controlling the light intensity of the light source, the cross-section area of the light flux passing through the pupil of the projection optical system can also be changed. As a result, the intensity of projected light can be more precisely adjusted.

In a multi-plate projection device, the control unit 5500 controls at least one of a plurality of spatial light modulators 5100 for modulating light of a plurality of wavelengths, the total time of sub-frame time corresponding to light having each wavelength and/or gradation of light of each wavelength can also be changed.

For example, if it is desired to increase the length of a sub-frame corresponding to light of a specific wavelength, a sub-frame corresponding to light of another wavelength is decreased. Then, the light source is synchronously controlled to shorten the sub-frame and reduce the gradation of light in the corresponding sub-frame.

The levels of gray for image display for the light of each wavelength can also be flexibly adjusted without changing the length of a sub-frame.

Furthermore, when the spatial light modulator 5100 is implemented with a mirror device, the deflection angle of each mirror can be repeatedly and simultaneously changed from an ON state to an OFF state and from an OFF state to an ON state in synchronization with the emitting/extinguishing timing of the light source. As a result, the amount of reflected light can be reduced, compared with when the deflection angle of a mirror is held only in an ON state. Therefore, in this manner, the intensity of light can be more precisely controlled. As a result, the level of gray scales for achieving a higher gradation of image with increased resolution of brightness contrast can be achieved.

A multi-panel projection apparatus, with illumination lights of multiple wavelengths, may alternatively be configured so that at least one spatial light modulator 5100 modulates the lights of a few wavelengths, while the remaining spatial light modulators modulate the lights of remaining wavelengths of the illumination lights.

As an example, a two-panel projection apparatus is configured with one spatial light modulator 5100 modulates the illumination light with the green wavelength, while the other spatial light modulator 5100 modulates the illumination lights with red and blue wavelengths. The multi-panel projection apparatus that includes a plurality of spatial light modulators thus apply the spatial light modulators to modulate the illumination lights of the respective colors.

A multi-panel projection apparatus, with illumination lights of multiple wavelengths, may alternatively be configured such that a first spatial light modulator 5100 modulates the illumination lights of a few wavelengths, while the other spatial light modulator(s) modulates the lights of multiple wavelengths, including those modulated by the first spatial light modulator.

As an example, a two-panel projection apparatus includes one spatial light modulator 5100 to modulate the illumination lights of the green and blue wavelengths, while the other spatial light modulator modulates that of the red wavelength. A three-panel projection apparatus may alternatively implement one spatial light modulator to modulate the illumination light of the green wavelength, while another spatial light modulator modulates a light of red wavelength, and the remaining spatial light modulator to modulate the projection of the green and blue wavelengths. In this way, several spatial light modulators may modulate the illumination light of the same color in a multi-panel projection apparatus, comprising a plurality of spatial light modulators.

Preferably, in a multi-panel projection apparatus, the control unit 5500 for a spatial light modulator 5100 controls a semiconductor light source and/or a spatial light modulator 5100 so that the length of time an illumination light is modulated by at least two spatial light modulators are about the same within one frame.

As an example, when the illumination lights of the colors R, G and B are modulated in a three-panel projection apparatus, the control unit 5500 extends the period for modulating the illumination light of one color to match the period required for modulating the color with the maximum modulation period. Specifically, the lengths of time for modulating the illumination lights of R, G and B are lined up as much as possible. In this case, the control unit 5500 performs a control to lower the intensity of the illumination light of a color by controlling the number of emitting sub-light sources, thereby extending the length of time for modulating the illumination light. Such control is also applicable to a two-panel projection apparatus in a similar manner.

The control unit 5500 for a spatial light modulator 5100 preferably controls the semiconductor light source on the basis of the total length of time of an individual sub-frame of the illumination light of each wavelength so that the ratio of brightness of the illumination lights of each wavelength is close to the distribution of the spectral luminous efficiency.

The intensity of the illumination light of each wavelength can be adjusted by adjusting, for example, the number of individual sub-light sources. Furthermore, the ratio of the brightness of the illumination light of each wavelength can be approximated to the distribution of the spectral luminous efficiency on the basis of the total lengths of time of an individual sub-frame corresponding to the illumination light of each wavelength. In this event, if the totals of the individual sub-frame of the illumination light of each wavelength are the same, the ratio of brightness of an image to be projected can be approximated to the distribution of the spectral luminous efficiency by matching the ratio of intensity of the illumination light of each wavelength with the distribution of the spectral luminous efficiency.

In contrast, even if the respective sub-frames of the illumination lights of individual wavelengths are different, the ratio of the intensity of the illumination light of each wavelength can be approximated to the distribution of spectral luminous efficiency by controlling the length of time for modulating each respective sub-frame of the illumination light of each wavelength by adjusting the quantity of the illumination light of each wavelength. Specifically, the control unit 5500 for the spatial light modulator 5100 for adjusting the quantity of the illumination light of each wavelength can control and adjust the length of time for modulating the sub-frame of the illumination light of each wavelength in line with the spectral luminous efficiency.

Note that such a control may be carried out for each frame of the illumination light of each wavelength instead of for each sub-frame of the illumination light of each wavelength.

Furthermore, the control unit 5500 of the spatial light modulator 5100 may also controls a semiconductor light source to project the illumination light of each wavelength to change the gray scales of an image.

It is also preferable that the control unit 5500 of the spatial light modulator 5100 controls the semiconductor light source to change the white balance or gamma characteristic of a projected image. Thus, a pixel for setting a white color to a projected image can be more flexibly changed. By controlling the amount of light of the semiconductor as described above, the brightness, from 100% white to completely black can also be modified in finer gradations.

It is preferable that the control unit 5500 of the spatial light modulator 5100 controls the semiconductor light source to reduce, as much as possible, the difference between projection times for projecting the illumination light of each wavelength. By controlling the intensity of light and the modulation time of illumination light of each wavelength, the differences between projection times can be eliminated. For example, in a multi-plate projection device, the intensity of light in the illumination light with the shortest modulation time (and darkest color) can be reduced by reducing the period of light emission, and the modulation time can be matched with that of the other wavelengths by increasing the modulation time of the illumination light. Thus, the differences between projection times of each wavelength can be eliminated, and color breaks in a multi-plate projection device can be reduced. Furthermore, when in a single-plate projection device, only illumination light of one wavelength has a short modulation time, as exemplified above, the intensity of light can be reduced by reducing the period of light emission of one wavelength, and the modulation time can be matched with that of the other wavelengths by increasing the modulation time of the illumination light. As a result, the switching times of illumination light of each wavelength can be averaged. By increasing the modulation time thus, the process time of image signals transmitted to the spatial light modulator 5100 from the control unit 5500 of the spatial light modulator 5100 can be reduced.

Preferably, the control circuit can control the spatial light modulator so that the cycle of one frame of modulation of illumination light is between 90 Hz and 360 Hz. Conventionally, in a spatial light modulator, the cycle of one frame of modulation of illumination light is around 60 Hz. If the spatial light modulator is a liquid crystal, such as LC and LCOS, a low-speed operation is sometimes selected to eliminate blurriness in a moving image. In that case, an interpolation image is generated to interpolate the image between frames. Further, the gray scales and dynamic ranges of the interpolation image can be changed. An image of high-level gray scale can be obtained by the control circuit appropriately controlling the number of emitting light sources and the emission light intensity for the image of each frame.

The control circuit for the spatial light modulator may control a semiconductor light source so as to emit an illumination light at a shorter cycle than the cycle of a sub-frame corresponding to the illumination light of the spatial light modulator.

When a frame speed approaches a high speed, for example, 360 Hz, the sub-frame of the illumination light of each wavelength is further shortened. In this case, the control circuit for the spatial light modulator controls the light source to emit pulses in a shorter time than the control of a sub-frame and to alternately change over the emission regions of sub-light source 5210a (sub light source 5211a, 5212a or 5213a).

Furthermore, multiple sub-light source 5210a (sub light source 5211a, 5212a or 5213a) are preferably laser light sources, and the polarizing direction of each sub-light source may be set at a prescribed direction for each wavelength.

The modulation efficiency of light for a liquid crystal device such as LC and LCOS is degraded unless the polarizing directions of the illumination lights are aligned. As an example, when a color separation of an illumination light is carried out by a polarization beam splitter (PBS) in a two-panel projection apparatus as shown in the above described FIGS. 7A through 7D, the color separation can be carried out more conveniently by aligning the polarizing directions of the illumination lights from individual sub light source 5210a (sub light source 5211a, 5212a or 5213a). Therefore, it is preferable to align the polarizing direction of the illumination lights.

However, a plurality of sub-light sources each may comprise a laser light source and at least one of the sub-light sources may have a different polarizing direction.

When using a mirror device as a spatial light modulator, adjustment of the polarizing direction of the illumination light emitted from a sub-light source may not be required because a modulation efficiency of light is not affected by the polarizing direction of the illumination light. Therefore, the illumination light emitted from the sub-light source may have a different polarizing directions.

Furthermore, the polarizing directions of the light of a specific wavelength emitted from an adjustable number of sub-light sources may be changed by rotating it by ½π, et cetera. Such a configuration makes it possible to adjust a variation of the critical angle. The adjustment is important when the illumination light of an individual wavelength is reflected by the total internal reflection (TIR) surface of a prism or a similar optical device, depending on the polarizing direction of the illumination light of an individual wavelength. Furthermore, also when using either mirror device or liquid crystal device such as LCD or LCOS, an optical element such as a polarization beam splitter (PBS) may be applied to separate an illumination light by the polarizing directions for selectively transmitting only the light of a specific polarizing direction to flexibly adjust the light intensity.

The illumination light and/or the projection light of a projection apparatus according to the present embodiment each may preferably be a polarized light and the projection apparatus preferably comprises a polarization control unit for controlling a polarizing direction.

In addition to using such a device, a liquid crystal device such as LC and LCOS allows a control of a polarizing direction; the projection apparatus may comprise a control circuit for controlling the emission light intensity and emission timing of the light source, and a polarization control unit, placed in the illumination light path of the light from the light source or a projection light path, for controlling the intensity of a transmission light. The polarization control unit may be a commercial product called a color switch that is produced by combining a liquid crystal with a polarization filter. Furthermore, the polarizing direction of the light of a plurality of wavelengths may be controlled at the polarization control unit.

Furthermore, a projection apparatus is preferred to implement a mirror device as a spatial light modulator for modulating illumination lights with different polarizing directions and wavelengths, respectively.

As an example, when at least one mirror device modulates both of the illumination lights in two colors with different polarizing directions in a two-panel projection apparatus, a transmissive optical element, such as an LC, is placed in the projection light path to project only the light of a specific polarizing direction. Further, the lights of respective colors are projected in sequence by changing over the states of the LC in synchronization with the color of an image signal in order to separate polarized lights.

The wavelengths of light transmitting through the PBS can be changed over in sequence by sequentially changing the polarizing directions of the illumination lights of two colors by a color switch when an optical element such as a polarization light beam splitter (PBS) is placed in a projection light path in order to separate a polarized light.

This control process for sequentially changing over polarizing directions can also changeover the polarizing directions and adjust a light intensity by comprising sub-light sources with different polarizing directions, configuring a light source appropriately setting the number of emitting sub-light sources and the positions thereof for each wavelength of the light and changing over the sub-light sources in sequence on the basis of a designated polarizing direction. The light source may also implement sub-light sources to emit lights of the same wavelength with different polarizing directions. Furthermore, the sub-light sources may be made to emit light so that the lights of the same wavelength possess a plurality of polarizing directions. Thus, the sub-light sources can emit lights of the same wavelength with any polarizing direction.

Furthermore, the polarizing directions can be changed by 90 degrees by transmitting a linear-polarized light through two pieces of λ/4 plates. The two pieces of λ/4 plates are preferably placed with the polarization axis different by 90 degrees from each other. Sequential changes of the polarizing directions are achieved through controlling the transmitting, and not transmitting, the light through these two λ/4 plates. Further, there may be one λ/4 plate so that the light transmitting through the λ/4 plate is reflected by a reflection surface placed at a later stage of the aforementioned λ/4 plate in the light path and then the light is transmitted through the same λ/4 plate.

The spatial light modulator is preferably a mirror device, and a projection apparatus can be configured to have two mirror devices with individual mirror devices modulating illumination lights with different polarizing directions and having about the same wavelength.

For example, the projection apparatus is configured with one mirror device for modulating the lights projected as red and green lights and the other mirror device modulating the lights projected as green and blue lights. The linear polarization green lights, with polarizing directions having a 90 degree difference, are irradiated on the respective mirror devices. Then, the control circuit for the mirror device carries out a control for changing the intensities and emission periods of the four lights modulates the individual lights by means of the respective mirror devices, making it possible to adjust different gray scale and brightness of the individual lights. Then, the modulated individual lights are synthesized and the synthesized light is projected through a projection optical system.

Furthermore, the spatial light modulator modulates the individual lights based on the image signals corresponding to the lights of different wavelengths. The colors of the illumination lights with different wavelengths may include lights such as cyan, magenta, yellow and white.

A projection apparatus is further preferably configured to implement the semiconductor light source as a laser light source; the spatial light modulator is a mirror device that includes a mirror array having approximately one million to two million pixels of mirror elements each controlling the reflection light of the illumination light emitted from the laser light source, with a deflectable mirror capable of deflecting the reflecting direction of the illumination light, to an ON direction guiding the reflection light of the illumination light to a projection light path or an OFF direction not guiding the reflection light of the illumination light thereto. The mirror device further modulates the illumination light; the deflection angle of the mirror of the mirror element is between ±9 degrees and +4 degrees clockwise (CW) from the initial state; and the F number of the projection lens of a projection optical system is between 3 and 7.

The spatial light modulator of a projection apparatus according to the present embodiment is preferably a mirror device implemented with a mirror array that includes a plurality of mirror elements each comprising both a mirror for controlling the reflecting direction of an illumination light to the ON direction guiding the reflection light of the illumination light emitted from a semiconductor light source to a projection optical path or the OFF direction guiding the reflection light of the illumination light to project away from the projection optical path. The projection apparatus further includes one or two address electrodes causing the mirror to function a coulomb force and which modulates the illumination light, and the control circuit for the mirror device to control the address electrode and the semiconductor light source. Furthermore, the control unit for the mirror device may preferably control the address electrode and semiconductor light source applying a pulse width modulation (PWM) control.

Furthermore, by synchronizing the control of the address electrode with the control of the semiconductor light source using the control unit 5500 of the mirror device, the pulse width modulation of the mirror device, such as the free oscillation state of a mirror, as shown in FIGS. 22C and 26D, the intermediate state of a mirror, as shown in FIGS. 23A and 26A and the like, can be controlled. As a result, a higher resolution to achieve a higher level of gray scales in display a higher image quality can be controlled.

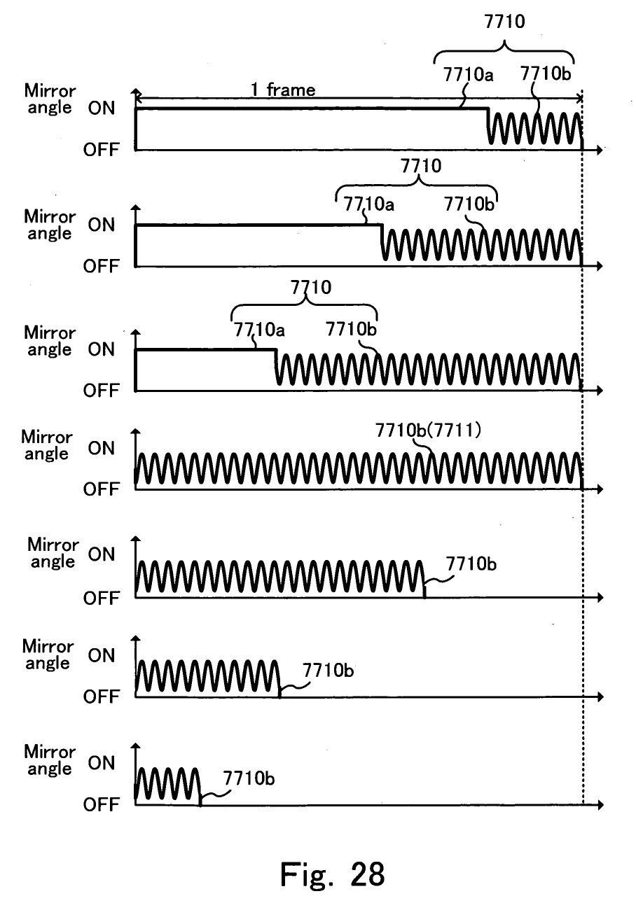

Furthermore, the illumination optical system of a projection apparatus according to the present embodiment may preferably comprise any of the diffractive optical element, optical fiber, micro lens array and rod pipe. By using these optical elements, the intensity distribution of illumination light flux can be averaged, thereby projecting a display not dependent on a projection position. By emitting light of a plurality of wavelengths from a plurality of semiconductor light sources, the projection device in this preferred embodiment can also be structured in such a way that the optical axis of illumination light of one wavelength does not coincide with the optical axis of illumination light of another wavelength. Furthermore, the projection device in this preferred embodiment can reduce the blurring effect of a dynamic image with ambiguous outlines by using a mirror device for the spatial light modulator 5100 and controlling the mirror device to continuously maintain the deflection state of the mirror device, as shown in FIG. 28, on the basis of data obtained by converting binary image signals to non-binary ones.

Specifically, in the case of a multi-plate projection device provided with a plurality of spatial light modulators 5100, like the above-described projection devices 5020, 5030 and 5040, when emission time for each color differs, only a specific color is emitted and there is a possibility that a color break may be generated. Therefore, in this preferred embodiment, the mirror 5112 of the spatial light modulator 5100 is provided with a function to switch between an ON state and an OFF state or to adjust it to a half-tone output state oscillating between the ON and OFF states. Then, when a brightness output value to be modulated is equal to or greater than one in the case where the half-tone output state is continued during the entire display period of one frame for each color, a modulation is performed during the entire display period of one frame for each color by the combination of the ON state and the half-tone output state of the mirror 5112.

FIG. 28 illustrates a countermeasure for a color break. The mirror control profile 7711 shown at the center of FIG. 30 indicates a brightness output carrying out a mirror oscillation control 7710b during the entire display period of one frame for each color.

Furthermore, the present embodiment is configured to continue to output light during the entire display period of one frame through a combination of a mirror ON/OFF control 7710a and a mirror oscillation control 7710b as indicated by the mirror control profile 7710 in the upper section of FIG. 28, wherein the brightness output is no less than the mirror control profile 7711.

In contrast, when the brightness output is no more than the mirror control profile 7711, the necessary brightness output is attained by controlling a continuation time period of the mirror oscillation control 7710b during the display period of one frame, as shown on the lower section of FIG. 28.

In the projection devices 5020, 5030 and 5040, which are provided with a plurality of spatial light modulators 5100, the control illustrated in FIG. 28 makes it easy to align the output time for each color, thereby reducing occurrence of a color break.

Then, by controlling the intensity of illumination light reflected in an intermediate direction to be ½ of the intensity of light reflected in an ON direction, the display gradation of this projection device can be improved one bit or more with the use of the intermediate gradation. Furthermore, by controlling the mirror device to project diffraction light, generated when illumination light is reflected, in an intermediate or ON direction, projected light can be controlled more finely, thereby achieving higher gradation.

In the projection device it is also preferable that the control unit 5500 of the spatial light modulator 5100 controls a light source on basis of the gradation of inputted image signals, controlling the gradation of illumination light of at least one wavelength. Furthermore, the control unit 5500 of the spatial light modulator 5100 can display high gradation images even with fairly low-speed spatial light modulators 5100 by controlling the light source on the basis of the modulation time of illumination light. For example, it is preferable to reduce the gradation of a sub-frame corresponding to illumination light of a specific wavelength whose modulation time is short and to finish modulation control in a prescribed time.

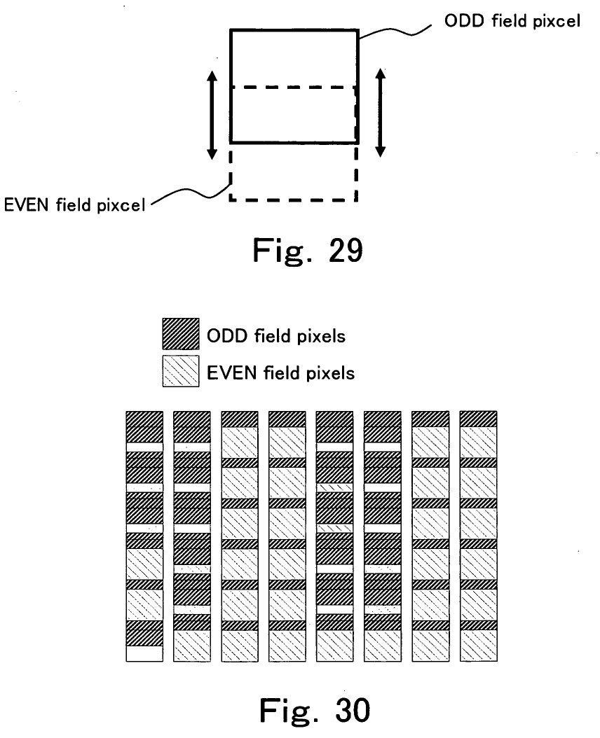

It is also preferable that the projection device in this preferred embodiment comprises a wobbling unit for wobbling projected light and that the wobbling unit and the semiconductor light source be synchronously controlled. In particular, it is preferable that the control unit 5500 of the spatial light modulator 5100 controls the intensity of light of the semiconductor light source before, after, and/or during the wobbling of projected light. More preferably, the wobbling should be performed as shown in FIGS. 29 and 30, described below.

FIG. 29 is a diagram for illustrating an oscillation of a light modulation element of a spatial light modulator when operating a wobbling device according to the present embodiment. The present embodiment is configured to operate a wobbling device to fluctuate (or wobble) the light modulation element in the vertical up and down direction instead of in a diagonal direction. Fluctuating the light modulation element vertically makes it possible to project an image of an interlaced signal directly, without requiring an extra process. The interlaced method represents an image projection method for dividing one image into two fields, an odd field and even field, and displaying the fields alternately to change the image. Specifically, the odd field represents the pixels corresponding to the odd numbered rows of one image, while the even field represents the pixels corresponding to the even numbered rows of one image.

Displaying an image by alternating fields increases the number of changes to one image, enabling a display of smooth motion. This method enables a display without increasing the bandwidth or the amount of bit-rate information processing, and therefore a common broadcast signal may adopt the interlaced method. For example, on a liquid crystal display (LCD), a flicker is generated when a stationary image is displayed, and the interlaced signal is converted into a non-interlaced signal before displaying an image. Such a method is called a progressive method, in which the amount of information is increased to two times and an image is degraded in the process of synthesizing the odd and even fields.

Therefore, when the odd field of an interlaced signal is first displayed, fluctuating the light modulation element vertically, upward and downward, as the present embodiment is configured, makes it possible to display an even field superimposed on the odd field, thus obtaining an effect similar to that of the progressive method without requiring a conversion of the interlaced signal into a progressive signal.

FIG. 30 is a diagram illustrating the case of wobbling the even field of an interlaced signal in the vertical direction after displaying the odd field of the interlaced signal. In FIG. 30, after first displaying the odd number field of an interlace signal, the wobbling device wobbles performs a wobbling controlling the spatial light modulator. Such an operation makes it possible to change the modulation of light to a position where the even field is superimposed on the odd field by shifting the even field by approximately one half of the field from the original position. Therefore, by projecting the interlaced image directly instead of carrying out extra image processing for an interlaced signal, it is possible to reduce image processing and improve the image quality of a projection image. Furthermore, the present embodiment is configured to switch off the light source in sync with the wobbling in order to turn off the light source during the wobbling.

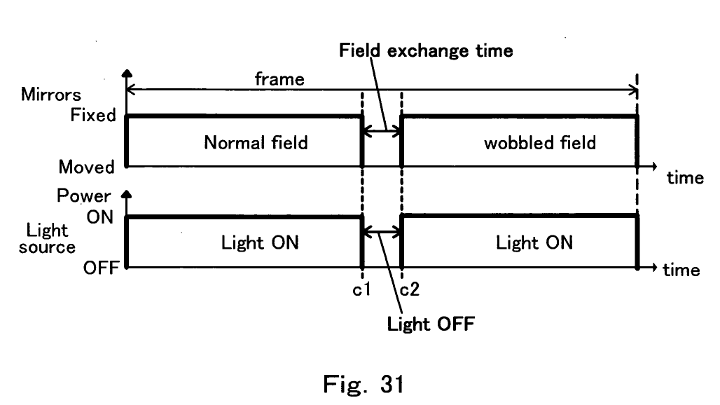

FIG. 31 is a timing diagram for illustrating the synchronization between a light source and the change in mirror positions of a mirror device (for example, a spatial light modulator) by means of a wobbling within one frame. The vertical axis of the figure indicates the changes of the mirror positions in a mirror device and changes of the output of a light source. A term “Fixed” is defined as when the mirror is at a prescribed position and another term “Moved” defined as when the mirror is moved in the wobbling process. “Normal field” indicates the mirror position prior to being wobbled, and “wobbled field” indicates the mirror position after being wobbled. The output of the light source is defined as “ON” when the light source emits an incident light for projecting an image, and “OFF” when the power supply to the light source is completely shut off. The horizontal axes are time axes, indicating the elapsed time. Prior to time c₁: the mirror position of the mirror device is fixed at a normal field, with the output of the light source set at ON. Therefore, the image of the odd field is projected when the normal field is the odd field.

Between time c₁ and time c₂: the mirror positions are shifted by the wobbling device. While the mirror positions are being shifted by the wobbling, the power supply to the light source is turned OFF in sync with the time in turning on the wobbling device. As a result, no image is projected while the mirror positions are moved during the mirror wobbling process, thus projecting a black image.

At time c₂: the mirror wobbling process is completed and the wobbling device has moved the mirror to a prescribed fixed position. Then the power supply to the light source is turned ON in sync with turning off the wobbling device. This operation causes the image of the even field to be projected with the even field designated for display as the wobbled field.

Pixels are distinctively separated before and after the wobbling by the synchronization of the light source and wobbling device, turning off the power supply to the light source during the wobbling, as described above. Therefore, the resolution of the projection image can be improved.

The process of switching off of the light source also has the advantage of reducing the power consumption and the heat generated by projecting light onto the spatial light modulator.

A projection apparatus comprising a synchronously controlled wobbling device and a spatial light modulator to improve the resolution of image display is therefore described above.

Such projection apparatuses include, for example, a single-panel projection apparatus connected to a wobbling device, which is described in FIG. 5 and a multi-plate projection device provided with a plurality of spatial light modulators connected to a wobbling device, as shown in FIGS. 6A through 6C and 7A through 7D.

The control process for controlling the illumination light with wobbling controls the processes in the ODD and EVEN sub-frames. Then, while the wobbling is carried out, the exchange of ODD and EVEN sub-frames by wobbling, the light source is switched OFF, as shown in FIG. 31. As a result, the displacements of images disappear. Then, by the insertion of a black image, the transition of images becomes clear and the contrast of the image is improved. In this case, the order of the ODD and EVEN sub-frames can also be modified. Alternatively, display time can also be modified. It is also preferable that the control unit 5500 of the spatial light modulator controls illumination light in such a way as to extrapolate the displacements of images caused by different lines displayed in ODD and EVEN sub-frames. Such a control can also be applied to a case where ODD and EVEN sub-frames are alternately displayed at double speed.

Therefore, by using the mirror device for the spatial light modulator 5100 of the projection device in this preferred embodiment, the ratio of the brightness level to the darkness level of the contrast of images by controlling the mirror device can be improved up to 5000:1 to 10000:1. Furthermore, by completely switching illumination light OFF during one frame period and providing a period for displaying a black frame, the contrast of the image can be improved.

A projection apparatus according to the present embodiment generates an image by controlling or adjusting at least one of the following: the emission light intensity of the sub light source 5210a (sub light sources 5211a, 5212a and 5213a), the number of emissions, the emission period, the number of emitting sub-light sources and the position thereof; and controlling or adjusting the total time length of the sub-frames of an illumination time and/or the gray scale of the illumination light.

At least one color of an image may be generated by controlling or adjusting at least two of the following: the emission light intensity of a sub light source 5210a (sub light sources 5211a, 5212a and 5213a), the number of emissions, the emission period, the number of emitting sub-light sources and the position thereof. More options to control the light source are therefore accomplished by combining the two parameters of the sub light source 5210a (sub light sources 5211a, 5212a and 5213a) and modifying the combination.

It is also preferable to configure the projection device in such a way that the sub light source 5210a (sub light sources 5211a, 5212a and 5213a) of the semiconductor light source is a laser light source, and such that a control circuit controlling a spatial light modulator controls at least two of the following: the emission light intensity of a laser light source, the number of emissions, the emission period, the number of emitting sub-light sources and the position thereof. The control circuit may be one circuit or multiple circuits.

A multi-panel projection apparatus comprising a plurality of spatial light modulators, of which at least one spatial light modulator modulates illumination lights of multiple wavelengths on the basis of an image signal, may also be configured.

A projection apparatus according to the present embodiment is also preferred to comprise a wobbling actuator for fluctuating an illumination light, wherein the control circuit for a spatial light modulator preferable controls at least one of the following in the projection period of an image either before or after fluctuating the illumination light: the emission light intensity of a semiconductor light source, the number of emissions, the emission period, the number of emitting sub light source 5210a (sub light sources 5211a, 5212a and 5213a), and the position thereof.

Furthermore, the control circuit for a spatial light modulator may control the semiconductor light source at a frame cycle that is no more than, for example, 120 Hz, and also at least one of the following: the emission light intensity of a semiconductor light source, the number of emissions, the emission period, the number of emitting sub light source 5210a (sub light sources 5211a, 5212a and 5213a) and the emitting position thereof for each frame of 120 Hz. Such a spatial light modulator 5100 is, for example, the above-described mirror device.

A projection apparatus according to the present embodiment comprises a laser light source comprising a plurality of sub light sources 5210a (sub light sources 5211a, 5212a and 5213a), a spatial light modulator that includes no less than 1,000,000 pixels for modulating, in accordance with an image signal, the illumination light emitted from the laser light source, and a control circuit for controlling the spatial light modulator. Further, the control circuit for a spatial light modulator controls at least two of the following: the emission light intensity of a laser light source, the number of emissions, the emission period, the number of emitting sub light source 5210a (sub light sources 5211a, 5212a and 5213a) and the position thereof, so that the illumination light of at least one wavelength modulated by the spatial light modulator possesses no less than 1000 levels of gray scale. The spatial light modulator is, for example, a mirror device as described above. Further, a configuration may be such that the control circuit for a spatial light modulator controls at least two of the following: the emission light intensity of a laser light source, the number of emissions, the emission period, the number of emitting sub light source 5210a (sub light sources 5211a, 5212a and 5213a) and the position thereof, so that the light of at least one wavelength of the illumination light modulated by the spatial light modulator possesses no less than 40 sub-frames within one frame.

Furthermore, in the projection apparatus according to the present embodiment described thus far, the illumination light modulated by the spatial light modulator may be a white light, and the illumination light may be a white light before and after the control circuit for a spatial light modulator controls the laser light source or sub-light source.

Furthermore, the gray scale of one illumination light may be different from the gray scale of another illumination light.

It is also preferable that the sub light sources 5210a (sub light sources 5211a, 5212a and 5213a) are laser light sources and are arranged in an array.

Alternatively, the sub light sources 5210a (sub light sources 5211a, 5212a and 5213a) can be a laser light source and the polarizing directions of individual sub-light source 5210a with approximately the same wavelength are approximately the same.

Alternatively, the sub light sources 5210a (sub light sources 5211a, 5212a and 5213a) can be laser light sources and a plurality of the sub light sources 5210a (sub light sources 5211a, 5212a and 5213a) with approximately the same wavelength can include at least one sub light source 5210a (sub light sources 5211a, 5212a or 5213a) having a different polarization direction.

Alternatively, the sub light source 5210a (sub light sources 5211a, 5212a and 5213a) can comprise a plurality of light sources.

As described above, a projection apparatus according to the present embodiment is configured to control or adjust the light source in combination with two of the following: the emission light intensity of a light source, the number of emissions, the emission period, the number of emitting sub light source 5210a (sub light sources 5211a, 5212a and 5213a) and the position thereof, in sync with the spatial light modulator, thereby the levels of gray scales for displaying the projected image may be increased to improve the quality of image display. Further, an appropriate execution of the control makes it possible to cause a color break to be inconspicuous.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternatives and modifications that fall within the true spirit and scope of the invention.

What is claimed is:

1. A projection device, comprising:
a semiconductor light source comprises a plurality of sub light sources arranged in an array;
an illumination optical system for guiding an illumination light emitted from the semiconductor light source;
a spatial light modulator for receiving and applying an image signal for modulating the illumination light emitted from the semiconductor light source guided by said illumination optical system;
a control circuit for controlling the semiconductor light source and the spatial light modulator; and
a projection optical system for projecting an image by applying the illumination light modulated by the spatial light modulator, wherein the control circuit controls or adjusts an emitting state of the semiconductor light source by modifying at least two of following parameters consisted of an emission intensity, a number of times of emission, an emission period and an emitting timing of the sub light source or a number of emitted light and an emitting position of the sub light sources.

2. The projection device according to claim 1, wherein:
the semiconductor light source emitting said illumination light with different wavelengths.

3. The projection device according to claim 1, wherein:
the spatial light modulator further comprising a mirror device with mirror elements arranged as two dimensional array for modulating the illumination light emitted from the semiconductor light source and deflecting the illumination light in an ON direction for reflecting the illumination light to the projection optical system, in an OFF direction for the illumination light away from the projection optical system or in an intermediate direction between the ON direction and OFF direction.

4. The projection device according to claim 3, wherein:
the control circuit applies non-binary data for controlling the mirror device wherein the non-binary data is generated from converting binary data of the image signal.

5. The projection device according to claim 3, wherein:
the control circuit controls the emission intensity, the number of times of emission, the emission period and the emitting timing of the semiconductor light source in synchronization with the spatial light modulator.

6. The projection device according to claim 2, wherein:
the control circuit controls the semiconductor light source and the spatial light modulator by changing the total length of time of each sub-frame in the illumination light of at least one wavelength during each frame period of image signal.

7. The projection device according to claim 1, wherein:
the control circuit controls the semiconductor light source to generate different levels of gray scale of the illumination light of at least one wavelength and/or in different number of sub-frames during each frame period of image signal.

8. The projection device according to claim 2, comprising:
a plurality of the spatial light modulators wherein said different illumination lights of different wavelengths are modulated by at least one of the spatial light modulators.

9. The projection device according to claim 2, comprising:
a plurality of the spatial light modulator wherein
a first spatial light modulator modulates the illumination light of a plurality of wavelengths and the other spatial light modulator modulate the illumination light of a plurality of wavelengths including the wavelengths modulated by the first spatial light modulator.

10. The projection device according to claim 1, comprising:
a plurality of the spatial light modulator wherein the control circuit controls the semiconductor light source and/or the spatial light modulators for modulating the illumination light by at least two of the spatial light modulators with almost equal total length of time during each frame period of image signal.

11. The projection device according to claim 1, wherein:
the control circuit controls the semiconductor light source for adjusting a ratio of a brightness of a projected image for each wavelength based on the total time of each sub-frame time during each frame period of image signal is approximately the same as a distribution of spectral luminous efficiency.

12. The projection device according to claim 1, wherein:
the control circuit controls the semiconductor light source and/or the spatial light modulator to change white balance or a gamma characteristic of an image to be projected.

13. The projection device according to claim 1, wherein:
the control circuit controls the semiconductor light source and/or the spatial light modulator to project the illumination light of each wavelength with almost equal length of time during each frame period of image signal.

14. The projection device according to claim 1, wherein:
the control circuit controls the semiconductor light source to emit the illumination light of each wavelength in a period with a shorter cycle than a modulation cycle of the spatial light modulator.

15. The projection device according to claim 2, wherein:
the plurality of sub light sources for emitting the illumination light of different wavelengths have the same polarization direction.

16. The projection device according to claim 2, wherein:
the plurality of sub light sources for emitting the illumination light of at least one wavelength have different polarization directions.

17. The projection device according to claim 1, further comprising:
a polarization control unit for controlling the polarization direction of the illumination light, wherein the illumination light and/or a projected light form the semiconductor light source are polarized light.

18. The projection device according to claim 17, wherein:
the polarization control unit comprises a polarization filter and polarization conversion element for switching the polarization direction of the illumination light or the projected light from the semiconductor light source.

19. The projection device according to claim 17, wherein:
the polarization control unit controls polarization directions of the illumination light of a plurality of wavelengths.

20. The projection device according to claim 1, comprising:
two spatial light modulators wherein the spatial light modulators modulate the illumination light of different polarization directions and the same wavelength.

21. The projection device according to claim 1, wherein:
the illumination light applied to the spatial light modulator is one of cyan, magenta, yellow and white, and the spatial light modulator modulates the illumination light on the basis of an image signal corresponding to the illumination light.

22. The projection device according to claim 1, wherein:
the illumination optical system comprises at least a diffractive optical element, an optical fiber, a micro-lens array and a rod pipe.

23. The projection device according to claim 1, wherein:
the illumination light emitted from the semiconductor light source has a plurality of wavelengths and said light sources emits the illumination light of different wavelengths along different optical axes.

24. The projection device according to claim 1, wherein:
the control circuit controls the semiconductor light source of at least one wavelength on the basis of the image signal.

25. The projection device according to claim 1, comprising:
a wobbling unit for wobbling the projected light from the semiconductor light source, wherein the spatial light modulator comprises a mirror device comprising a plurality of mirror elements for modulating the illumination light emitted from the semiconductor light source and controlling the reflection direction of the illumination light.

26. The projection device according to claim 25, wherein:
the control circuit controls the semiconductor light source before/after or during wobbling the projected light from the semiconductor light source.

27. The projection device according to claim 1, wherein:
the spatial light modulator comprises a mirror device including 1,000,000 or more mirror elements disposed in an array having a set of at least one address electrode and memory, for modulating the illumination light emitted from the semiconductor light source and controlling a deflected direction of the illumination light; and
a ratio between a light level and dark level of contrast of an image projected by the projection optical system is 5000:1 to 10000:1.

28. The projection device according to claim 1, wherein:
the spatial light modulator comprising a mirror device including 1,000,000 or more mirror elements disposed in an array having a set of at least one address electrode and memory, for modulating the illumination light emitted from the semiconductor light source and controlling a deflected direction of the illumination light and
the control circuit applying a pulse modulation process to control the semiconductor light source and the spatial light modulator for providing 1,000 or more levels of gray scale.

29. A projection device, comprising:
a semiconductor light source of different wavelengths, comprising a plurality of sub light sources disposed in an array;
an illumination optical system for guiding an illumination light emitted from the semiconductor light source;
a spatial light modulator for receiving and applying an image signal for modulating the illumination light emitted form the semiconductor light source guided by said illumination optical system;
a control circuit for controlling the semiconductor light source and the spatial light modulator; and
a projection optical system for projecting an image by the illumination light modulated by the spatial light modulator, wherein
the semiconductor light source has different wavelengths,
the control circuit modifies at least one of the following parameters consisted of an emission intensity, a number of times of emission, an emission period and an emitting timing of the sub light source or a number of emitted light and an emitting position of the sub light sources and also controls or adjusts the total length of time of sub-frame time for each wavelength for emitting the illumination light.

30. The projection device according to claim 29, wherein:
the control circuit controls or adjusts at least two of the following parameters consisted of the emission intensity, the number of times of emission, the emission period and the emitting timing of the sub light source or the number of emitted light and the emitting position of the sub light sources disposed in an array to generate at least one color of the projected image.

31. The projection device according to claim 29, comprising:
a plurality of the spatial light modulators, wherein at least one of the spatial light modulators modulates the illumination light of a plurality of wavelengths according to the image signal.

32. The projection device according to claim 29, wherein:
the projection optical system combines the illumination light modulated by the spatial light modulator.

33. The projection device according to claim 29, comprising:
a wobbling unit for wobbling the projected light projected from the semiconductor light source, wherein
the control circuit controls at least one of the following parameters consisted of the emission intensity, the number of times of emission, the emission period and the emitting timing of the sub light source or the number of emitted light and the emitting position of the sub light sources during the projection period of the image before or after wobbling the projected light.

34. The projection device according to claim 29, wherein:
by the control circuit controls the semiconductor light source, levels of gray scale of illumination light of at least one wavelength and/or number of sub-frames during each frame period of the image signal differ.

35. The projection device according to claim 29, wherein:
the sub light source also comprises a plurality of light sources.

36. The projection device according to claim 29, wherein:
the spatial light modulator comprises a mirror device including 1,000,000 or more mirror elements disposed in an array having a set of at least one address electrode and memory, for modulating the illumination light emitted from the semiconductor light source and controlling a deflected direction of the illumination light; and
a ratio between a light level and a dark level of contrast of an image projected by the projection optical system is 5000:1 to 10000:1.

37. The projection device according to claim 29, wherein:
the spatial light modulator comprising a mirror device including 1,000,000 or more mirror elements disposed in an array having a set of at least one address electrode and memory, for modulating the illumination light emitted from the semiconductor light source and controlling a deflected direction of the illumination light and the control circuit applying a pulse modulation process to control the semiconductor light source and the spatial light modulator for providing 1,000 or more levels of gray scale.

38. A projection device, comprising:
a semiconductor light source comprises a plurality of sub light sources disposed in an array;
an illumination optical system for guiding an illumination light emitted from the semiconductor light source;
a spatial light modulator for receiving and applying an image signal for modulating the illumination light emitted from the semiconductor light source guided by said illumination optical system;
a control circuit for controlling the semiconductor light source and the spatial light modulator; and
a projection optical system for projecting an image by applying the illumination light modulated by the spatial light modulator, wherein
the control circuit controls the spatial light modulator and/or the semiconductor light source in the frame cycle of 120 Hz or more and controls at least one of following parameters consisted of an emission intensity, a number of times of emission, an emission period and an emitting timing of the sub light source or a number of emitted light and an emitting position of the sub light sources for each frame.

39. The projection device according to claim 38, wherein:
the spatial light modulator further comprising a mirror device with mirror elements arranged as two dimensional array for modulating the illumination light emitted from the semiconductor light source and deflecting the illumination light in an ON direction for reflecting the illumination light to the projection optical system, in an OFF direction for the illumination light away from the projection optical system or in an intermediate direction between the ON direction and OFF direction.

40. The projection device according to claim 38, wherein:
by the control circuit controls the semiconductor light source, levels of gray scale of illumination light of at least one wavelength and/or number of sub-frames during each frame period of the image signal differ.

41. The projection device according to claim 38, wherein:
the sub light source also comprises a plurality of light sources.

42. The projection device according to claim 38, wherein:
the spatial light modulator comprises a mirror device including 1,000,000 or more mirror elements disposed in an array having a set of at least one address electrode and memory, for modulating the illumination light emitted from the semiconductor light source and controlling a deflected direction of the illumination light; and
a ratio between a light level and dark level of contrast of an image projected by the projection optical system is 5000:1 to 10000:1.

43. The projection device according to claim 38, wherein:
the spatial light modulator comprising a mirror device including 1,000,000 or more mirror elements disposed in an array having a set of at least one address electrode and memory, for modulating the illumination light emitted from the semiconductor light source and controlling a deflected direction of the illumination light and the control circuit applying a pulse modulation process to control the semiconductor light source and the spatial light modulator for providing 1,000 or more levels of gray scale.
